(19) United States
(12) Patent Application Publication
(10) Pub. No.: US 2013/0254120 A1
(43) Pub. Date: Sep. 26, 2013

(54) Recall Exchange Platform

(71) Applicant: FOODTRACK, INC., Wellington, FL (US)

(72) Inventor: Robert J. Waite, Wellington, FL (US)

(73) Assignee: FoodTrack, Inc., Wellington, FL (US)

(21) Appl. No.: 13/869,809

(22) Filed: Apr. 24, 2013

Related U.S. Application Data
(63) Continuation of application No. 12/903,513, filed on Oct. 13, 2010, now abandoned.
Application No. 12/903,513 is a continuation-in-part of application No. 12/903,479, filed on Oct. 13, 2010, now abandoned.
(60) Provisional application No. 61/252,002, filed on Oct. 15, 2009.

(30) Foreign Application Priority Data
Oct. 15, 2010 (US) PCT/US2010/052867

(51) Int. Cl. G06Q 30/00

(52) U.S. Cl. CPC G06Q 30/014
USPC 705/303

(57) ABSTRACT

A method, apparatus, and system are disclosed that provide a tiered recall notification service via an information exchange platform. A user may register with the information exchange platform and may identify one or more consignees and consignors. A governmental or administrative authority may also be registered with the information exchange platform. One or more parties may generate a recall notification request in relation to a product. The recall notification request may be distributed to one or more of the parties. Progress reports may be generated to track the status of the recall until the recall matter has terminated or closed.

### CROSS-REFERENCE TO RELATED APPLICATIONS

This application claims the priority benefit of U.S. application Ser. No. 12/903,513 filed Oct. 13, 2010, titled “Recall Exchange Platform,” U.S. Provisional Application No. 61/252,002 filed Oct. 15, 2009, titled “Product Recall Information Exchange Platform,” PCT Application No. PCT/US2010/052867 filed Oct. 15, 2010, titled “Recall Exchange Platform,” and U.S. application Ser. No. 12/903,479 filed Oct. 13, 2010, titled “Product Recall Information Exchange Platform,” the entire contents of which are incorporated herein by reference.

### FIELD

Aspects of the disclosure generally relate to computing technologies used to disseminate information. More specifically, an apparatus, method and system are described for providing a tiered product recall information processing exchange service with respect to one or more products or services.

### BACKGROUND

Product distribution chains require timely and accurate information in order to ensure a proper and safe flow of products. From time to time product recalls are required for any of numerous reasons, including, e.g., contaminated products or ingredients, crops or livestock, adulteration, mislabeling, counterfeiting a lapse in quality control standards at a manufacturing or processing plant (such as under-processing), suspected or actual product tampering (a form of which may be related to terrorist activities), or other such product safety related issues that threaten the integrity of products, safety of consumers and corporate/brand reputations.

With respect to food products, the Centers for Disease Control has estimated that some 76 million Americans are stricken each year with some form of food-borne illness. Even with millions of dollars spent by the U.S. Government and corporate crisis management teams, thousands of consumers become victims of tainted products each year. Dangerous goods reach grocery and other store shelves, homes, offices, schools, army barracks, restaurants, and other locations where products are sold and distributed. Add to this the ongoing threat of bio-terrorism, and the need is clear for a comprehensive solution to mitigate such risks.

Current product recall systems are inefficient and fall short. First and foremost there are tens, if not hundreds, of thousands of organizations and other points potentially affected by (i.e., potentially needed to participate in) a recall or withdrawal. Many organizations have their own methodology for initiating and responding to a recall. Further, there are diminishing budgets, staff reductions, antiquated prevention systems, antiquated communication systems and gaps, compliance irregularities, complacency, and simply too many points, distribution or otherwise, where critical information is either delayed in its arrival or never reaches its intended recipient, be it consumer, retailer, producer or distributor. All the while, potentially lethal products may be distributed, purchased, and in the case of food products, ingested.

Given the complexity and intricacies associated with modern and global product distribution chains, some recall notices might not make their way through the distribution chain for a number of days or even weeks. In some cases, the consuming public's safety is directly impacted by the relatively slow transmittal of information within the product distribution chain and the appropriate authorities may not be kept fully abreast of the recall as it is developing.

Conventional techniques for recalling a product typically include a recalling firm (RF) or regulatory authority discovering an adverse incident, defect or contamination related to the product. The RF advises one or more government agencies (e.g., the Food and Drug Administration (FDA) if the product is a food product) of the recall. The FDA or USDA/FSIS (or other regulatory agency) opens a file to track the status and effectiveness of the recall. Thereafter, a withdrawal, recall, hold, stop sale order, public or consumer health alert or other notification is issued by a RF or Regulator to the primary consignees, e.g., distributors, retailers, wholesalers, service personnel, buying groups, product banks/inventories/speculators, the military, schools, transit hub workers/officials, small stores (so called “mom & pop stores”), convenience stores, etc., as appropriate. The issuance of the withdrawal, recall or hold is then conveyed to supplementary consignees by the primary recipients. A supplementary recipient may, in turn, convey the withdrawal, recall or hold to yet another tier or level in the product's distribution and sales system. Thereafter, system-wide product withdrawal, inventory accounting, and reporting operations are required to bring the recall to closure. Needless to say, such antiquated processes can result in too many cases in ongoing consumer health threats, corporate liability, communication gaps, and non-universal compliance.

### BRIEF SUMMARY

The following presents a simplified summary of aspects of the inventive methods, systems and devices disclosed here. This summary is not an extensive overview, and is not intended to identify all or only key or critical elements or to delineate the scope of the inventive methods, systems and devices covered by the claims. The following summary merely presents some concepts and aspects of the disclosure in a simplified form as a prelude to the more detailed description provided below of certain exemplary and non-limiting embodiments of the invention.

In accordance with aspects of this disclosure, apparatuses, methods, and systems are disclosed for implementing product recalls, especially food recalls, withdrawals, holds or the like. In some instances, for brevity and convenience, the discussion below refers to product recalls, withdrawals, holds and the like by the general term product recall. As used here, implementing a product recall means assisting in the management or coordination of some or all aspects of the recall, including at least receiving and automatically disseminating recall notifications from a recalling firm and related information, and receiving, tabulating and providing access to recall related information. In at least certain exemplary and non-limiting embodiments or versions of the invention, providing access to recall related information includes automatically forwarding information concerning the progress (including lack of progress) of certain recall activities. The forwarded information may be disseminated throughout an information exchange platform to entitled/authorized members in real-time.

In certain exemplary and non-limiting embodiments, a multi-tier information exchange platform is provided that can handle activities associated with a product recall. In one example, a user may provide registration information for purposes of registering with the information exchange platform. The registration information may include an address for electronic communications with the user via the information exchange platform. The user may also identify a consignee or consignor of product produced or distributed by the user by entering associated consignment information into the information exchange platform.

In accordance with certain aspects of this disclosure, apparatuses, methods, and systems provide access to recall related information. More specifically, an information exchange platform is provided that is configured to handle activities associated with a product recall involving a multi-tier product distribution system. In one example, a user may provide registration information for purposes of registering with the information exchange platform. Registration may be done as pre-registration, i.e., prior to the user actually needing the information exchange platform to implement a recall, or it may be done in conjunction with a recall notification. For convenience, a registered user may be referred to as a member of the information exchange system implemented by the information exchange platform. The registration information may include an address for the information exchange platform to automatically issue electronic communications to the member, e.g., an address for e-mail, RSS feeds, SMS feeds, text messages, fax messages, phone messages, etc. The user's registration information optionally may also include similar information for one or more of its consignees. Alternatively or in addition, information of the one or more consignees may be provided by a recalling firm in conjunction with communicating a recall notification to the information exchange platform. A recall notification sent into the information exchange platform may also include the identification of specific product units being recalled and/or other associated consignment information.

In terms of registration information, contact information may be indexed and cross referenced with exchange-member identification numbers (ID #s). Confidentiality may be maintained to protect against unauthorized disclosure of a member's clients/consignors/consignees or products that the member deals in. A member may register with the information exchange platform by providing contact information, such as an email address (e.g., ExchangeRecall@yourdomain.com), to the information exchange platform. The member may be responsible for updating any changes to the contact information provided. In response to the provided contact information, the information exchange platform may assign an exchange-member ID # to the member (or more specifically, to the member's contact information). In this manner, a recalling firm (RF) member that wants to maintain client/consignor/consignee contact lists on the information exchange platform may do so knowing that the contact information is maintained and expressed in the form of a member ID#, with the identity of the corresponding client/consignor/consignee limited to need-to-know exchange staff only. In some embodiments, only the RF member may view the client domain and the correlating member ID #s on progress reports and the like, thereby ensuring confidentiality/privacy. In such embodiments, when a RF member initiates a product recall within the information exchange platform, the RF member may be assured that the RF member's contact list(s) and contact information is maintained in confidentiality.

Contact lists may be maintained outside of the information exchange platform. An RF member may initiate a product recall outside the information exchange platform. The indexing and cross reference system described above may be used, and the RF member may use a Universal Recall Form to initiate the product recall. The RF member may provide a copy of the communication and member ID #s to the information exchange platform for purposes of having a product recall notification disseminated within the information exchange platform. The product recall notification may be a targeted communication to consignees that are known on the basis of a record to have been sold/shipped specific lots of recalled product. Alternatively, the RF member may request a blanket notification be sent to all exchange members. In either case, the RF member may use a Universal Recall Form and may copy the information exchange platform on the notification to expedite supplemental, inside exchange notification.

In some embodiments, irrespective of whether a RF member initiates a product recall from within the information exchange platform or external to the information exchange platform, member (e.g., consignee) responses may be generated within the information exchange platform. For example, a RF member may distribute an electronic communication (e.g., an address for e-mail, RSS feeds, SMS feeds, text messages, fax messages, phone messages, etc.) to a consignee outside of the information exchange platform, with the consignee response(s) executed inside the information exchange platform.

In some embodiments, a RF member may send/transmit a product recall notification to the information exchange platform. Support staff affiliated with the information exchange platform may input and disseminate data through the information exchange platform.

In accordance with certain aspects of this disclosure, a recall information exchange platform includes an exchange processor, associated storage readable and writable by the exchange processor, and an electronic communication pathway for electronic data interchange by the exchange processor. The exchange processor may be configured to register multiple members of a multi-tiered distribution system as exchange system members. Registering a member includes receiving from the member, typically via electronic data interchange, and retrievably storing registration information, such as the identity of the member, an address for electronic data interchange with the member and, optionally additional information, e.g., the identity of product consignees or consignors of the member, UPC codes, Global Trade Identification Numbers ((GTINs)—a family of GS1 (EAN.UCC) global data structures that employ 14 digits and can be encoded into various types of data carriers) or other identification of one or more products handled by the member, etc.

As the term is used here, a product is “handled” by a member of the recall information exchange system if the member is in any way involved with the production, storage, distribution, sale and/or use of the product. The exchange processor is further configured to receive a product recall notification from a recalling firm or regulator. The recalling firm may be an exchange system member or in certain exemplary and non-limiting embodiments the exchange processor may be configured to receive a recall notification even from a recalling firm that is not at that time an exchange system member. In certain exemplary and non-limiting embodiments of the recall information exchange system, the exchange processor may be configured to require in the recall notification at least information identifying the recalling firm (referred to in some instances here as “RF identification information”), information identifying at least certain product units for which the recall is to be executed (referred to in some instances here as “product information identifying”), and the identity of one or more consignors/consignees of some or all such product units for which the recall is to be executed. The exchange processor is further configured to automatically implement a recall information exchange in response to receipt of the recall notification, including being configured to perform, in any possible order, at least:
opening a product recall file;
generating and transmitting a recall notification receipt to the recalling firm;
establishing a tabulated recalled units status for the product units for which the recall is being implemented;
establishing a tabulated consignee status for the one or more identified consignees of product units for which the recall is being implemented;
generating and transmitting a primary recall notification to one or more identified consignees identifying at least product units for which the recall is being implemented;
receiving a consignee acknowledgment from any of the identified consignees indicating receipt of the primary notification;
updating the tabulated consignee status in response to receipt of each consignee acknowledgment;
receiving a progress report from any of the identified consignees indicating a status of product units for which the recall is being implemented;
updating the tabulated recalled units status in response to receipt of each progress report;
generating and transmitting a consignee status notification to the recalling firm and a governmental agency providing at least information corresponding to the tabulated recalled units status, the tabulated consignee status or both, and optionally additional actions.

In some embodiments, when a RF member initiates a product recall prior to a file number being assigned by a regulatory authority, the information exchange platform may be configured to assign a preliminary or temporary file number throughout the information exchange platform (including placing the temporary file number on any progress reports that may be generated). A subsequent file number assigned by a regulatory authority may be indexed, cross referenced and updated throughout the exchange platform.

In certain exemplary and non-limiting embodiments or versions of the recall information exchange platform/system described immediately above, the exchange processor may be further configured to register one or more state and/or federal governmental agencies as exchange system members. In certain exemplary embodiments the exchange processor comprises one or more servers that are in at least intermittent communication with one another. The servers may be co-located or geographically separated. In any case, the electronic communication pathway(s) of the recall information exchange system for electronic data interchange by the exchange processor may include, for example, any combination of one or more EDI pathways, interne connections, packet switched networks, cell phone systems and public phone system lines.

In certain exemplary and non-limiting embodiments or versions of the recall information exchange platform/system described immediately above, the exchange processor is configured:
to receive a sub-consignee report from a reporting consignee identifying one or more sub-consignees that received from the consignee one or more product units for which the recall is to be executed and, optionally, information identifying at least certain product units received by the sub-consignee;
to generate and transmit a sub-consignee report receipt to the reporting consignee acknowledging receipt of the sub-consignee report;
to update the tabulated consignee status to include the sub-consignees identified by the sub-consignee report;
to generate and transmit a consignee status notification to the recalling firm and a governmental agency providing at least information corresponding to the identity of the reporting consignee and the tabulated consignee status updated to include the sub-consignees identified by the sub-consignee report;
to generate and transmit a primary recall notification to one or more of the identified sub-consignees identifying at least product units for which the recall is being implemented;
to receive a progress report from any of the identified sub-consignees indicating a status of product units for which the recall is being implemented; and
to update the tabulated recalled units status in response to receipt of each progress report from a sub-consignee.

In certain exemplary and non-limiting embodiments or versions of the recall information exchange system described immediately above, the exchange processor is configured:
to determine the time duration from the transmittal of primary recall notifications to identified consignees, and
to generate and transmit a recall reminder notification and transmit to identified consignees to which a primary recall notification was sent and from which a consignee acknowledgment was not received within a predetermined period of time;
to update the tabulated consignee status to indicate the transmittal of the recall reminder notification; and to generate and transmit a consignee status notification to the recalling firm and at least one governmental agency providing at least information corresponding
to tabulated consignee status updated to indicate the transmittal of the recall reminder notification.

In certain exemplary and non-limiting embodiments or versions of the recall information exchange system described immediately above, the exchange processor is configured:
to determine if and when all product units for which the recall is being implemented have been accounted for by consignees; and
to update the tabulated recalled units status to indicate that all product units for which the recall is being implemented have been accounted for by consignees; and
to generate and transmit a consignee status notification to the recalling firm and at least one governmental agency providing at least information corresponding to the tabulated recalled units status updated to indicate that all product units for which the recall is being implemented have been accounted for by consignees.

Various aspects of the disclosure may, alone or in combination with other aspects, allow a registered member to issue a recall notification with respect to identified product units. The recall notification may be distributed to a consignor or consignee of the registered member via the information exchange platform. Alternatively, or additionally, the recall notification may (initially) be distributed external to the information exchange platform. The information exchange platform may be copied on the external recall notification. Response to the recall notification may be generated and distributed/disseminated internal to the information exchange platform.

### BRIEF DESCRIPTION OF THE DRAWINGS

A more complete understanding of the present disclosure and the advantages thereof may be acquired by referring to the following description in consideration of the accompanying drawings, in which like reference numbers indicate like features, and wherein:

FIG. 1 illustrates a network computing environment suitable for carrying out one or more illustrative aspects of the disclosure.

FIG. 2 illustrates a data processing architecture suitable for carrying out one or more illustrative aspects of the disclosure.

FIG. 3A illustrates an organizational flow chart suitable for demonstrating one or more illustrative aspects of the disclosure.

FIG. 3B illustrates a flow chart depicting a method suitable for carrying out one or more aspects of the disclosure.

FIG. 4 illustrates a flow chart depicting a method suitable for carrying out one or more aspects of the disclosure.

FIG. 5 illustrates a flow chart depicting a recall exchange business process in accordance with one or more aspects of this disclosure.

FIG. 6A-6D illustrate sorting reports in accordance with one or more aspects of this disclosure.

FIGS. 7A-7D illustrate demographic reports in accordance with one or more aspects of this disclosure.

FIGS. 8A-8C illustrate yearly summary reports in accordance with one or more aspects of this disclosure.

FIGS. 9A-9M illustrate screen shots in accordance with one or more aspects of this disclosure.

FIGS. 10A-10B illustrate use cases in accordance with one or more aspects of this disclosure.

### DETAILED DESCRIPTION OF EXEMPLARY EMBODIMENTS

In the following description of the various embodiments, reference is made to the accompanying drawings, which form a part hereof, and in which is shown by way of illustration various embodiments in which one or more aspects of the disclosure may be practiced. For convenience, the various embodiments discussed below are methods, devices and systems for recalls and the like. It is to be understood that other embodiments may be utilized, and structural and functional modifications may be made without departing from the scope of the present disclosure. Furthermore, throughout this disclosure, unless the context clearly indicates otherwise, the following abbreviations and definitions are used for convenience:

FDA—Food and Drug Administration

USDA—United States Department of Agriculture

EPA—Environmental Protection Agency

CPSC—U.S. Consumer Product Safety Commission

DHS—Department of Homeland Security

CDC—Centers for Disease Control and Prevention

FBI—Federal Bureau of Investigation

Multi-tiered distribution system—a system for the distribution and sale of multiple units (e.g., cans, cases, packages, bunches, pallets, etc.) of a food product (e.g., a beverage product, produce, fruit, meat, ingredients, etc.) or other product, including at least a producer of the multiple units of the product and at least one consignee that receives units of such product from the producer and offers all or some of such units of the product for sale to consumers and/or further distributes all or some of such units to one or more consignees next along the distribution chain of such product. Thus, a multi-tiered distribution system for a particular product may have multiple distribution channels, and each distribution channel may have distributors, shippers, wholesalers, retailers, consolidators, etc. Any given entity may perform multiple such roles. Units of a product may be said to move or flow “downstream” from the producer toward the ultimate consumer.

RF—Recalling Firm, a firm that initiates a recall of all or selective units of a product distributed to consignees in a multi-tiered distribution system. An RF may be the original producer of the product, a consignee (e.g., a wholesaler, retailer, distributor, etc.) of some or all of the recalled units of a product, a governmental agency, or others.

Consignee—A recipient (other than the ultimate consumer) of one or more units of a product being recalled. A consignee may be the ultimate seller of the product to the consumer or an intermediary. Thus, a consignee may be a distributor, shipper, wholesaler, retailer consolidator, etc. In some cases, an entity may act in more than one such role for a product, for example, being the retailer of some units of the product and the wholesaler or distributor of other units.

Recall—A voluntary or mandatory recall, withdrawal, hold and/or other corrective action for all or selective units of a product distributed to one or more consignees in a multi-tiered distribution system. In certain exemplary and non-limiting embodiments or versions of the methods, systems and devices disclosed herein, a recall may involve removal of all units or a subset of the units of a distributed food, drug, cosmetic or any other consumer product that is known or suspected of presenting a risk of injury or other threat to consumers of the product. In certain exemplary and non-limiting embodiments the product units in question may be known or suspected of posing a risk of gross deception of the consumer. In certain exemplary and non-limiting embodiments the product units in question may be known or suspected of being tainted by chemical, biological or other contaminant or to be otherwise defective. In certain exemplary and non-limiting embodiments the FDA, USDA, EPA, CPSC, DHS, CDC, FBI, or other local, state or federal agency may have determined to initiate legal action against the identified product or product units in question.

Universal Product Codes (UPCs), Global Trade Item Numbers (GTINs), Global Location Numbers (GLNs), NDCs—A UPC, GTIN, GLN, NDC, RFID Tag or similar type of identifier printed, attached or otherwise affixed to a product, i.e., to each unit of a product or to the packaging or other materials associated with the product unit (e.g., to individual cans, boxes, shrinkwrap or other wrapper, cartons, pallets, cases, etc.), encoding or otherwise providing information suitable to distinguish one unit or certain units of the product form other units based on the date of product as well as one or more other production-specific factors, e.g., the plant in which the product unit(s) were produced or the farm or specific field in which the product unit(s) were picked, the production line that produced the product unit(s), source and/or date information for one or more ingredients incorporated into the product unit(s), processing parameters for the product unit(s), etc.

Information exchange platform—A computer system with at least (i) a processor, e.g., one or more servers or the like, (ii) storage readable and writable by the processor, e.g., computer readable storage medium, and (iii) one or more electronic communication pathways for electronic data interchange (EDI) by the processor, e.g., EDI pathways, interne connections, packet switched networks, cell phone systems, public phone system landlines (POTS lines), etc.

Various connections and the like are set forth between elements in the following description. It should be understood that these connections in general, unless specified otherwise, and may be direct or indirect and that this specification is not intended to be limiting in this respect.

Aspects of this disclosure relate to the issuance of a recall notification from a member registered with an information exchange platform. The recall may relate to one or more product units. An acknowledgment of the receipt of the recall notification by a consignee or consignor may be entered into the information exchange platform. The information exchange platform may keep a running count or tabulation of the consignees who have acknowledged receipt of the recall notification. The information exchange platform may keep a running count or tabulation of identified products that the consignee, consignor, and registered member have acquired based on the recall notification.

These and other aspects of the disclosure generally relate to a member issuing a product recall notification with respect to one or more product units. An information exchange platform may distribute the product recall notification to one or more consignees and consignors of the member. It should be understood that a consignor, as that term is used here, may be the original producer of the product in question (i.e., of some or all of the product units subject to the recall in question) or a consignee of any of the product units that has or intends to further distribute at least some such units as opposed to itself selling them to consumers, e.g., a distributor, wholesaler, etc, of some or all of the product units. The information exchange platform may record the identity of each consignee so notified and the date and time of notification and/or other information. In certain exemplary and non-limiting embodiments of the methods, systems and devices disclosed herein, the information exchange platform may receive from the RF member or other source the total number of units being recalled, as well as an identification of the recalled units.

The one or more consignees (including consignees that act as intermediate consignors) may acknowledge having received the product recall notification, including, but not necessarily being limited to, sending an electronic message and/or other message to or via the information exchange platform in response to receiving the product recall notification. The one or more consignees each may take one or more actions to control (i.e., to sequester, regain possession, remove from its store shelves, destroy, hold for pick-up, return to the producer, or otherwise prevent sale to a consumer) of the one or more units of the recalled product in its possession. Each consignee upon obtaining control of some or all such product units may so inform via the information exchange platform, including, but not necessarily being limited to, sending an electronic message and/or other message to or via the information exchange platform. Optionally, a consignee may send multiple such messages over time, updating the total (or incremental) number of product units it has then obtained control of, such as in the case of continuing consumer returns. The information exchange platform may receive, record, and update a count indicative of the total number of product units that is the subject of the product recall notification responsive to the indication that the one or more consignees and consignors obtained possession of the one or more product units. That is, the information exchange platform may keep a running count over time of the cumulative total number of product units. Similarly, the information exchange platform may update a count indicative of the total number of such product units for which it has received acknowledgment from the consignees of their receipt of the recall. The information exchange platform may simultaneously distribute one or more progress reports to one or more members of the information exchange platform as the recall process is developing. Information included in the one or more progress reports may be filtered or screened in order to deliver information on an “as needed” basis.

To address the global corporate and consumer risk posed by the inordinate amount of recalls each year, and the risks they pose therein, an original and unique software/hardware/firmware solution and business process may capture critical data and, when used by participating licensors/members/parties, the captured data may be distributed across the whole and entirety of the food (human and pet), animal feed, general merchandise, pharmaceutical, health and beauty care (HBC) supply chain across the globe.

A single electronic information exchange platform, via a software solution, and as facilitated by a universal tracking form, may capture every known category in food (human and pet), animal feed, beverage, general merchandise, HBC and pharmaceutical, as completed by a recalling firm (RF) and disseminated through the information exchange platform to consignees. The consignees may in turn notify their customers, suppliers, and so on. Source producers and growers, retailers, distributors, wholesalers, buying groups, product banks/inventories/speculators, the military, schools, transit systems where product is sold, small “mom & pop” stores including convenience stores, etc., are provided with an efficient and universal information flow to all concerned, or potentially concerned and affected parties.

Aspects of the disclosure may integrate suppliers, distributors, retailers, wholesalers, buying groups, product service personnel, charitable organizations, businesses, governmental agencies via a world-wide platform, thereby mitigating or eliminating consumer health threats, corporate liability, and communication gaps. Universal compliance standards may be adopted and adhered to.

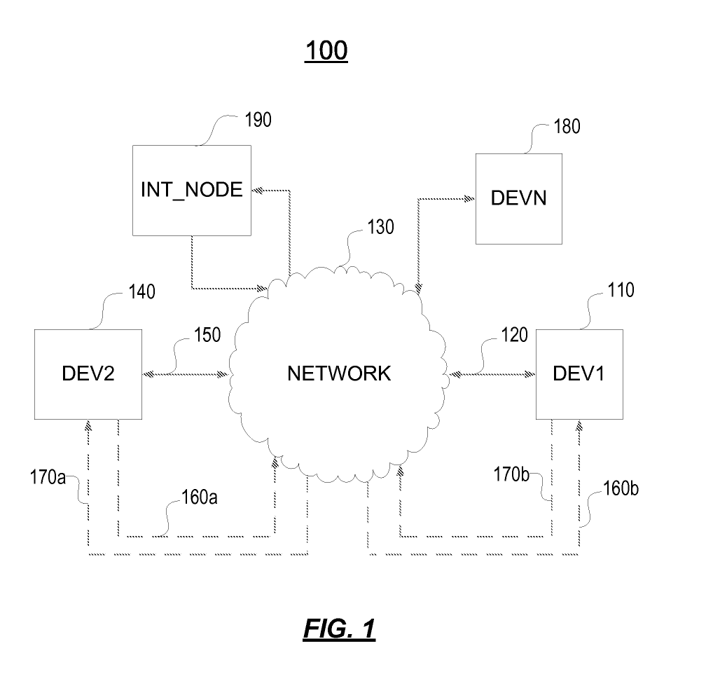

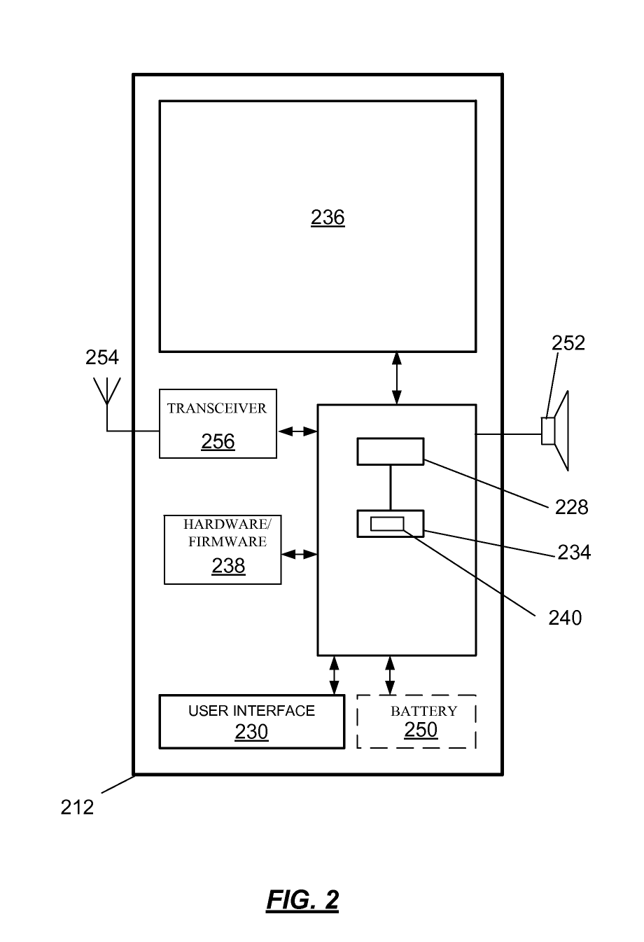

FIG. 1 illustrates a network computing environment 100 suitable for carrying out one or more aspects of the present disclosure. For example, FIG. 1 illustrates a first device DEV1 110 (e.g., device 212, FIG. 2) connected to a network 130 via a connection 120. Network 130 may include the Internet, an intranet, wired or wireless networks, or any other mechanism suitable for facilitating communication between computing platforms in general. FIG. 1 also depicts a second device DEV2 140 (e.g., a server) connected to network 130 via a connection 150. By virtue of the connectivity as shown, DEV1 110 and DEV2 140 may communicate with one another. Such communications may enable the exchange of various types of information. For example, the communications may include data to be exchanged between DEV1 110 and DEV2 140. Such data may include images, files, and the like. The communications may further include additional information such as control information.

Connections 120 and 150 illustrate interconnections for communication purposes. The actual connections represented by connections 120 and 150 may be embodied in various forms. For example, connections 120 and 150 may be hardwired/wireline connections. Alternatively, connections 120 and 150 may be wireless connections. Connections 120 and 150 are shown in FIG. 1 as supporting bi-directional communications (via the dual arrow heads on each of connections 120 and 150). Alternatively, or additionally, computing environment 100 may be structured to support separate forward (160a and 160b) and reverse (170a and 170b) channel connections to facilitate the communication.

Computing environment 100 may be carried out as part of a larger network consisting of more than two devices. For example, DEV2 140 may exchange communications with a plurality of other devices (e.g., DEVN 180) in addition to DEV1 110. The communications may be conducted using one or more communication protocols. Furthermore, computing environment 100 may include one or more intermediary nodes (e.g., INT_NODE 190) that may buffer, store, or route communications between the various devices.

FIG. 2 illustrates a generic computing device 212, e.g., a desktop computer, laptop computer, notebook computer, network server, portable computing device, personal digital assistant, smart phone, mobile telephone, cellular telephone (cell phone), terminal, distributed computing network device, mobile media device, or any other device having the requisite components or abilities to operate as described herein. As shown in FIG. 2, device 212 may include processor 228 connected to user interface 230, memory 234 and/or other storage, and display 236. Device 212 may also include battery 250 (which may be optional as indicated by the dashed box surrounding battery 250 in FIG. 2), speaker 252, antenna 254, and a transceiver 256. User interface 230 may further include a keypad, touch screen, voice interface, four arrow keys, joy-stick, stylus, data glove, mouse, roller ball, touch screen, or the like. In addition, user interface 230 may include the entirety of or portion of display 236 and/or be separate from display 236.

Computer executable instructions and data used by processor 228 and other components within device 212 may be stored in a computer readable memory 234. The memory may be implemented with any combination of read only memory modules or random access memory modules, optionally including both volatile and nonvolatile memory. Alternatively, or additionally, the memory may include a dynamic memory—e.g., a hard disk and the like. Software 240 may be stored within memory 234 and/or storage to provide instructions to processor 228 for enabling device 212 to perform various functions. Alternatively, some or all of the computer executable instructions may be embodied in hardware or firmware 238.

Furthermore, the computing device 212 may include additional hardware, software and/or firmware to support one or more aspects of the disclosure as described herein. For example, computing device 212 may include a camera (not shown) and/or audiovisual (e.g., movie/film) support software/firmware.

Device 212 may use computer program product implementations including a series of computer instructions fixed either on a tangible medium, such as a (collection of) computer readable storage medium (e.g., a diskette, CD-ROM, ROM, DVD, fixed disk, etc.) or transmittable to computer device 212, via a modem or other interface device, such as a communications adapter connected to a network over a medium, which is either tangible (e.g., optical or analog communication lines) or implemented wirelessly (e.g., microwave, infrared, radio, or other transmission techniques). The series of computer instructions may embody all or part of the functionality with respect to the computer system, and can be written in a number of programming languages for use with many different computer architectures and/or operating systems, as would be readily appreciated by one of ordinary skill. The computer instructions may be stored in any memory device (e.g., memory 234), such as a semiconductor, magnetic, optical, or other memory device, and may be transmitted using any communications technology, such as optical infrared, microwave, or other transmission technology. Such a computer program product may be distributed as a removable storage medium with accompanying printed or electronic documentation (e.g., shrink wrapped software), preloaded with a computer system (e.g., on system ROM or fixed disk), or distributed from a server or electronic bulletin board over a network (e.g., the Internet or World Wide Web). Various embodiments of the disclosure may also be implemented as hardware, firmware or any combination of software (e.g., a computer program product), hardware and firmware. Moreover, the functionality as depicted may be located on a single physical computing entity, or may be divided between multiple computing entities.

In at least one embodiment, device 212 may include a mobile client implemented in a C-based, Java-based, Flash-based or any other programming language. Device 212 may communicate with one or more servers over Wi-Fi, GSM, 3G, or other types of wired and/or wireless connections. Mobile and non-mobile operating systems (OS) may be used, such as Windows Mobile®, Palm® OS, Windows Vista®, Windows XP®, Apple OS X®, and the like. Other mobile and non-mobile devices and/or operating systems may also be used. One or more types of web browsers, e-mail applications and the like may also be used.

By way of introduction, aspects of the disclosure provide an information exchange platform member the ability to issue a recall notification with respect to one or more identified product units. As a preliminary step, the member may register with the information exchange platform. The information exchange platform may be arranged as one or more computing networks, may include one or more computing devices (e.g., Dev1 110 and Dev2 140 of FIG. 1, device 212 of FIG. 2), and may operate based on any combination of hardware, software, and firmware. As part of the registration process, or at a later time after the initial registration process has taken place, the user may identify one or more consignees and consignors of product produced or distributed by the user. For example, the one or more consignees and consignors may be customers of the user, suppliers of the user, or a combination thereof. In some embodiments, local, state, and federal administrative agencies or authorities may be members or participants in the information exchange platform. For example, in some embodiments the FDA, USDA, EPA, DHS, CDC, FBI and CPSC may be participants in the information exchange. Additional authorities (e.g., hospitals, police, fire, day care facilities, inventory banks/speculators, prison personnel, the military, etc.) may be designated as members or participants in the information exchange platform, either automatically or with the approval of the member.

Following the registration process, a member may issue a recall with respect to one or more product units via the information exchange platform. The recall may identify the one or more product units based on a universal product code (UPC) code, a GTIN (a family of GS1 (EAN.UCC) global data structures that employ 14 digits and can be encoded into various types of data carriers), NDC (a universal product identifier for human drugs) and/or other information that identifies the product to be recalled and the product units of that product which are to be recalled. The use of GTIN or similar identifying code, especially, e.g., a machine-readable GTIN or similar identifying code, advantageously can identify more precisely the product units to be recalled, leaving other product units available for continued distribution, sale and consumption. For example, the use of UPC codes typically can specify only that all product units made on certain dates are to be recalled. In contrast, depending on the additional information included in a GTIN or similar identifying code, it may enable recalling only the product units made on the dates in question by one or more particular production lines, and/or only those units incorporating an ingredient or component from a particular source, and/or only product units distributed by a particular consignee, etc. Advantageously, machine readable UPC codes, GTIN or similar identifying codes and the like may be used in certain exemplary and non-limiting embodiments to “lock-out” product units at the point of sale to consumers. For example, the identity of the recalled product units optionally can be loaded into the electronic cash register system of a retailer to preclude its sale. The accuracy typically available with machine implementation of a lock-out is especially advantageous in circumstances in which only some and not all of the units of a product then on the retailer's shelves are subject to the recall. Even if produced on the same date, the use of GTIN or similar identifying codes may facilitate lock-out of recalled units and continued sale of other units of the product, thereby decreasing the cost of the recall and increasing productivity.

Optionally, information included with the recall notification may include code information for package and case, when applicable, to target and identify specific units of the general product. The member (or, optionally, one or more authorities or a consignee or a consignor) may enter a recall notification in the information exchange platform. The recall notification may include information identifying the product units that are the subject of the recall, date/time information related to the product units or the details of their traversal throughout a product distribution chain, information identifying the criticality of the recall, and any other information that may facilitate a successful product recall. The recall notification may be distributed to one or more consignees and consignors of the user based on the information entered by the user during (or after) the registration process. The one or more consignees and consignors may acknowledge in the information exchange platform receipt of the recall notification, and the acknowledgment may be made available to the member and/or the authorities via the information exchange platform.

The one or more consignees/consignors (and/or the member and authorities) may enter into the information exchange platform the number of units they were able to account for (e.g., (re)acquire, take into possession, etc.) in response to the recall notification. The information exchange platform may keep a running count or tabulation of the product units that have been accounted for and the product units that remain unaccounted for. As the recall unfolds and develops, additional information (in the form of progress reports) may be distributed to any number of the parties (e.g., the member, the authorities, and/or consignees/consignors) as circumstances warrant.

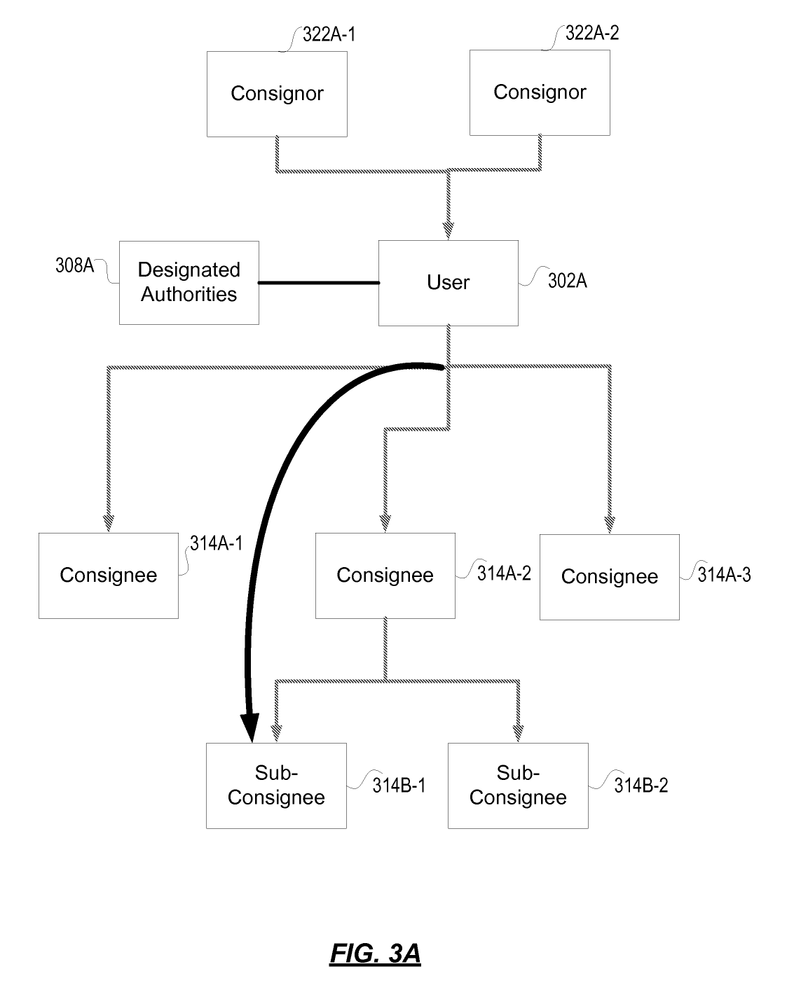

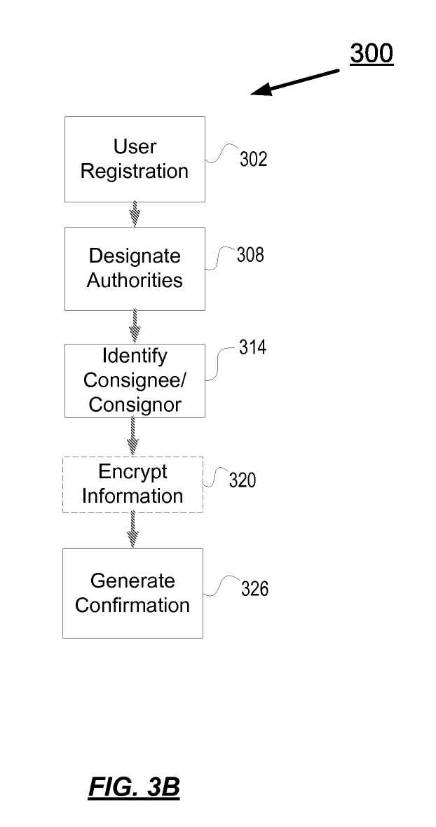

FIG. 3A illustrates an organizational flow chart suitable for demonstrating one or more illustrative aspects of the disclosure. In particular, FIG. 3A illustrates an organizational flow chart for parties to an information exchange platform described herein.

FIG. 3A includes a user 302A. User 302A may be affiliated or associated with a business that may wish to use the information exchange platform to effectuate the dissemination and distribution of product recall notices. For purposes of this disclosure, the terms user and user's business are interchangeable, and it is understood that a given business may allow one or more actual users (e.g., employees, officers, owners, members of the board of directors, etc.) to operate the information exchange platform. The information exchange platform may operate as a permission-based system to ensure that only authorized users obtain access.

As shown in FIG. 3A, associated with (and on an equal-level as) user 302A is designated authorities 308A. Designated authorities 308A may include the FDA, USDA, EPA, CPSC, CDC, FBI, DHS hospitals, police, fire, the military, and any other entity, agency, or organization. The designated authorities may be responsible for enforcing a product recall notice (in accordance with law, regulations, political pressure, etc.) and may work with user 302A to ensure that timely and accurate information is made available as the public interest requires. In some embodiments, designated authorities 308A may reside above user 302A in the organizational flow chart, and designated authorities 308A may take ultimate responsibility for overseeing and managing a product recall as discussed further below.

One or more consignees may be associated with user 302A. For purposes of illustration, in FIG. 3A user 302A is shown as being affiliated with three consignees (314A-1, 314A-2, and 314A-3). Consignees 314A-1 through 314A-3 may be customers of user 302A, suppliers of user 302A, or some combination thereof. Furthermore, consignees 314A-1 through 314A-3 may be distributors of product produced (or distributed) by user 302A.

Each of consignees 314A-1 through 314A-3 may in turn have their own consignees, which are secondary/child/sub consignees with respect to user 302A. For example, as shown in FIG. 3A, consignee 314A-2 has its own associated consignees 314B-1 and 314B-2. The relationship between consignee 314A-2 and (sub) consignees 314B-1 and 314B-2 may be similar to the relationships described above between user 302A and consignees 314A-1 through 314A-3. Moreover, user 302A may share a (direct) relationship with one or more of the sub consignees. For example, as shown via the heavy/weighted arrow in FIG. 3A, user 302A may share a (direct) relationship with sub consignee 314B-1.

Also associated with the registered user may be one or more consignors. As shown in FIG. 3A, associated with user 302A is consignors 322A-1 and 322A-2. Consignors 322A-1 and 322A-2 may deal in a similar product as one another with respect to user 302A, or may deal in diverse products with respect to user 302A, or some combination thereof.

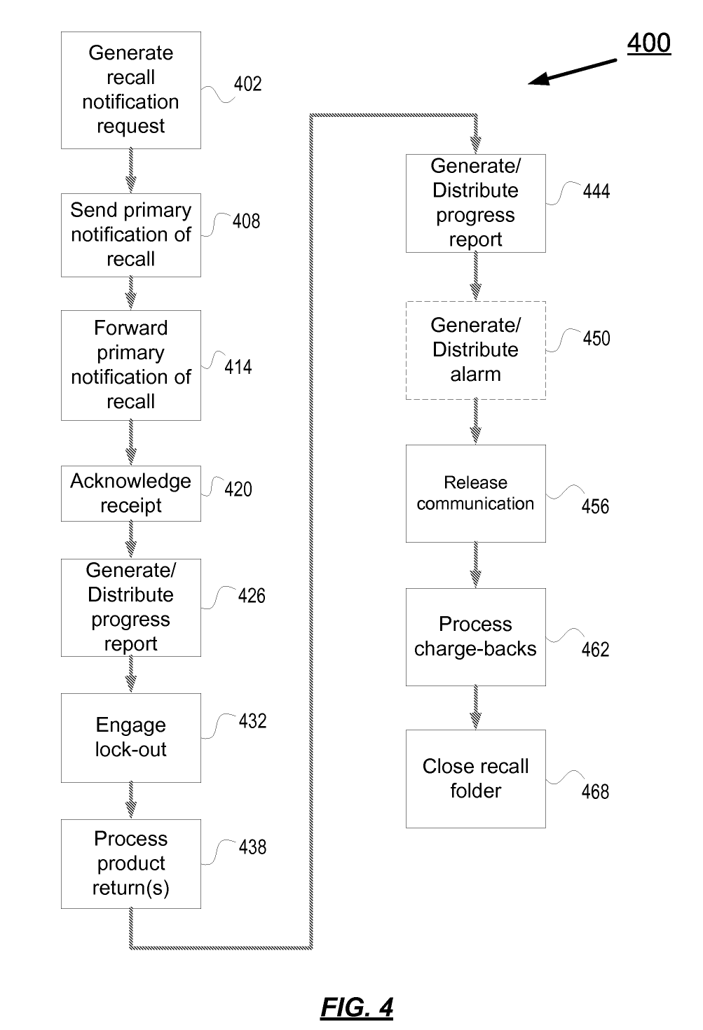

The organizational flow chart demonstrated in FIG. 3A is merely illustrative. Other organizational flows may be used in various embodiments. For example, a hub-and-spoke organization may be used, wherein the information exchange platform hardware/software/firmware serves as the hub, and the parties (e.g., a user, consignees, consignors, and authorities) are arranged around the information exchange platform hardware/software/firmware hub as the endpoints of the spokes. Furthermore, accompanying such a hub-and-spoke organization, a push-pull architecture may be used. For example, one or more of the user, consignees, (sub consignees), and consignors may submit or push product related information (which may include recall notification requests as discussed below in conjunction with FIG. 4) into the information exchange platform hardware/software/firmware hub. In response to the submitted/pushed information, the authorities may pull the (pushed) information from the information exchange platform hardware/software/firmware hub and may make one or more decisions based on that information (e.g., the authorities may issue or approve of a recall).

In some embodiments, a push-push type of architecture may be used. For example, a user may push product related information (which may include a recall notification request) into the information exchange platform hardware/software/firmware hub. In response to receiving the pushed product related information from the user, the information exchange platform hardware/software/firmware hub may push the information to one or more of the parties to the information exchange (e.g., consignors, consignees, authorities, etc.).

FIG. 3B depicts a flow chart describing a method 300 suitable for carrying out one or more aspects of the disclosure as described herein. In particular, method 300 illustrates a registration and information entry process associated with a user (e.g., user 302A of FIG. 3A). Method 300 may be executed on any suitable computing platform (e.g., Dev1 110 and Dev2 140 of FIG. 1, device 212 of FIG. 2). More specifically, method 300 may be executed in conjunction with a (web) browser (e.g., MICROSOFT INTERNET EXPLORER, MOZILLA FIREFOX, APPLE SAFARI, GOOGLE CHROME, OPERA, etc.) or the like, such as via a client/server, Java, Java Script, AJAX, applet, Flash®, Silverlight™, or other applications, operating systems, devices and the like. In fact, any of the methods described herein and any of the device architectures/embodiments may be executed/implemented at any level of computing abstraction, and are not in any way limited to merely web based solutions.

In step 302, a user registers with an information exchange platform. The user registration may include the user entering factual data related to the user or the user's business (e.g., an electronic mail (e-mail) account associated with the user, specific areas of trade, distribution, and goods produced or served, etc.). As such, the information exchange platform may use the information as part of a larger taxonomical or classification scheme. The information may be entered into a universal exchange compliance form at a client computing device (e.g., device 212 of FIG. 2), and the exchange compliance form may be uploaded to a server or the like. Alternatively, or additionally, the user registration (via the exchange compliance form) may be updated by the information exchange platform based on historical activity the user or user's business has undertaken. For example, if a user initially is involved in the distribution and sale of cans of soup, but later modifies her business to only deal in canned tomatoes, the user registration/exchange compliance form may be updated to reflect that the user has changed product lines. This update may take place “behind the scenes” in some embodiments, as a user might not be aware that the update has taken place. In other embodiments, the user may be required to approve of the update before it is entered.

In some embodiments, a user might not want to enter all of the information that she has available to her regarding her business. For example, for competitive reasons the user might not want to upload information identifying customers, UPC codes or quantities of product the user maintains in inventory at her place of business. Such information may serve as a trade secret with respect to the user's business, or more generally, privacy considerations may dictate keeping such information outside of the information exchange platform. Accordingly, in some embodiments, an application programming interface (API) may integrate with the information exchange platform to upload only that data that needs to be entered into the information exchange. Such an API may be particularly suitable for users, consignors, consignees, authorities, etc. that have legacy platforms and infrastructures in place, allowing those users and businesses to continue to leverage off of their history with such platforms and infrastructures. The API may also support data transformation in order to effectuate the integration. The information exchange platform may provide its own set of tools and custom interfaces to allow users to build a recall or product distribution chain/flow/model from scratch. In some embodiments, the information exchange platform may support a library of application programming templates that may be customized or modified by users to support unique user needs.

In step 308, one or more authorities (e.g., designated authorities 308A of FIG. 3A) may be designated to partake in the information exchange. The one or more authorities may be automatically added or designated by the information exchange platform based on the identity of the user, the types of products produced or served, etc. For example, if the user is dealing in a line of products that have a wide base or volume of distribution (e.g., milk), or that have dangerous propensities (e.g., weapons manufacture), authorities may be automatically added without requiring user action or approval. Conversely, if the user is dealing in relatively benign products, or products of limited distribution scope (e.g., custom made products for a limited number of customers), the authorities might not be added (or may be added only upon user 302A approval).

In step 314, the user may identify one or more consignees (e.g., consignees 314A-1 through 314A-3 of FIG. 3A) and consignors (e.g., consignors 322A-1 and 322A-2 of FIG. 3A) of her business. As discussed above, the one or more consignees/consignors may be a customer of the user's business, a supplier of the user's business, a distributor of products for the user, or a combination thereof. The one or more consignees/consignors may be identified when the user is registering with the information exchange platform (e.g., during step 302 of FIG. 3B) for the first time, or at a later time. The identification of the consignees/consignors to the information exchange platform may be based on information similar to the information included by the user during step 302. For example, consignment information may include an e-mail account associated with a consignee/consignor, specific areas of trade, distribution, and goods produced or served, etc.

In some embodiments, privacy considerations may dictate keeping consignee/consignor information a secret, e.g., for reasons similar to those discussed above with respect to the user. As such, in some embodiments, data encryption/decryption techniques may be used to allow the information exchange platform to have access to sensitive information (thereby improving the accuracy and timing of the notices and results generated and distributed by the information exchange platform) while depriving unauthorized third parties (which may include the user, consignee, consignor, and/or administrative authorities) from viewing or accessing that sensitive information or learning of the identities of one or more of the parties to the information exchange platform. Step 320 demonstrates an optional step (the optional nature of the step being shown via the broken lines) of encrypting information entered into the information exchange platform. When a party to the information exchange platform desires to access or view information maintained in the information exchange platform, that party may be required to submit to a decryption algorithm. For example, a consignee attempting to review information related to the user may be confronted by a challenge question or may be forced to enter a password in order to obtain access or visibility to the information.

Alternatively, or additionally, as described above a user's contact list may be maintained in confidence/secrecy on the basis of an indexing and cross-referencing scheme. For example, a user may submit a list of contacts to the information exchange platform, and the information exchange platform may assign a member identification number (ID #) to each contact included in the list. Thereafter, an identification of the user's contacts may be transformed by the information exchange platform, such that the contact information might only take the form of member ID #s to unauthorized users. Authorized users (e.g., the registered user/member and/or one or more designated authority) may be able to obtain access to the correlative relationship between the contact list and the corresponding member ID #s.

In step 326, one or more confirmation messages may be generated by the information exchange platform. For example, an e-mail message may be sent to one or more of the user, a consignee, a consignor, and (administrative/designated) authorities after the user has completed the registration process. An e-mail message may also be sent following any modifications to the information entered with respect to the user, the consignee, the consignor, and the designated authorities. In some embodiments, alternative communication techniques (e.g., facsimile/FAX, telephone call, letter/mail) may be used instead of, or in addition to, e-mail. Non-packet based forms of communication may be used.

Method 300 is illustrative, and it is to be understood that modifications may be made without departing from the spirit and scope of the method. For example, one or more steps may be made optional (e.g., step 320 is shown as optional, however, other steps may be made optional in some embodiments). In some embodiments, additional steps (not shown) may be included. For example, in some embodiments the designated authorities may need to approve of a user registration before it is allowed to be entered into the information exchange platform.

Furthermore, method 300 may be implemented in a recursive fashion to allow additional registrations to take place. For example, the one or more consignees (e.g., one or more of consignees 314A-1 through 314A-3 of FIG. 3A) identified in step 314 may register with the information exchange platform in a later iteration, bringing in their own (sub) consignees (e.g., sub-consignees 314B-1 and 314B-2 of FIG. 3A) to the information exchange platform. In this manner, the information exchange platform may grow exponentially, and may be used to link an entire distribution chain from manufacturing to the lowest levels of retail sales. The service provider of the information exchange platform may offer coupons or discount incentives to encourage registration or participation in the information exchange platform. For example, if ten (10) of the user's consignees register with the information exchange platform, the user may receive one year of free service or service at a reduced price.

In some embodiments, a user may require the user's suppliers to pre-register with the information exchange platform. For example, the user may achieve such an objective through an addendum to an existing purchase contract. An exchange processor associated with the information exchange platform may maintain a registry that tracks compliance with such requirements and may generate one or more notifications when required pre-registrants fall out of compliance (e.g., when pre-registrants fail to renew annual memberships). The registry may index and cross reference all members and the respective pre-registration requirements between all members. For example, a soup company may be required to pre-register by one or more buyers. The soup company may require its ingredient suppliers and contract packers to pre-register. All such pre-registration requirements between exchange members may be contained in a master registry, with each member having access to a display device (on or off server, web based or client-server) identifying compliance or non-compliance.

FIG. 4 illustrates a flow chart describing a method 400 suitable for carrying out one or more aspects of the disclosure as described herein.

In step 402 a recall notification request may be generated. The recall notification request may be generated by one or more of the parties discussed above with respect to FIGS. 3A-3B (e.g., a registered user, a consignee of the registered user (or a sub-consignee), a consignor of the registered user, or an administrative/designated authority), and that party may be termed a recalling firm (RF). In some embodiments, the recall notification request must be generated by the user (e.g., only the user can serve as the RF). In some embodiments, the recall notification request may be generated by the first party to the information exchange platform to discover a problem or issue with effected product unit(s). In some embodiments, the recall notification may be generated by a party that does not exist within (e.g., is not a member or participant of) the information exchange platform. The recall notification request may be implemented as an electronic form (e.g., a universal tracking form) wherein selections of (radio) buttons or options from one or more menus, windows or the like may be made. Fields may also be provided to allow for customized entry of information or data related to the recall. Options may be presented to allow for the generation of one or more progress reports that may be distributed in real-time.

The recall notification request may include one or more pictures and videos to help facilitate product recognition or product discrimination. For example, if a product is shipped in secure/sealed containers, distributors may need a visual depiction of the effected product to be able to determine what the product is or to be able to distinguish the effected product from other similar products.

As part of step 402, the information exchange platform may open up a new electronic recall folder for the matter. All notices, communications, and the like related to the recall may be stored in the electronic recall folder. The step of opening a recall folder may need to be approved by one or more of the parties (e.g., an administrative/designated authority) before the recall folder is activated or is allowed to remain on the information exchange platform. For example, an administrative authority may pull the recall notification request from a server and may approve the opening of a recall folder in response thereto. The administrative/designated authority may thus serve to protect participants of a distribution chain against abusive practices by a user (e.g., a user out to get revenge against a participant in the distribution chain). The electronic recall folder may be used to distinguish a given recall matter from another recall matter. Moreover, the information exchange platform may support linking or defining a relationship status between two or more electronic recall folders. Such linking may be beneficial when two or more recalls are related, yet distinct matters, such as in an ingredient-driven recall where multiple RFs and products may be involved.

While discussed above with respect to an issue or problem, it is understood that the techniques related to generating (and disseminating) a recall notification request or opening a recall folder could be adapted and applied to a situation before the situation has been confirmed as a definite issue or problem. For example, one or more “watch folders” may be created that may serve as a basis for monitoring whether a potential situation matures to the point that a recall needs to be initiated. Such a watch folder may be particularly beneficial to parties that need to devote or allocate scarce resources.

Pre-recall, information exchange platform members may use an intelligence service as a decision support tool to manage day-to-day product safety, defense and supplier issues. Services may be delivered outside the information exchange platform, but in some embodiments integration, linking, and/or launching from within the information exchange platform may be supported.

Subscription-based service may include targeted delivery of information (pre-recall incident alerts, off-exchange recalls and alerts, foreign recalls, etc.) from around the globe by origin of products (country, state, province), distribution of products, and product categories.

Product categories may include food products and ingredients (for human consumption), which in turn may include: blanket food, produce/crops, nuts/seeds, meat & poultry, dairy, seafood, etc. Product categories may include food products and ingredients (for animal/pet consumption). Product categories may include pharmaceutical, tobacco, liquor categories. Product categories may include general merchandise and health and beauty care (HBC). Other categories may be included in product categories.

Incident alerts may be generated. Incident alerts may include: product recalls, withdrawals, and tampering incidents (on/within and off/outside of the information exchange platform), foodborne illness outbreak alerts, food defense threats and events (e.g., terrorist activity with respect to food and beverage products/ingredients, water supply tampering, etc.), counterfeit product identifications, product extortion, product contamination events, TrendTrack™ Reports, and heads-up alerts.

Based on the foregoing description, an instant notification (e.g., desktop, email, SMS, text, voicecast) to remove products and/or recalled ingredients from process/distribution may be obtained quickly. Off-exchange incident alerts and recalls, as well as alerts and recalls processed through the exchange may be obtained.

Based on the foregoing description, purchasing personnel may be positioned to arrange alternate sources of key products and ingredients, before competitors or speculators lock up excess supply.

Based on the foregoing description, a swift corporate response to crisis events, including consumer liability issues may be obtained.

Based on the foregoing description, a user may obtain additional time to prepare before consumers, the media, regulators, and the like demand answers.

Based on the foregoing description, a follow-up process may be engaged for UPC's and other product identifiers usually omitted from recalling firm (RF) press releases, enabling consignees/consignors (e.g., retailers and wholesalers) to determine if they have affected product in their system.

Based on the foregoing description, a voicecast, emergency telephone broadcast notification system may be used to broadcast or disseminate information or alerts related to extremely urgent incidents or threats. Voicecasts may be provided over a given time period, or may be continuous (e.g., 24 hours per day/7 days per week) as an additional notification channel to mitigate risk.

Based on the foregoing description, increased productivity may be obtained. For example, personnel may have access to a reliable source on critical food safety issues and can focus on core business matters rather than scouring the web/Internet to find information that may already be known and delivered.

Based on the foregoing description, incident alerts, reports, and other information may be disseminated to various departments or divisions of a user's business, enabling cost and information sharing.

Based on the foregoing description, real-time feed and archives of incident alerts (including product recalls) and key government regulatory/enforcement actions (e.g., warning letters, import alerts, EU RAPEX, etc.) may be obtained. A user may setup an alert profile that includes key words and phrases and lists on issues, suppliers, ingredients, brands, labels or other information to track. For example, a retailer or processor may enter a list of all current suppliers under an alert called “MY SUPPLIERS.” The information exchange platform may be configured to pull matching documents from an archive with key words and phrases highlighted. Any new incident disseminated through the system may be identified as a new, updated item under the alert profile. In another example, a retailer or processor may enter the names of key products and ingredients under an alert called “MY INGREDIENTS.” The system may pull matching documents from the archive with key words and phrases highlighted. In all instances, the user may set internal notification actions to be performed when a new item arrives (email, audio, visual, desktop, blinking headline, pop to top, and the like). A user may also use a ‘search’ function to pull data on a prospective new supplier to determine product safety track record. For example, the information exchange platform may pull recalls, outbreaks, warning letters and other regulatory enforcement actions assessed against the new supplier.

The information exchange platform may monitor one or more web sites for purposes of generating/disseminating a recall notification request or opening a recall folder. For example, the information exchange platform may monitor a web site operated by one or more authorities. The information exchange platform may detect a change to the web site, and may generate/disseminate a recall notification request or open a recall folder responsive thereto. In some embodiments, web sites affiliated with or operated by one or more of the other parties may be monitored for such purposes.

Referring back to FIG. 4, in step 408, once the recall notification request is entered into the information exchange platform, a primary notification of the recall may be transmitted to one or more of the parties. For example, a primary notification may be sent to consignees that carry, distribute, or sell product related to the recall. The primary notification may refer to the product on a general level (e.g., soup brand X, chicken noodle) or may include additional details and information (e.g., UPC codes, GTINs, date/time stamps in relation to the location of the product within the distribution channels, etc.) in order to isolate and identify the product unit(s) that is/are the subject of the product recall notification. The primary notification may be transmitted as, and take the form of, an e-mail message. In some embodiments, alternative forms of communication may be used (e.g., RSS, facsimile/FAX, really simple syndication (RSS), auto phone dial, etc.) to transmit the primary notification.

In certain exemplary and non-limiting embodiments or versions of the recall information exchange system disclosed here, the primary notification may be sent automatically to some or all of the consignees of the product units that are being recalled. In some embodiments, an RF member may have an obligation to notify consignees shown on the RF member's records as having been shipped recalled product. For example, if the RF member includes in the recall notification request the identity of one or more consignees for the product type that is subject to the recall, including an address (e.g., an e-mail address, text message address, phone or fax number, etc.), then the information exchange platform may automatically transmit the primary notification to such consignees.

In step 414, the primary notification may be forwarded to additional parties. For example, in response to having received the primary notification in step 408, a consignee may forward the primary notification to its own sub-consignees (alternatively referred to as secondary or child consignees). In some embodiments, this forwarding may take place automatically. For example, if the sub-consignee is already registered as a member of the recall information exchange system and has included the identity of sub-consignees for the product type that is subject to the recall, then in at least certain exemplary and non-limiting embodiments of the recall information exchange systems disclosed here, the information exchange platform automatically extends the recall notification to such sub-consignees by sending each of them a primary notification. Alternatively, in some embodiments, a blanket notification may be sent to all exchange members. For example, a contact list associated with the RF may be examined by the information exchange platform, and any member included on the RF member's contact list may receive the primary notification.

In other embodiments, the consignee may have to take an affirmative action to notify its sub-consignees (if any). For example, in certain exemplary and non-limiting embodiments the information exchange platform is configured to receive the identity of sub-consignees from consignees who receive a primary notification. In some such embodiments the information exchange platform is configured to generate and include in the primary notification sent to the consignee(s) a user interface displayable on a display device of a computer of the consignee, wherein the user interface includes a first region configured to receive sub-consignee identification information input by the consignee. In other embodiments the consignee may be required or have the option of pressing a forward button in an e-mail application or graphical user interface (GUI) to forward the primary notification to e-mail or other EDI address or the like for any or all of its sub-consignees. Furthermore, as described above, an indexing and cross-referencing scheme may be used to allow the primary notification to be transmitted on the basis of a member ID # selected from a candidate pool of member ID #s maintained in a registry. Such a scheme may allow for communications to be initiated internal or external to the information exchange platform, yet still allow response to be received within the information exchange platform.

In some embodiments, the primary notification may be forwarded to administrative/designated authorities or consignors using similar techniques. For example, the primary notification may be forwarded to the administrative authorities and consignors automatically. In some embodiments, the primary notification may be forwarded to the administrative authorities and consignors automatically responsive to the push of a forwarding button in one or more applications/application interfaces. Techniques similar to those described above may also be used.

Data or informational filtering techniques may be applied such that only that information that is necessary is forwarded to the secondary/child/sub consignees and the administrative/designated authorities. In this manner, privacy may be maintained and the secondary/child/sub consignees and administrative/designated authorities might not be burdened by information that might not be relevant to them. Furthermore, by filtering out the information, transmission bandwidth may be conserved with respect to the information exchange platform.

In step 420, a consignee may acknowledge receipt of the primary notification of the recall (with failure to do so subject to penalty of law). By receiving the acknowledgment of receipt, the user may be able to absolve herself from liability (or mitigate her liability) by having acquired proof that she put her consignees on notice of the recall. The acknowledgment may also serve as a form of contract or agreement that the consignee agrees to be bound by the terms and conditions of the recall. The acknowledgment may also be used as a mechanism for requesting additional information with respect to the recall.

In step 426, a progress report may be generated by the information exchange platform. The progress report may include a count of the total number of units of product that is the subject of the recall, an identification of the product (e.g., via a UPC or GTIN code and any additional information that may serve to uniquely identify the subject product), and a status of the product (e.g., in consignee possession, unaccounted for, etc.). The progress report may provide an identification of the parties that are responsible for carrying out the recall, and what their roles are for purposes of the recall. The progress report may also indicate any actions that a user, consignee, or consignor has taken to effectuate an accounting or return of the subject product units. Similar to the recall notification request discussed above with respect to step 402, the progress report of step 426 may include one or more photos or videos. Such photos or videos included with the progress report may serve as confirmation that product unit(s) has/have been confiscated, taken into possession, destroyed, etc. One or more of the parties may use the photos or videos to confirm with other party members that product is included within the recall. Such photos/videos may be helpful in reducing the amount of time that a given product's status with respect to the recall remains in an unknown state.

While shown as a distinct step 426, a progress report may be generated periodically or in response to particular events during the recall. For example, a progress report may be generated in response to a consignee report as discussed further below. The generated progress reports may be distributed to one or more of the parties to the information exchange platform. The progress report may take the form of a photo, a video, an e-mail, a telephone call, a facsimile/fax, a(n instant messaging) chat, short message service (SMS) messaging, a hyperlink that opens up to an Internet web page, etc. A program on a server, a local computer, or a client-server program may be used to generate the progress report In step 432, a lock-out may be engaged. The lock-out may be engaged by retailers at their own discretion. The lock-out may prevent a further distribution of affected product units. For example, if the product units effected by the recall include two thousand (2,000) palettes of chicken noodle soup, a retailer may be precluded from taking possession of one (or more) of the two thousand palettes from a wholesale distributor. Similarly, if the affected chicken noodle soup has already made its way onto the retailer's store shelves, a shopper may be prevented from purchasing a can of the chicken noodle soup at the retail store's check-out register. For example, a register clerk may scan a bar code or label and a message may appear on a visual display of the check-out register informing the clerk (and shopper) that the product is unsellable, that it has been recalled, or providing any other suitable status message.

The lock-out discussed above may be based on UPC codes, GTINs, GLNs and additional information that may be used to distinguish the effected two thousand palettes of chicken noodle soup from otherwise identical chicken noodle soup that is not the subject of the recall. In this manner, when a customer/shopper attempts to return a can of chicken noodle soup, believing that her can is included in the recall, the retailer can determine within a reasonable amount of time, based on the UPC code, GTINs, GLNs and additional information, whether that customer's/shopper's can of chicken noodle soup is included in the recall (e.g., that it originated from one of the two thousand palettes). In this manner, unnecessary returns can be avoided if the customer's can was not included in the two thousand palettes of chicken noodle soup. In some embodiments, lockouts may be requested of retailers with lockout capability by the RF in their notification via, e.g., an exchange Universal Form.

In some embodiments, at least initially, the lock-out may be applied to all products of a given type (e.g., all cans of chicken noodle soup of brand X, as opposed to merely the suspected two thousand palettes of chicken noodle soup). For example, the producer/manufacturer of the chicken noodle soup (e.g., the user of the information exchange platform) initially might not know of the extent of the problem/issue, which consignees are or were in receipt of potentially bad product, etc., and may want to lock-out all the products of the given type in order to be conservative. Over time, as more information becomes available, the producer/manufacturer may be able to isolate the problem to the two thousand palettes, and thus, the total lock-out may be modified to merely encompass a partial lock-out of the two thousand palettes in response thereto. Conversely, a partial lock-out may be extended to a full lock-out in the event that subsequently learned or discovered information dictates taking such action. Thus, an RF member may expand or contract a recall, and may request retailers through blanket instructions (to wholesalers, food brokers, and other intermediaries) to initiate register locks.

In step 438, returned product may be processed. Continuing the above example related to chicken noodle soup, if a customer/shopper brings back a can of soup to the retailer, and the can of soup is one of the cans being recalled, the retailer may take possession of the can of soup (refunding the customer/shopper the value of the can of soup). The retailer may then engage in one more actions with respect to the can of soup. For example, if the notification of recall (steps 408, 414) indicates that the retailer is to destroy the can of soup, the retailer may destroy the can of soup in order to comply with the notification of recall. Similarly, if the notification of recall indicates that the retailer is to send the can to the wholesale distributor for collection, the retailer may send the can of soup to the wholesale distributor to comply with the notification of recall.

As part of processing the returns in step 438, or as a separate step (step 444 in FIG. 4), the information exchange platform may distribute one or more progress reports in a manner similar to step 426 described above. The progress reports associated with step 444 may be distributed after any product that is the subject of the recall has been taken into possession. Alternatively, to reduce the number of progress reports that are generated and distributed, a progress report may be generated after the number of products taken into possession exceeds a threshold (e.g., after every ten cans of chicken noodle soup have been taken into possession). In some embodiments, the progress reports may be generated periodically for the duration of the recall. A RF member may maintain control over an ultimate or final progress report, and may release all or a portion of the data included therein to regulatory/administrative/designated authorities at the RF member's discretion (or as required by law). The RF member may set a (periodic) timer with the information exchange platform that may disseminate or release information at periodic intervals. Alternatively, or additionally, the RF member may manually request a release of information (via, e.g., a button, a key, or the like).

In (optional) step 450, an alarm may be generated and distributed to the parties of the information exchange platform. For example, if one or more of the parties is unresponsive (e.g., fails to acknowledge receipt in step 420) or fails to take an action in accordance with the recall notification request, an alarm may be signaled. The alarm may be of an auditory nature (e.g., a beeping, humming, buzzing, ringing sound, or the like), a visual nature (e.g., a flashing light on a computer screen, an e-mail or text message, etc.), or the like. The alarm may be signaled if one or more of the parties (e.g., a consignee) fails to account for that party's entire volume of the recalled product units or if a party fails to acquire its share of the recalled product units within a threshold amount of time. A determination of whether to signal an alarm in step 450 may also be a function of the urgency associated with the recall. For example, if the recall is relatively benign, such as a button missing from a sweater, an alarm might not be sounded in some embodiments. Conversely, if the recall is related to a food product that, if ingested, could cause extreme food poisoning in humans, an alarm might be sounded in those same embodiments.

In step 456, product related press releases may be issued by the information exchange platform. The information exchange platform may accept as inputs (meta)data related to consumer perception of the product, consumer perception of how the recall is being handled, etc. The information exchange platform may also compare the inputs/information contained in the electronic recall folder (opened as part of step 402) to past instances of product recalls to recommend one or more communications or press releases. Such communications may be particularly beneficial in order to calm the public in the event of an emergency.

In step 462, charge-backs may be processed. For example, in order to comply with a product recall initiated by a RF member, a consignee of the RF may negotiate with the RF to have the RF incur the consignee's costs associated with the recall. These costs may include not only the money associated with the value of the product itself, but also administrative costs incurred by the consignee for having to process, inventory, and ship or destroy the returned/removed product units. The charge-back may result in the consignee's account being credited by the RF or it may result in the direct disbursement of a cash or check to the consignee.

In step 468, the electronic recall folder opened as part of step 402 may be closed and archived. The closing of the recall folder may take place in response to one or more events. For example, if the entire volume of product that is the subject of the recall has been accounted for (and any corrective action that may be required has been taken), then the recall folder may be closed. Alternatively, in some embodiments, if risk associated with the recall has been mitigated to below a threshold value, or if the amount of time that the recall folder has been open exceeds a threshold value, then the recall folder may be closed. As part of closing the folder, a recall completion notification message may be transmitted to the party that closed the recall folder (if done manually), and/or to the RF and a registered administrative authority.

One of more of the parties to the information exchange platform may continue to have access to the information contained in the recall folder, even after it is closed, while another of the one or more parties may lose access rights to the folder (and hence, the information contained therein) once the recall folder has been closed. The closing of the recall folder may take place automatically or based on a manual input. Accordingly, the information exchange platform provides flexible control with respect to the management of the recall process.

The steps associated with the method depicted in FIG. 4 are illustrative, and it is understood that in some embodiments, some of the steps may be made optional, and additional steps (not shown) may be included. For example, as a sort of “heads-up” feature, information from parties other than a RF member regarding product safety may be received, and one or more alerts may be issued regarding the same to one or more members of the information exchange platform. In some embodiments, the progress reports may be used to convey an update to information included in the recall folder. For example, if one or more of the parties erroneously entered incorrect information, but later modifies (e.g., corrects that information), a progress report may be generated and distributed to capture the modification. Additionally, the ordering of the steps shown in FIG. 4 may be modified in some embodiments.

Additional features and services may be provided in some embodiments. For example, a physical retrieval of recalled products service may be included. An RF member may use existing staff (direct store delivery (DSD) staff) or contract services to facilitate the physical retrieval of recalled products to third party vendors. The information exchange platform exchange processor may provide the RF with tools to automatically provide DSD staff or third party vendors with recall information, consignee lists, instructions, and other information necessary to perform the task of physically removing and accounting for products physically collected from consignees. The exchange processor may provide the RF with the ability to grant limited access to exchange data for the purpose of reconciling the quantities of recalled products with retailers/wholesalers.

As described above, blanket recall notifications may be supported in some embodiments. Blanket product-specific targeted alerts may be included with respect to the following categories: (1) food products and ingredients for human consumption, which in turn may include blanket food, produce/crops, nuts/seeds, meat and poultry, dairy, seafood, etc., (2) food products and ingredients for animal/pet consumption, (3) pharmaceutical, tobacco, and liquor/alcoholic products, (4) general merchandise and health and beauty care (HBC), and (5) other product categories.

The information exchange platform may offer associate membership privileges to select companies who provide services related to the recall process. For example, such privileges may include: product recall insurance, product liability insurance, physical retrieval of recalled products, 1-800 and call center services, emergency telephone broadcast services, crisis management services, public relations (PR) services, tracking and traceability services, and other services. Based on the services provided, a user's market for potential clients may be expanded and discounts may be negotiated to reduce overall costs of services to members. As prices decrease, services may be made available to small and medium size members, thereby expanding the reach and usefulness of the information exchange platform. Through exchange “listing” of leading/notable/reputable service providers, members are provided with one-stop shopping for services on-demand. In order to ensure integrity and reliability in conjunction with the information exchange platform, service providers may be subject to a vetting process to ensure that their services have been deemed up to par in the past. Service providers may also be subject to member-nomination or an information exchange platform committee approval process.

In some embodiments, the information exchange platform may be configured to provide the Food and Drug Administration (FDA) with the ability to upload contact database(s) created under the Bioterrorism Act of 2002, specifically “Registration of Food Facilities,” to facilitate notifications to contact lists on a targeted (by industry, product category etc. . . . ) or blanket basis. The exchange processor may provide real-time progress reporting a registry of Registered Food Facilities by ID #'s indexed and cross referenced with email addresses, etc. (using exchange specific email addresses and member ID #s per the exchange process. This service can be set up on a dedicated server for security reasons and serve as a redundant system for FDA use.

As described herein, a bi-directional flow of information may be supported within the information exchange platform. For example, a RF member may issue a notification of a product recall in a downstream direction (e.g., toward consignees), and progress reports may be generated and disseminated in an upstream direction (e.g., toward the RF) as consignees throughout the chain reply/respond to the recall.

As described herein, the information exchange platform may be operative across one or more computing servers and one or more computing networks. The functionality may be distributed in any manner, or may be located in a single computing device (e.g., a server, a client computer, etc.). As discussed herein, the information exchange via the information exchange platform may take place in real-time (or substantially in real-time). Thus, the parties to the information exchange platform may be apprised of the events associated with the recall as they are developing throughout the entirety of the recall process.

As described herein, the methodological acts and processes may be tied to particular machines or apparatuses. For example, one or more computers may include one or more processors and memory storing instructions, that when executed, perform the methodological acts and processes described herein. Furthermore, the methodological acts and processes described herein may perform a variety of functions including transforming an article (e.g., computer data) into a different state or thing (e.g., distributed/disseminated product recall notices, tabulated product counts/tracking, alarms, progress reports, etc.).

Moreover, the description herein has been phrased with respect to product recalls or withdrawals. However, it is understood that the subject matter, techniques, and methodological acts may readily be adapted and applied to different application contexts that relate, generally, to the dissemination of information. As an illustrative, non-limiting example, the subject matter may be adapted to accommodate a dissemination of information related to not only the distribution of products, but stop sale orders, consumer alerts, product tampering, product holds, bioterrorism incidents/threats and outbreaks.

In certain illustrative and exemplary embodiments, an exchange processor may be configured to receive product information including at least UPC or GTIN numbers for at least some product units being recalled. The term GTIN is used here to mean any identification data structure, e.g., the UPC. GTINs in commercial use may, for example, employ 14 digits and can be encoded into various types of data carriers, e.g., bar codes, radio frequency identification (RFID), etc.

In certain illustrative and exemplary embodiments, an exchange processor may be configured to receive product information including at least date codes, size information, distribution information, instructions for executing a recall, and a reason for the recall for at least some product units being recalled.

In certain illustrative and exemplary embodiments, an exchange processor may comprise at least one server.

In certain illustrative and exemplary embodiments, an exchange processor may be configured to register state and federal governmental agencies as exchange system members.

In certain illustrative and exemplary embodiments, an electronic communication pathway for electronic data interchange by an exchange processor may comprise any combination of one or more EDI pathways, internet connections, packet switched networks, cell phone systems and public phone system lines.

In certain illustrative and exemplary embodiments, an exchange processor may be configured to: receive a sub-consignee report from a reporting consignee that identifies one or more sub-consignees that received from the consignee one or more product units for which a recall is to be executed and at least certain product units received by the sub-consignee; generate and transmit a sub-consignee report receipt to the reporting consignee acknowledging receipt of the sub-consignee report; update a tabulated consignee status to include the sub-consignees identified by the sub-consignee report; generate and transmit a consignee status notification to a recalling firm and at least one designated authority providing at least information corresponding to the identity of the reporting consignee and the tabulated consignee status updated to include the sub-consignees identified by the sub-consignee report; generate and transmit a primary recall notification to one or more of the identified sub-consignees identifying at least product units for which the recall is being implemented; receive a progress report from any of the identified sub-consignees indicating a status of product units for which the recall is being implemented; and update the tabulated recalled units status in response to receipt of each progress report from a sub-consignee.

In certain illustrative and exemplary embodiments, a recalling firm may retain control over a release of information to at least one designated authority.

In certain illustrative and exemplary embodiments, a recalling firm may perform at least one of: setting a timer that automatically releases information at a periodic rate and manually requesting the release of the information.

In certain illustrative and exemplary embodiments, an exchange processor may be configured to: determine a time duration from a transmittal of primary recall notifications to identified consignees, and generate and transmit a recall reminder notification and transmit to identified consignees to which a primary recall notification was sent and from which a consignee acknowledgment was not received within a predetermined period of time; update a tabulated consignee status to indicate the transmittal of the recall reminder notification; and generate and transmit a consignee status notification to a recalling firm and at least one designated authority providing at least information corresponding to a tabulated consignee status updated to indicate the transmittal of the recall reminder notification.

In certain illustrative and exemplary embodiments, an exchange processor may be configured to: determine if and when all product units for which a recall is being implemented have been accounted for by consignees; update a tabulated recalled units status to indicate that all product units for which the recall is being implemented have been accounted for by consignees; and generate and transmit a consignee status notification to a recalling firm and at least one designated authority providing at least information corresponding to the tabulated recalled units status updated to indicate that all product units for which the recall is being implemented have been accounted for by consignees.

In certain illustrative and exemplary embodiments, an exchange processor may include a registry configured to provide a pre-registration process wherein a recalling firm requires at least one of one or more identified consignees to register with a recall information exchange system, e.g., to register in advance, i.e., at a time prior to a recall occurring.

In certain illustrative and exemplary embodiments, an exchange processor may be configured to identify whether at least one of one or more identified consignees complies with a pre-registration process.

In certain illustrative and exemplary embodiments, an exchange processor may be configured to provide a recalling firm with tools to automatically provide at least one of direct store delivery staff and third party vendors with recall information, consignee lists, and instructions for removing and accounting for product units for which a recall is being implemented.

In certain illustrative and exemplary embodiments, an exchange processor may be configured to initiate a voicecast when product units for which a recall is to be executed represent an urgent incident or threat to public safety.

In certain illustrative and exemplary embodiments, a voicecast may be provided twenty four hours a day, seven days a week.

In certain illustrative and exemplary embodiments, an exchange processor may be configured to disseminate incident alerts to a plurality of departments within a business.

In certain illustrative and exemplary embodiments, an exchange processor may be configured to receive an input from a recalling firm for setting up an alert profile that provides the recalling firm with one or more documents matching a search criterion entered by the recalling firm in response to a product related incident being identified by an information exchange system.

In certain illustrative and exemplary embodiments, one or more documents may include highlighting identifying words or phrases that match search criterion.

In certain illustrative and exemplary embodiments, an exchange processor may be configured to disseminate a blanket product-specific targeted alert.

In certain illustrative and exemplary embodiments, a consignee status notification may be transmitted to at least one designated authority, and wherein the at least one designated authority may include the Food and Drug Administration (FDA), and wherein an exchange processor may be configured to upload an FDA contact database for disseminating notifications to contacts included in a contact database on a targeted or blanket basis.

In certain illustrative and exemplary embodiments, an exchange processor may receive a receipt of a recall notification internally.

In certain illustrative and exemplary embodiments, an exchange processor may receive a receipt of a recall notification as a copy of a recall notification disseminated externally to a recall information exchange system.

In certain illustrative and exemplary embodiments, an exchange processor may receive a response to a receipt of a recall notification internal to a recall information exchange system.

In certain illustrative and exemplary embodiments, identified product units for which a recall is to be executed are food products.

In certain illustrative and exemplary embodiments, at least one information exchange party member includes a designated authority.

In certain illustrative and exemplary embodiments, data associated with at least one of a user and at least one information exchange party member may be encrypted.

In certain illustrative and exemplary embodiments, encrypted data may include data that identifies at least one of a user and at least one information exchange party member.

In certain illustrative and exemplary embodiments, a communication may be transmitted to at least one of a user and at least one information exchange party member responsive to receiving a recall notification request.

In certain illustrative and exemplary embodiments, a transmitted communication is at least one of an electronic mail (e-mail), a web based communication, and a client-server communication.

In certain illustrative and exemplary embodiments, an acknowledgment receipt may be received from at least one of a user and at least one information exchange party member, the acknowledgment receipt acknowledging a transmission of a primary notification.

In certain illustrative and exemplary embodiments, an alert may be generated responsive to not having received a progress report from at least one of a user and at least one information exchange party member within a threshold amount of time, e.g., within 1 hour, or within 2 hours, or within 3 hours, or within 4 hours, or within 6 hours, or within 8 hours, or within 12 hours, or within 18 hours, or within 24 hours, or within or within 36 hours, or within 48 hours. Any of these exemplary time limits also may be used for any other time threshold or time limit referred to in this disclosure.

In certain illustrative and exemplary embodiments, an alert may be generated responsive to a progress report failing to account for product included in one or more product units attributable to a corresponding at least one user and at least one information exchange party member.

In certain illustrative and exemplary embodiments, a progress report may take the form of one of: a photo, a video, an electronic mail (e-mail), a telephone call, a facsimile/fax, an instant message, a short message service (SMS) message, and a hyperlink.

In certain illustrative and exemplary embodiments, a progress report may be updated in real-time as at least one of a user and at least one information exchange party member processes a recall.

In certain illustrative and exemplary embodiments, an updating of a user's registration information may be based on historical activity undertaken by the user.

In certain illustrative and exemplary embodiments, a closing of a folder may be responsive to determining that the time the folder has been open exceeds a threshold value.

In certain illustrative and exemplary embodiments, a completion notification message may be transmitted to at least one of a user and at least one information exchange party member.

In certain illustrative and exemplary embodiments, an at least one information exchange party member includes a designated authority, and a closing of a folder is approved by the designated authority.

In certain illustrative and exemplary embodiments, a lock-out may be engaged to prevent at least one of a sale and a distribution of at least one of one or more product units, e.g., specific identified units being recalled.

In certain illustrative and exemplary embodiments, a lock-out may be a total lock-out that prevents at least one of a sale and a distribution of all products that are of a same product type as one or more product units, e.g., the same type as a product being recalled.

In certain illustrative and exemplary embodiments, a lock-out may be a partial lock-out that allows a sale and a distribution of products that are of the same product type as one or more product units.

In certain illustrative and exemplary embodiments, a charge-back may be tabulated to credit at least one of a user and at least one information exchange party member responsive to a corresponding at least one of a user and at least one information exchange party member complying with terms and conditions of a primary notification.

In certain illustrative and exemplary embodiments, crediting includes crediting an account an at least one information exchange party member has with a user.

In certain illustrative and exemplary embodiments, an at least one information exchange party member includes a designated authority, a plurality of consignors, a plurality of consignees, and a plurality of sub consignees, and wherein at least one of the designated authority, the plurality of consignors, the plurality of consignees, and the plurality of sub consignees may be registered with an information exchange platform that a user registration pertains to, and wherein a notification request may be a product recall notification request, and wherein the opening of a folder may be responsive to the designated authority approving of the product recall notification request, and wherein a lock-out may be engaged to prevent a sale and a distribution of at least one or more product units by the plurality of consignors, the plurality of consignees and the plurality of sub consignees responsive to the opening of the folder, and wherein a second progress report may be received from at least one of the user and the at least one information exchange party member, wherein the second progress report may indicate a status of product included in one or more product units and attributable to the corresponding at least one of the user and the at least one information exchange party member, the second progress report accounting for all of the one or more product units in total, and wherein the folder may be closed by the designated authority responsive to receiving the second progress report.

In certain illustrative and exemplary embodiments, a receiving of a notification request from at least one of a user and at least one information exchange party member may be based on a push by the at least one of the user and the at least one information exchange party member.

In certain illustrative and exemplary embodiments, a transmission of a primary notification to a user and at least one information exchange party member may be based on a push of a primary notification.

In certain illustrative and exemplary embodiments, a transmission of a primary notification to a user and at least one information exchange party member may be based on a pull by at least one of the user and the at least one information exchange party member.

In certain illustrative and exemplary embodiments, an apparatus comprises a processor and memory storing instructions that, when executed by the processor, perform any number of the features recited in the system and method claims herein in any combination.

In certain illustrative and exemplary embodiments, a computer readable medium may store instructions that, when executed, perform any number of the features recited in the system and method claims herein in any combination.

In certain illustrative and exemplary embodiments, a computer readable medium may be a tangible medium.

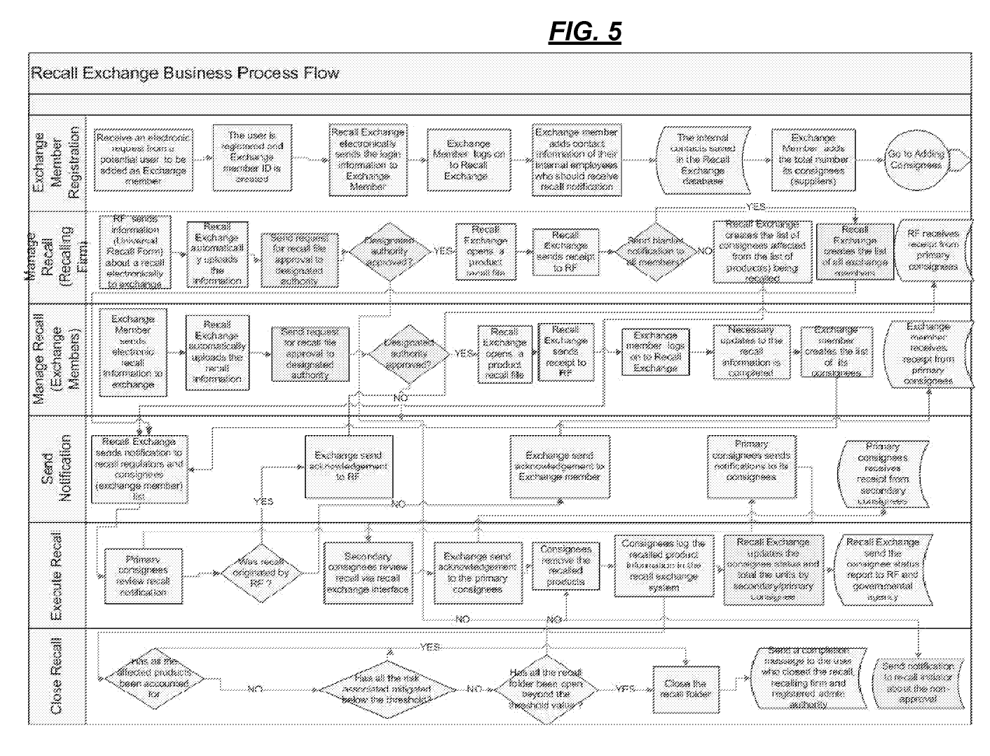

In certain illustrative and exemplary embodiments, a recall exchange business process flow similar to that shown in FIG. 5 may be implemented.

In certain illustrative and exemplary embodiments, a recall exchange system may
Allow each participating member of an Exchange to complete a form identifying the individual organization's specific area of trade, distribution, and goods produced or served.
Allow automatic population of data into an Exchange Database where categories are indexed and cross-referenced.
Allow the first organization familiar with an incident to report it electronically to the Exchange via the form.
Send the form to the consignees via e-mail or other electronic communications.
Allow consignees to acknowledge a recall notice.
Allow consignees to send recalls to their consignees.
Allow real time efficient, automatic notifications and responses. All data of recalled items may be delivered back to the Recalling Firm. The RF may report back to the appropriate government regulatory authority overseeing the recall.
Send data about a recall from recall firms to regulators who are Exchange members
Allow consignees to complete a recall reply form
Allow confirmation of recall compliance via a dashboard application enabled on one or more Exchange Member PC screens. The dashboard may provide a list of running real-time statistics.
Send a notification of closed recalls and automatically send a notification to the dashboards of all concerned parties that the recall is closed and move the recall into a closed archive folder.
Allow a capture of consumer return data via a recall update form
Allow charge backs of returned items to the recalling firm.
Enable the display of some or all public press releases related to a specific recall.
Allow a voice cast alert capability for retailers (e.g., consumers) & other members via one or more delivery channels (e.g., voice, email, fax, etc.)
Provide an ability to lock out on partial recalls using a sub UPC code system.
Enable reporting on recall information

In certain illustrative and exemplary embodiments, training sessions may be scheduled for one or more parties to the recall exchange system. In some embodiments, e-learning modules (asynchoronus) may be used to demonstrate to the novice and intermediate user how to use the application, administrator tools and reports associated with exchange system. In some embodiments, webinars (synchronous) and/or training events held via webex or other web conferencing system may be used.

In certain illustrative and exemplary embodiments one or more reports may be generated in accordance with one or more of the following report parameters (illustratively numbered x.x):

Report #1.0: Recall Item count

| | |
|---|---|
| Purpose | Gives real-time status of recall count |
| Used by | TBD |

| | |
|---|---|
| Granularity | Status by primary consignees |
| | Status by secondary consignees |

| | |
|---|---|
| Batch | |
| Frequency | |
| Output | |
| Format(s) | |
| Report | Major Scope: Recall |
| Parameters | Minor Scope: Primary Consignee, Secondary |
| | Consignee |

| | |
|---|---|
| Header Format | Header Text: |

Recall Units Report

| Fields | Description |
|---|---|
| Consignee | Consignee who received the recall. |
| Total units | Total units that has to be recalled |
| recalled | |
| Total units | Total units that are accounted for |
| accounted | |
| Total units | Total units pending (Total units pending = total |
| pending | units recalled − total units accounted) |
| Drill down | The report should drill down from primary consignee |
| rules | to its secondary consignees. When drilling down from |
| | a primary consignee, the secondary consignees' total |
| | should be equal to the primary consignee data. |

Report #2.0: Acknowledgment

| | |
|---|---|
| Purpose | Gives real-time status of consignee acknowledgement |
| Used by | TBD |

| | |
|---|---|
| Granularity | Status by primary consignees |
| | Status by secondary consignees |

| | |
|---|---|
| Batch | |
| Frequency | |
| Output | |
| Format(s) | |
| Report | Major Scope: Primary Consignee |
| Parameters | Minor Scope: Secondary Consignee |

| | |
|---|---|
| Header Format | Header Text: |

Consignee Acknowledgement Report

| Fields | Description |
|---|---|
| Consignee | Consignee who received the recall. |
| Total | Total consignees who acknowledged the recall |
| Acknowledged | |
| Total Pending | Total consignees pending to acknowledge |
| Drill down | The report should drill down from primary consignee |
| rules | to its secondary consignees. When drilling down from |
| | a primary consignee, the secondary consignees' total |
| | should be equal to the primary consignee data. |

Report #2: Sorting Report

| | |
|---|---|
| Description | Reports the Survey Response rate for Company, Divisions/Zones/Stores, |
| | Warehouses, DCs, Manufacturing Plants, GO Pharmacy Refills and GO |
| | Produce along with survey question scores for the above scopes. |
| Business | |
| Notes | |
| Used by | |

| | |
|---|---|
| Granularity | Company by Division |
| | Division by Zone/Store/DCs/Warehouses/Plants |
| | Zone by Store |

| Batch | | |
|---|---|---|
| Frequency | Quarterly | |
| Output | HTML | |
| Format(s) | | |
| Report | Type: Dimension and Sorting Report | |
| Parameters | Scope: | |
| | Major Scope | Minor Scope |

| | |
|---|---|
| Company | Divisions |
| | GO |
| | RASC |
| | KASH |
| | CALM |
| | DC Overall |
| | Peyton Overall |
| | Manufacturing overall |
| | Pharmacy Refill Overall |
| | Floral Overall |
| Company | Division Offices (Show all |
| | division offices except DCs, |
| | Peyton, Pharmacy Refill, |
| | Floral because they don't |
| | have any division offices) |
| Division | Division Office |
| | Zone |
| | Store |
| | Warehouses |
| Zone | Stores |
| Store Groups | Stores |
| Store | Departments |
| DC Overall | Individual Distribution |
| | Plants |
| Peyton Overall | Individual Peyton Plants |

| Associate Survey Year/Quarter: Year and Quarter for which the report is | |
|---|---|
| generated. Associate survey year includes Q4 of previous year, Q1, Q2, Q3 | |
| of current year. | |
| Report Filter: | |
| Classification | Options |
| Category | Inclusion, Perf Mgt, Comms, Tal |
| | Mgt, Inclusion, Training/Dev, |
| | Reward/Rec |
| Dimension 1 | 4 Keys, Value, Engagement, |
| | Effectiveness |
| Roadmap Year | existing, about, 1, 2, 5 inc survey, |
| | Kenexa |
| Dimension 2 | I Get What I Want (Plus A Little), |
| | Shopping Experience, Our People |
| | Are Great!, Our Prices Are |
| | Good/Great, Diversity, Honesty, |
| | Inclusion, Integrity, Respect, |
| | Safety, Knowledge of values, |
| | Employee Engagement, Supervisor |
| | Effectiveness |

Show Survey Questions: Checking this will show survey questions by
major scope
Question Filter: This filters the survey questions. Question Filter is a pop
up screen from where users can select the questions they want to report on.
It also includes ‘Question Group’ option (See UC2.0) to select from

| | |
|---|---|
| Header Format | Show Survey Question: Clicking the ‘Yes’ button will take to the |
| (Response | Survey question report |

| | |
|---|---|
| Rate) | Header Text: |

Dimension and Sorting Report <Fiscal Year/Quarter> Results
There should be options to view report in xcel and pdf

| | |
|---|---|
| Header Format | Report Filter: |
| (Survey, | Classification - Filter the survey questions on one of the below |

| | |
|---|---|
| Question | classifications. |

| | |
|---|---|
| Scores) | Category |
| | Dimension 1 |
| | Road map Year |
| | Dimension 2 |

Option - Each of the classification above have different options that
can be used to filter the survey questions:

Category - Inclusion, Perf Mgt, Comms, Tal Mgt, Inclusion, Training/

Dev, Reward/Rec

Dimension 1 - 4 Keys, Value, Engagement, Effectiveness
Roadmap Year - existing, about, 1, 2, 5 inc survey, Kenexa

Dimension 2 - I Get What I Want (Plus A Little), Shopping
Experience, Our People Are Great!, Our Prices Are
Good/Great, Diversity, Honesty, Inclusion, Integrity, Respect,
Safety, Knowledge of values, Employee Engagement, Supervisor
Effectiveness
Header Text:

Dimension and Sorting Report <Fiscal Year/Quarter> Results

| Fields | | |
|---|---|---|
| (Response Rate) | Description | |
| Scope | Division/Zone/Store/DCs/Warehouses etc. | |
| Returned | Number of survey results returned | |
| Sent | Numbers of surveys sent | |
| Returned Percent | Percent of survey results returned | |
| Fields (Survey | | |
| Question Scores) | Description | |
| Response Rate | Response for each question | |
| Question | Questions in the survey | |
| Target | Target Score for the question | |
| Scope Score | Individual scope score | |
| Drill Down rule | If the user selected to see survey questions, Key questions are the major scope | |
| for survey | always. Minor Scopes and drill down rule are described below | |
| Questions | | |
| | Scope | Rule |
| | Company | Report shows company total and all |
| | | its Minor Scope |
| | Company's minor scope | Report shows Company total, Scope |
| | | Total and its minor scopes |
| | All other minor scope | Report shows Company's minor |
| | | scope, scope total and its minor |
| | | scope |
| | For ex. When drilling down from a division, the report should show the Company | |
| | total score, division total score and the score of individual zones/stores/ | |
| | store groups in the division. When drilling from a zone, the report should | |
| | show the division total score, the zone total score and the score of the | |
| | individual stores in the zone. When drilling from a store, the report should | |
| | show division total score, store total score and its department scores | |
| | Each column drill into: | |
| | Scope Columns | |
| | Scope | Minor Scopes Shown |

| | |
|---|---|
| Company | Divisions |
| | GO |
| | RASC |
| | KASH |
| | CALM |
| | DC Overall |
| | Peyton Overall |
| | Manufacturing overall |
| | Pharmacy Refill Overall |
| Company | Floral Overall |
| | Division Offices (Show |
| | all division offices except |
| | DCs, Peyton, Pharmacy |
| | Refill, Floral because they |
| | don't have any division |
| | offices) |
| Division | Division Office |
| | Zone |
| | Store |
| | Store Groups |
| | Warehouses |
| Zone | Stores |
| Store Groups | Stores |
| Store | Departments |
| DC Overall | Individual Distribution |
| | Plants |
| Peyton Overall | Individual Peyton Plants |
| Manufacturing Overall | Individual Manufacturing |
| | Plants |

KASH
RASC

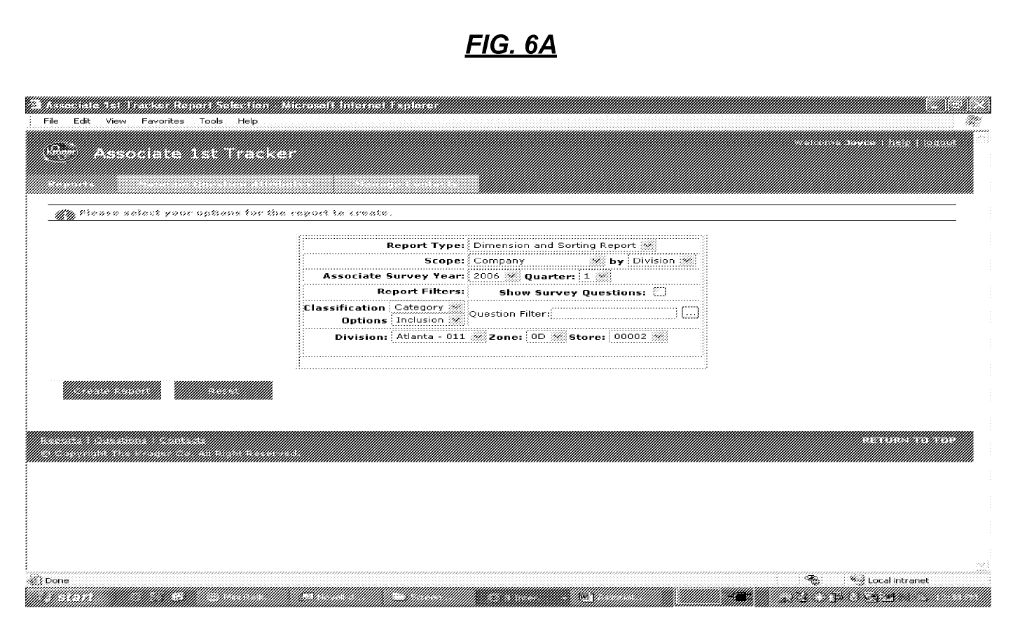

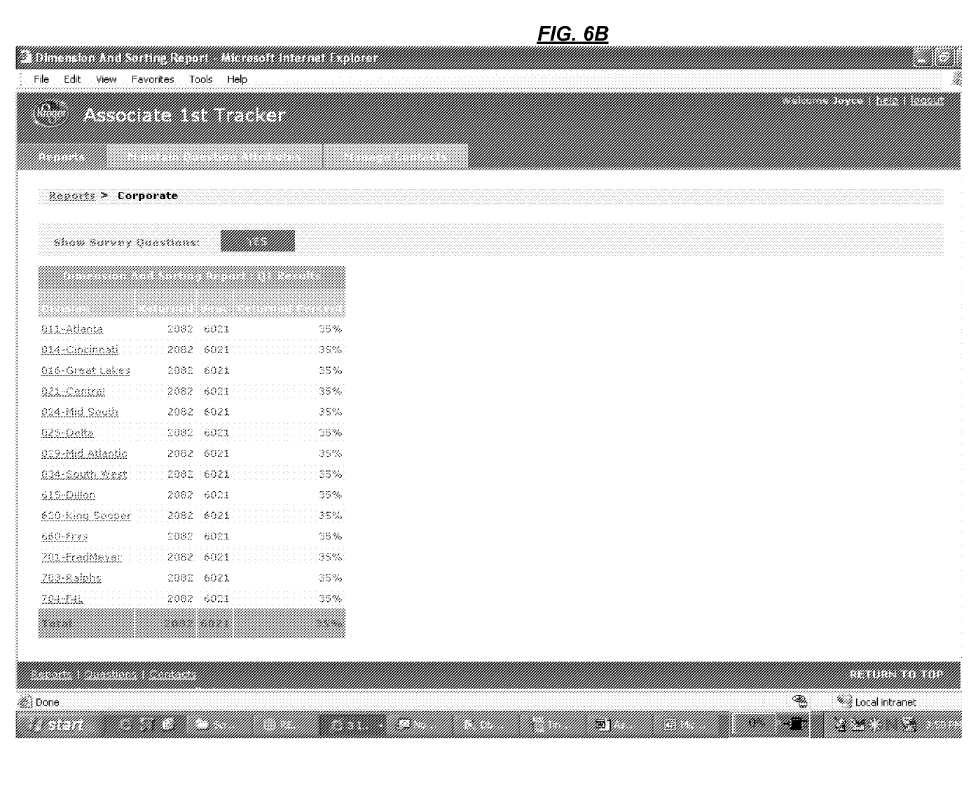

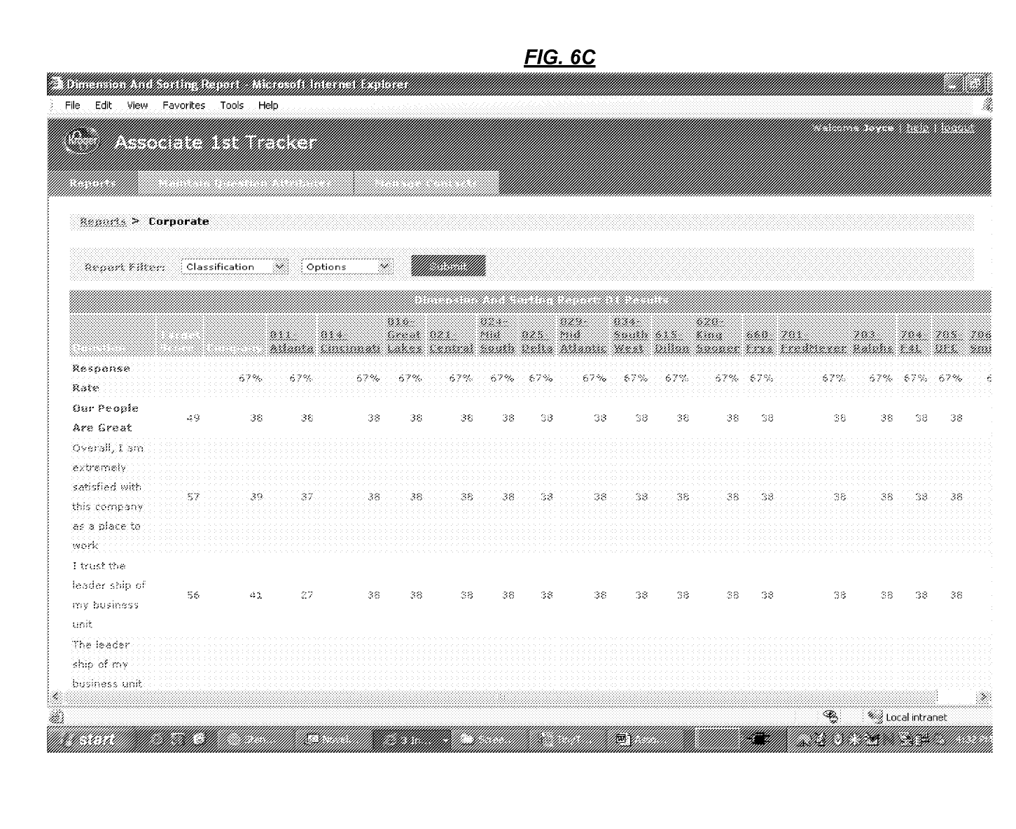

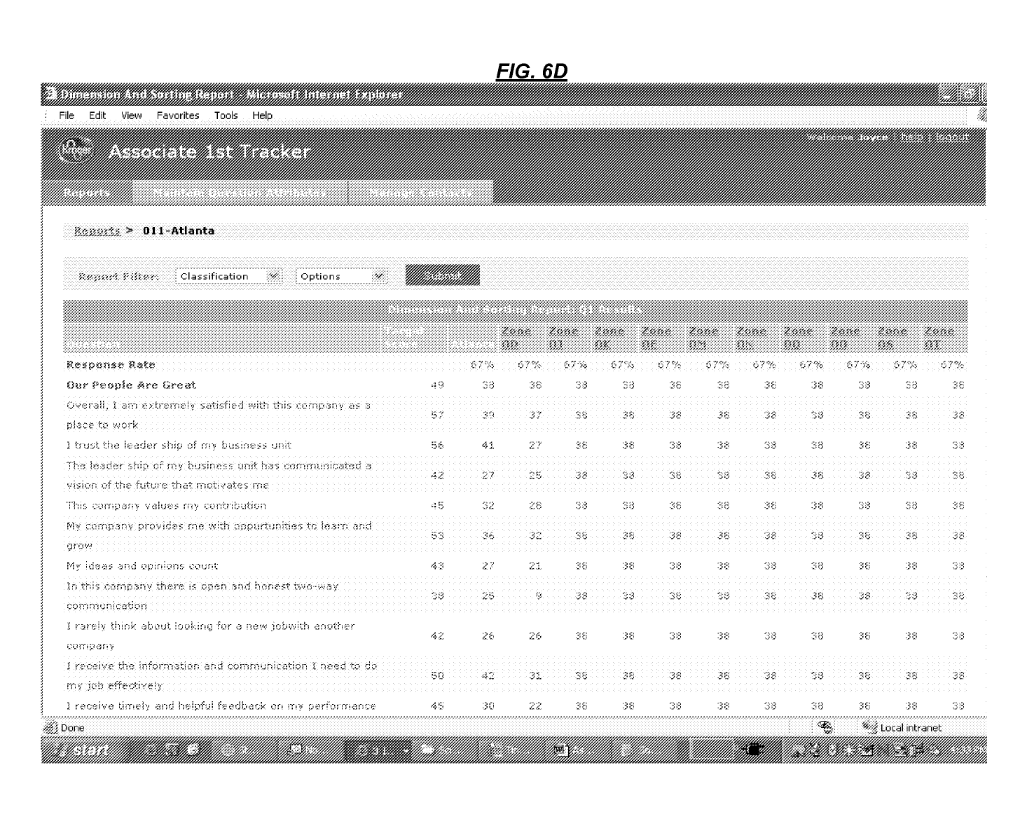

Certain illustrative and exemplary sorting reports are illustrated in FIGS. 6A-6D.

Report #3: Demographic Report

| | |
|---|---|
| Description | Reports the Survey Response rate by demographics for Company, |
| | Divisions/Zones/Stores, Warehouses, DCs and Manufacturing Plants |
| | along with survey question scores for the above scopes. |
| Used by | |

| | |
|---|---|
| Granularity | Company by Demographic |
| | Division/Zones/Stores by Demographic |
| | Warehouse by Demographic |
| | Manufacturing Plants by Demographic |
| | DCs by Demographic |
| | GO Pharmacy Refills by Demographic |
| | GO Produce by Demographic |

| Batch | | |
|---|---|---|
| Frequency | Quarterly. | |
| Output Format(s) | HTML | |
| Report Parameters | Type: Demographic Report | |
| | Scope: | |
| | Major Scope | Minor Scope |
| | Company/Division/Zone/Store/Store | Age,, Ethnic Group,, Gender, |
| | Groups/Manufacturing | Years of Service, |
| | Plants/Warehouse/DCs/G.O. | Salaried/Hourly, Department |
| | Pharmacy Refills/G.O. Produce | |

For: Age,, Ethnic Group,, Gender, Years of Service,
Salaried/Hourly, Department
Associate Survey Year/Quarter: Year and Quarter for which the report
is generated. Associate survey year includes Q4 of previous year, Q1,
Q2, Q3 of current year.
Show Survey Questions: Checking this will allow filtering on the
survey questions.
Question Filter: This filters the survey questions. Question Filter is a
pop up screen from where users can select the questions they want to
report on. It also includes ‘Question Group’ option (See UC2.0) to
select from.
Select Age: Filters by Age
Select Ethnic Group: Filters by Ethnic Group
Select Gender: Filters by Gender
Select Years of Service: Filters by Years of Service
Select Salaried/Hourly: Filters by Salaried/Hourly
Select Department: Filters by Department

| | |
|---|---|
| Header Format | Show Survey Question: Clicking the ‘Yes’ button will take to the |
| (Response Rate) | Survey question report |

Header Text:

Demographic Scores <Fiscal Year/Quarter> Results: <Major
Scope>
<Minor Scope> by <Column Scope>
Total Survey Sent:
There should be options to view report in xcel and pdf

| | |
|---|---|
| Header Format | Questions Filter: This will allow to choose a survey question for reporting |

| | |
|---|---|
| (Survey Question | Header Text: |

| | |
|---|---|
| Scores) | Demographic Scores <Fiscal Year/Quarter> Results: |
| | <Major Scope> |

| Fields | |
|---|---|
| (Response Rate) | Description |
| Minor Scope | Company/Division/Zone/Store/DCs/Warehouses etc. |
| Column Scope | Age,, Ethnic Group,, Gender, Years of Service, |
| | Salaried/Hourly, Department |
| Surveys Received | Number of survey results returned |
| Percent | Percent of survey results returned |
| Fields (Survey | |
| Question Scores) | Description |
| Minor Scope | Company/Division/Zone/Store/DCs/Warehouses etc. |
| Column Scope | Age,, Ethnic Group,, Gender, Years of Service, |
| | Salaried/Hourly, Department |
| Score | Score for the survey questions |
| Response Rate | Response for each question |
| Report Creation Rule | Store: Do not have access to demographic reports. |
| | Division/Zones: If the number of responses for a particular demographic |
| | is less than or equal to 20, do not show the report. |
| | Corporate: No restrictions on the number of responses |

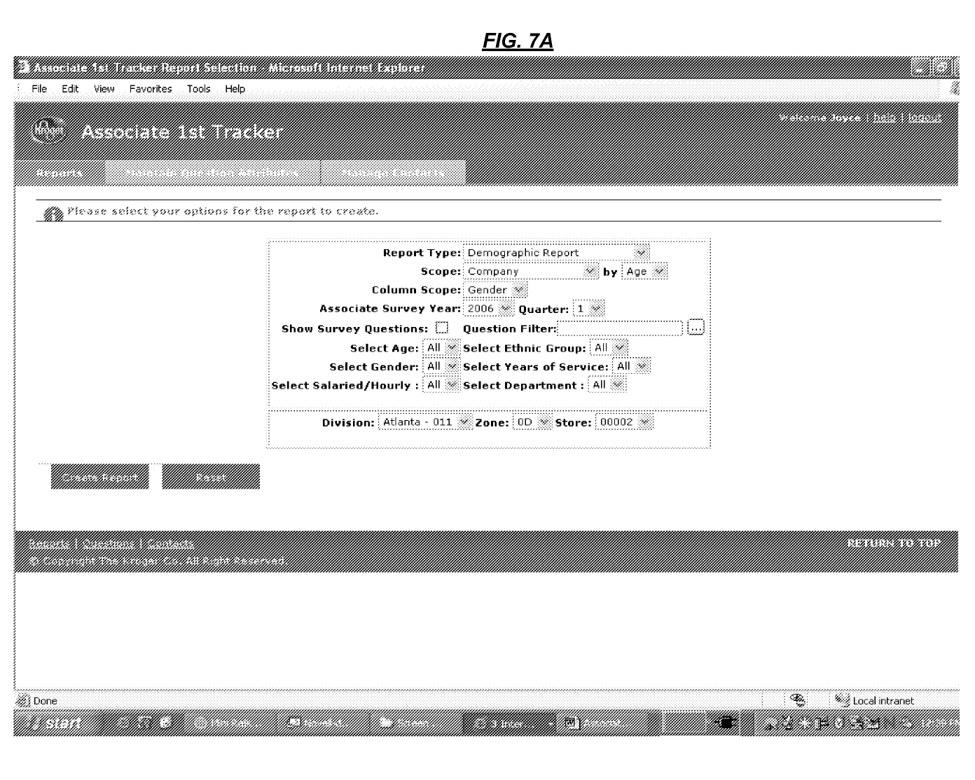

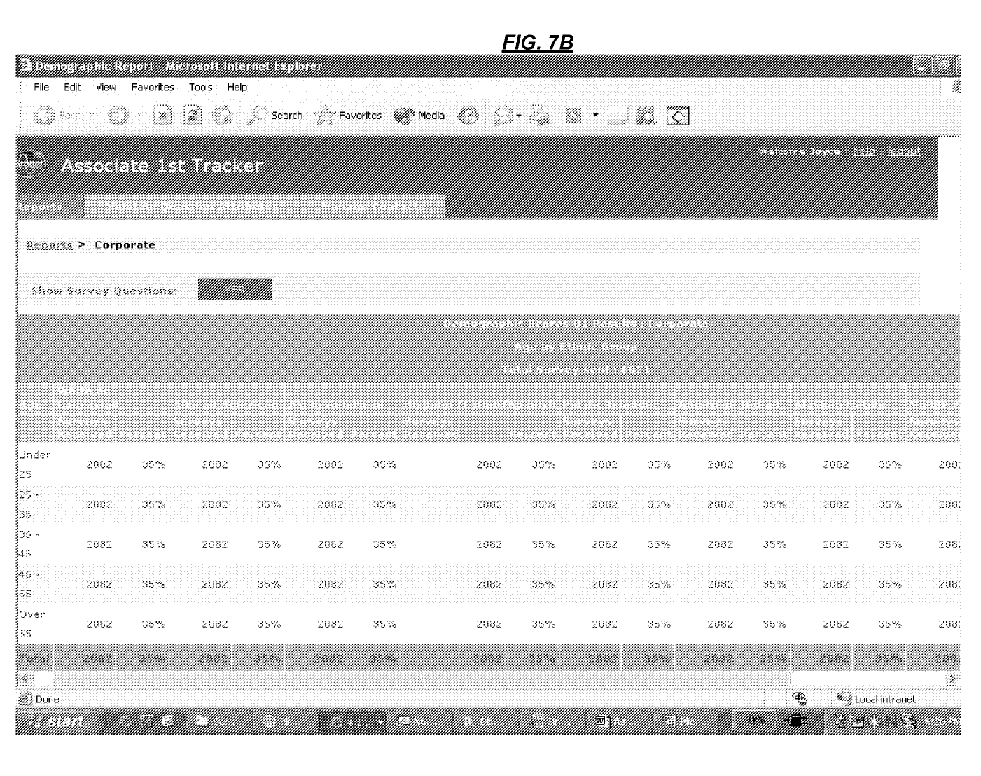

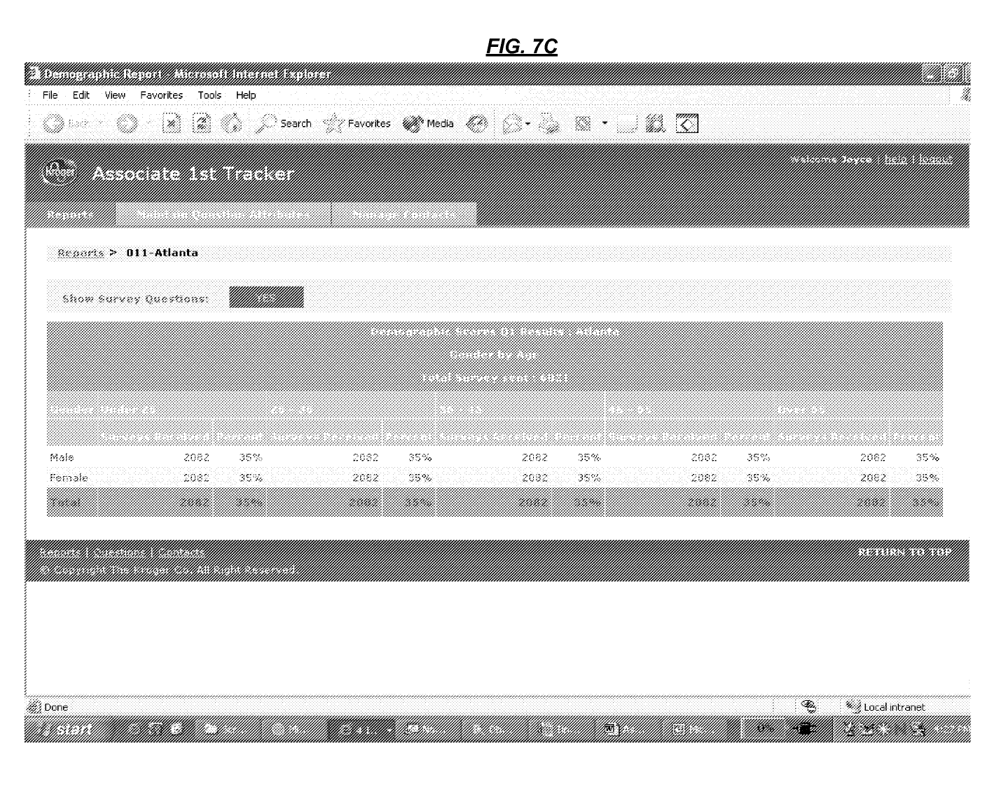

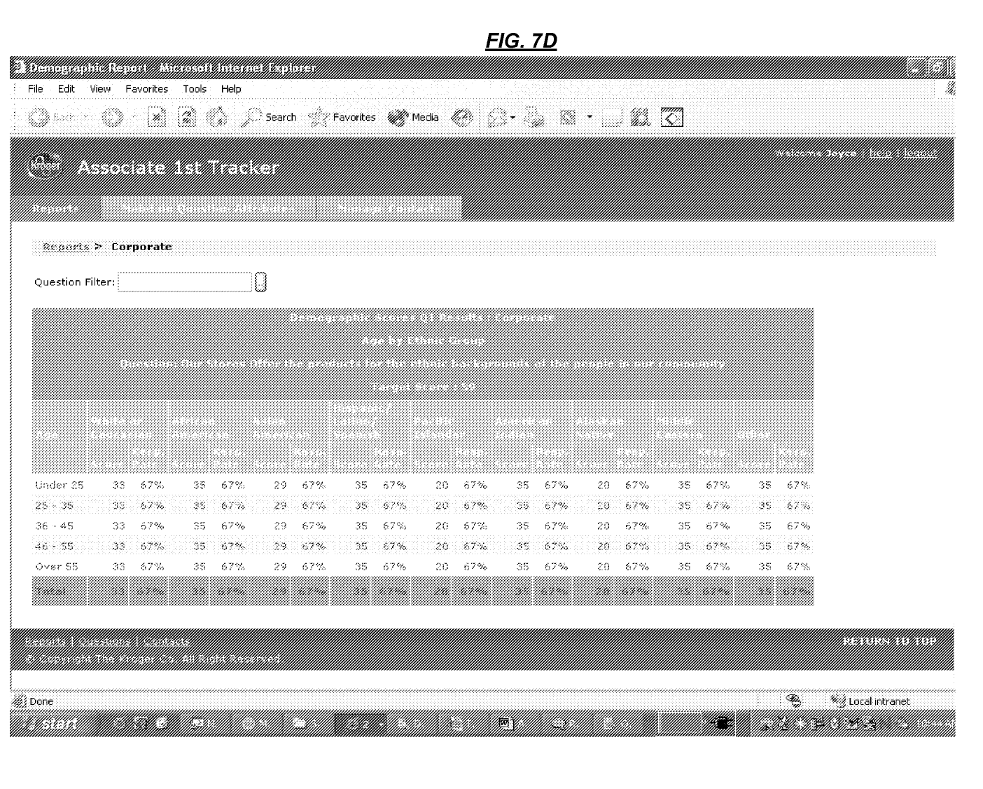

Certain illustrative and exemplary demographic reports are illustrated in FIGS. 7A-7D.

Report #4: Yearly Summary Report

| | |
|---|---|
| Purpose | Reports the Key Question scores for Company, Divisions/Zone/Stores, |
| | Warehouses, DCs and Manufacturing Plants for the entire Associate |
| | Tracker year by quarter. |
| Used by | TBD |

| | |
|---|---|
| Granularity | Key Questions by Company |
| | Key Questions by Division/Zone/StoreGroups/Stores |
| | Key Questions by Warehouses |
| | Key Questions by DCs |
| | Key Questions by Manufacturing Plants |
| | Key Questions by GO Pharmacy Refills |
| | Key Questions by GO Floral |
| | Key Questions by CALM |

| | |
|---|---|
| Batch | |
| Frequency | Quarterly |
| Output Format(s) | HTML |
| Report Parameters | Type: Standard |
| | Major Scope: Key Questions |
| | Minor Scope: Company, Division. Zone, Store Groups, Store, |
| | Warehouse, Manufacturing Overall, DCs, GO Pharmacy Refills, GO |
| | Produce, CALM |
| | Column Scope: If the minor scope is division, columns can be zones, |
| | store groups or stores depending on the column scope selection. Column |
| | scope is applicable only to division |
| | Associate Survey Year: Year for which the report is generated. |
| | Associate survey year includes Q4 of previous year, Q1, Q2, Q3 of |
| | current year. |
| | For ex. Associate Survey Year 2006 includes, Q4 of 2005, Q1, Q2, Q3 |
| | of 2006 |
| | Associate Survey Year 2006 includes, Q4 of 2006, Q1, Q2, Q3 of 2007 |

| | |
|---|---|
| Header Format | Header Text: |

Standard Report: <Major Scope> <Fiscal Year> Results
Target Rating: GREEN = meets or exceeds target,
YELLOW = within 10 points of target, RED = more than 10
points below target
There should be options to view report in xcel and pdf

| Fields | Description |
|---|---|
| Response Rate | Response percent for the survey. |
| Key Question | Key question which is scored |
| Target Score | Target score for the key question |

| | |
|---|---|
| Qtr4 Score | Score for the selected scope for quarter 4. Different scopes are Company, |
| | Division, Manufacturing plants, DCs etc. |
| Qtr1 Score | Score for the selected scope for quarter 1. Different scopes are Company, |
| | Division, Manufacturing plants, DCs etc. |
| Qtr2 Score | Score for the selected scope for quarter 2. Different scopes are Company, |
| | Division, Manufacturing plants, DCs etc. |
| Qtr3 Score | Score for the selected scope for quarter 3. Different scopes are Company, |
| | Division, Manufacturing plants, DCs etc. |
| Yearly Avg. | Average of all the quarter's scores for the year. Different scopes are |
| | Company, Division, Manufacturing plants, DCs etc. |

Drill down rules

| Column Drill | Scope | Rule |
|---|---|---|
| | Company | Report shows company total and all |
| | | its Minor Scope |
| | Company's minor scope | Report shows Company total, Scope |
| | | Total and its minor scopes |
| | All other minor scope | Report shows Company's minor |
| | | scope, scope total and its minor |
| | | scope |
| | For ex. When drilling down from a division, the report should show the | |
| | Company total score, division total score and the score of individual | |
| | zones/stores/store groups in the division. When drilling from a zone, the report | |
| | should show the division total score, the zone total score and the score of the | |
| | individual stores in the zone. When drilling from a store, the report should | |
| | show division total score, store total score and its department scores. | |
| | Scope Columns | |
| | Scope | Minor Scopes Shown |

| Company | Divisions |
|---|---|
| | GO Corporate Office |
| | RASC |
| | KASH |
| | CALM |
| | DC Overall |
| | Peyton Overall |
| | Manufacturing overall |
| | Pharmacy Refill Overall |
| | Floral Overall |
| Company | Division Offices (Show |
| | all division offices except |
| | DCs, Peyton, Pharmacy |
| | Refill, Floral because they |
| | don't have any division |
| | offices) |
| Division | Division Office |
| | Zone |
| | Store |
| | Warehouses |
| | Store Groups |
| Zone | Stores |
| Store Groups | Stores |
| Store | Departments |
| DC Overall | Individual Distribution |
| | Plants |
| Peyton Overall | Individual Peyton Plants |
| Manufacturing Overall | Individual Manufacturing |
| | Plants |
| KASH | |
| RASC | |
| CALM | |
| Pharmacy Refill | Kentucky Refill |
| | Columbus Refill |
| Floral | Northern Floral |
| | Southeastern floral |

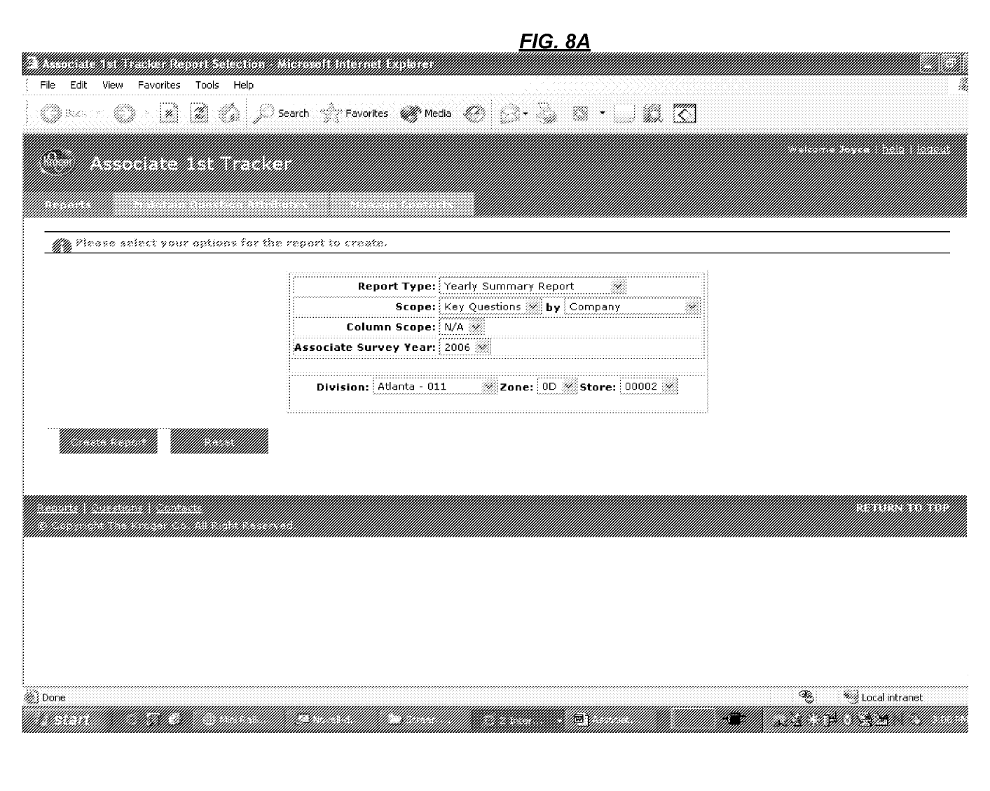

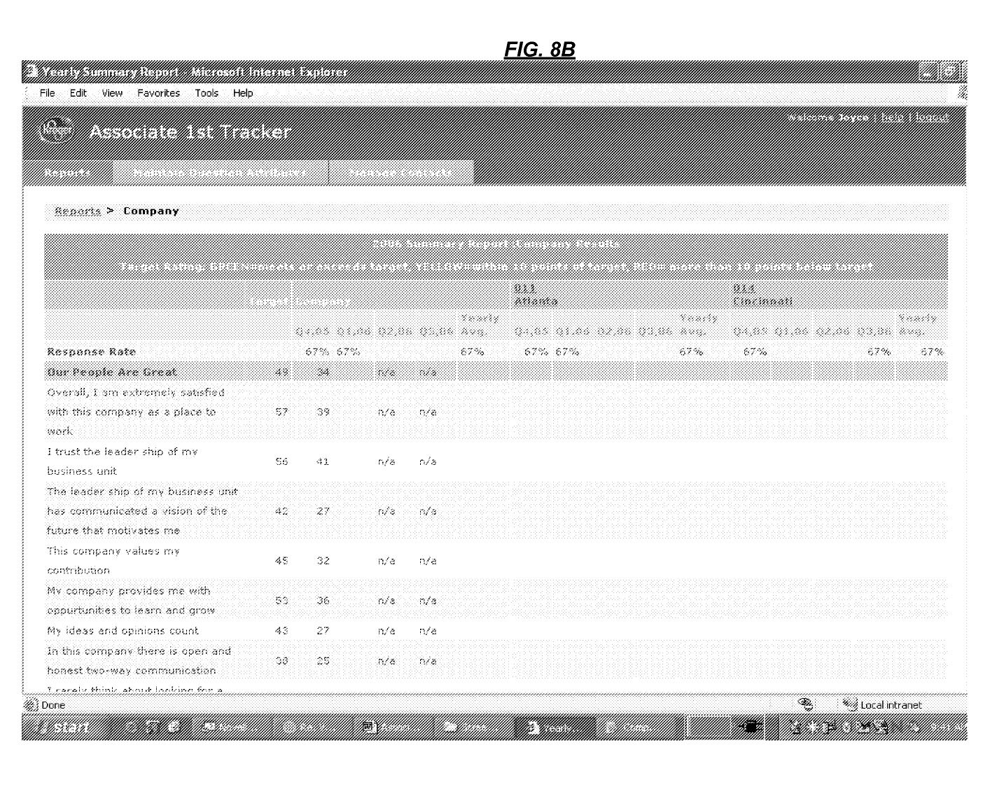

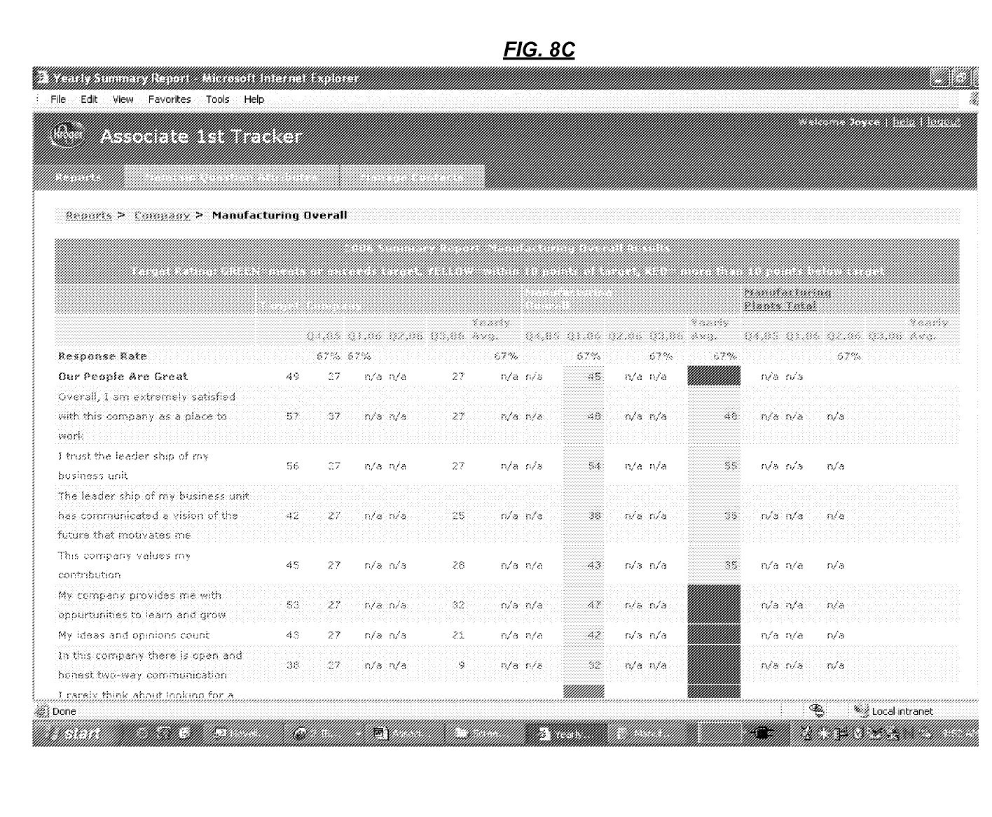

Certain illustrative and exemplary yearly summary reports are illustrated in FIGS. 8A-8C.

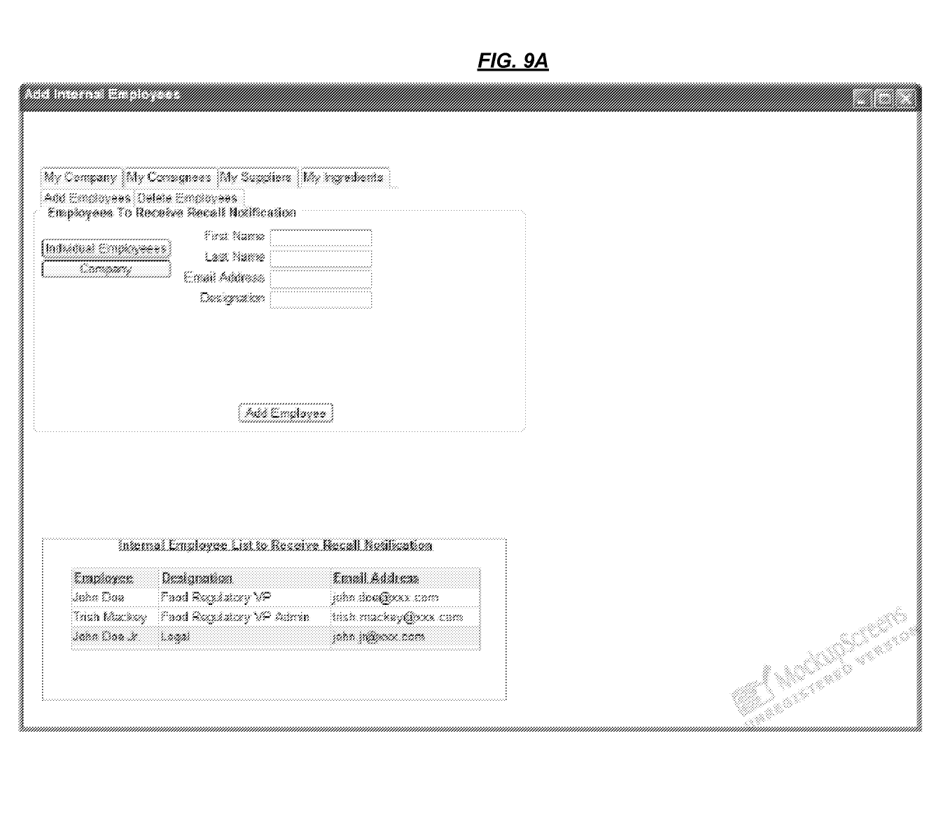

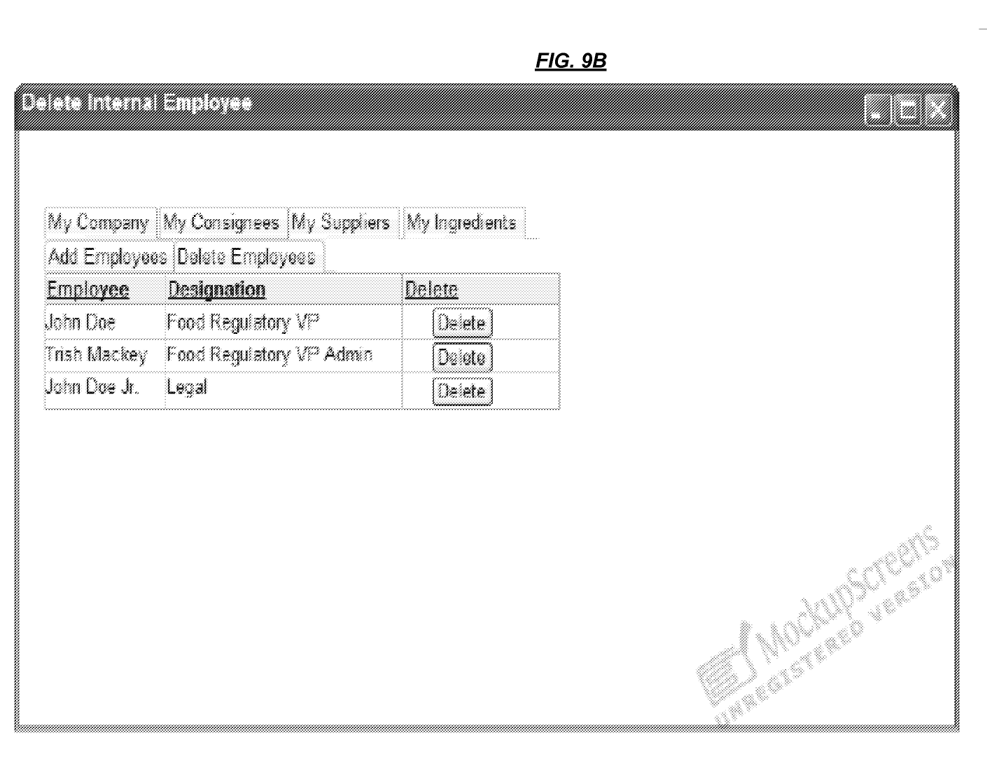

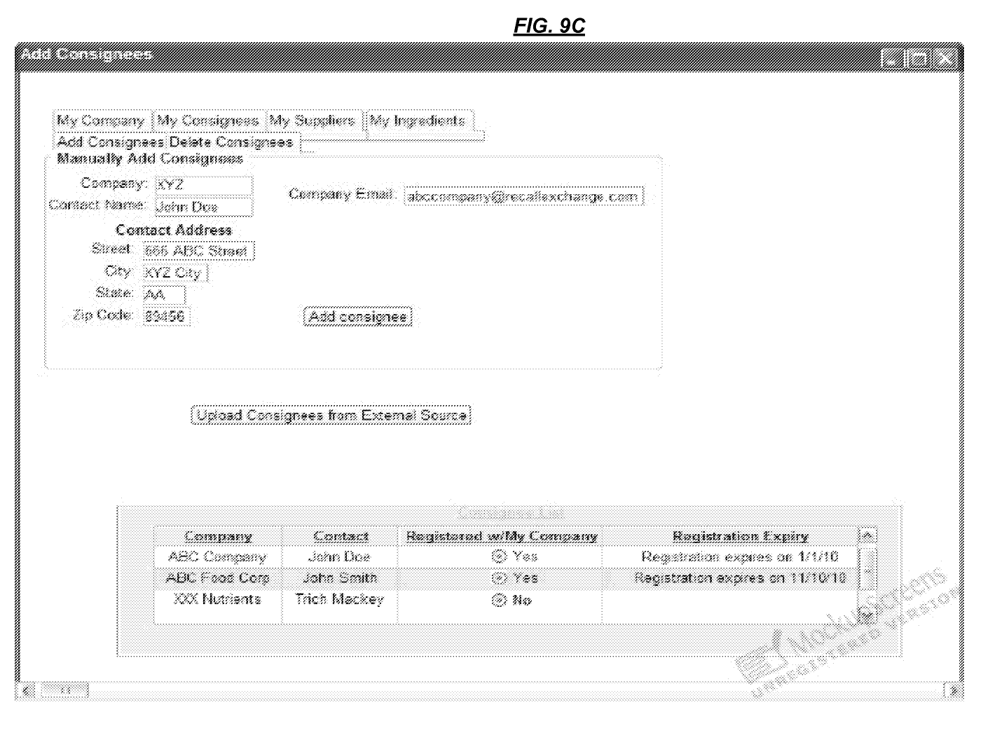

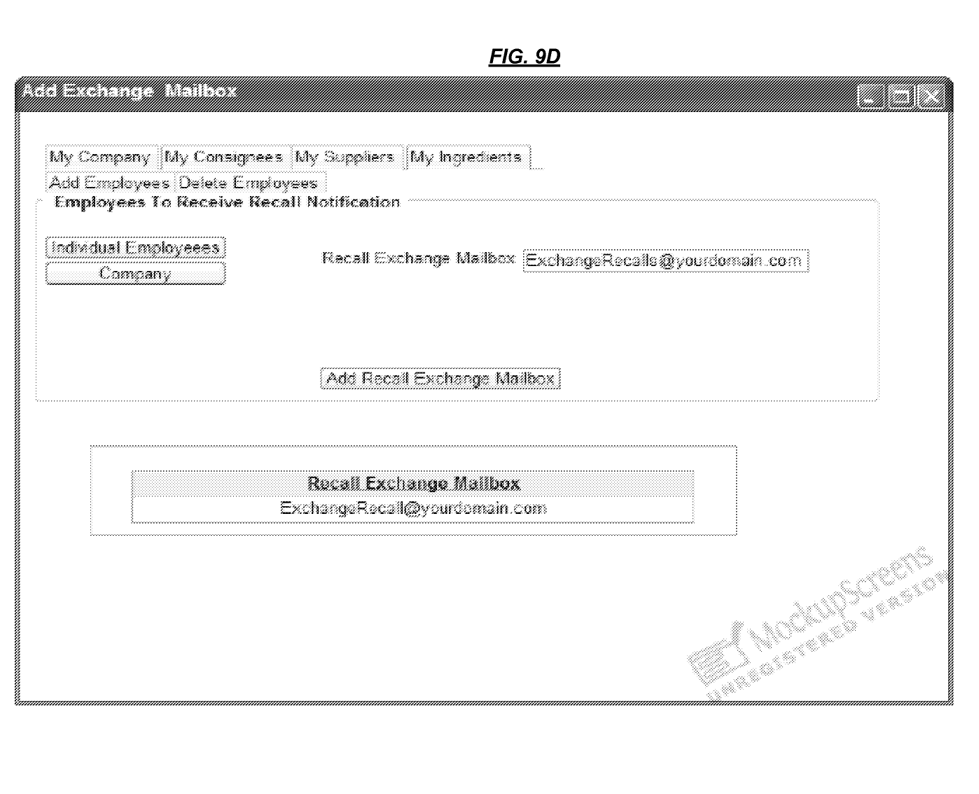

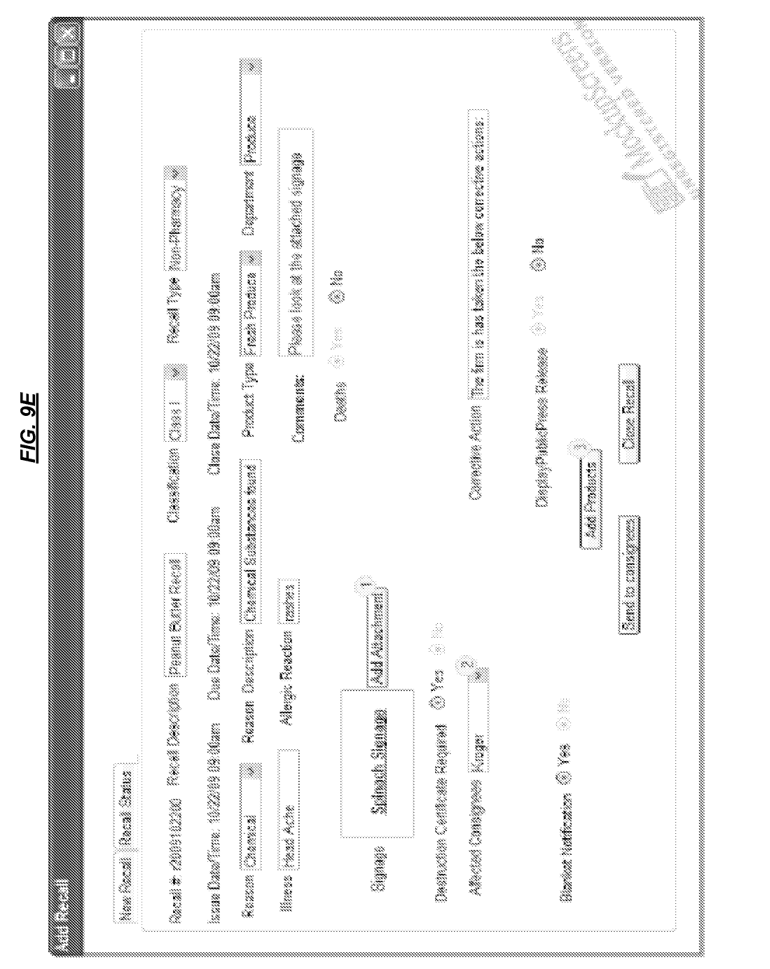

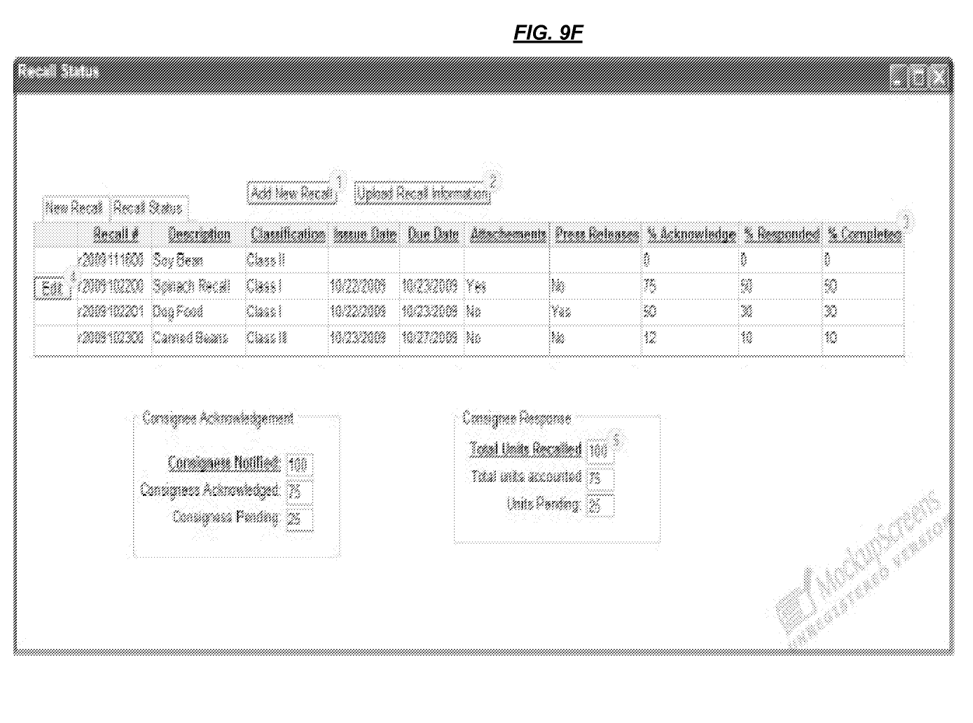

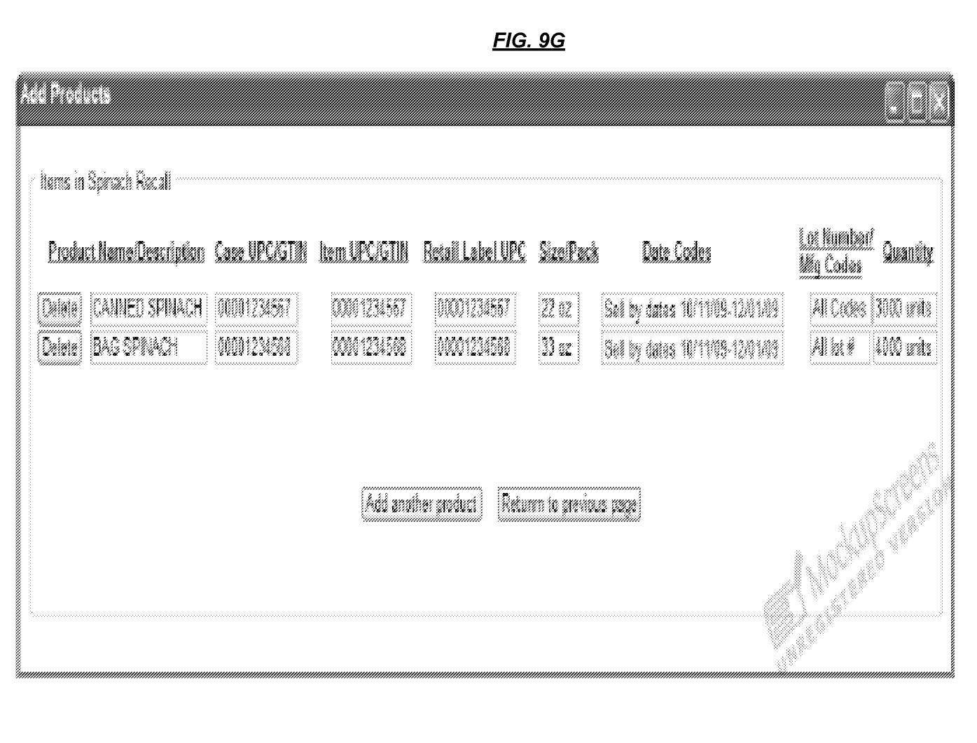

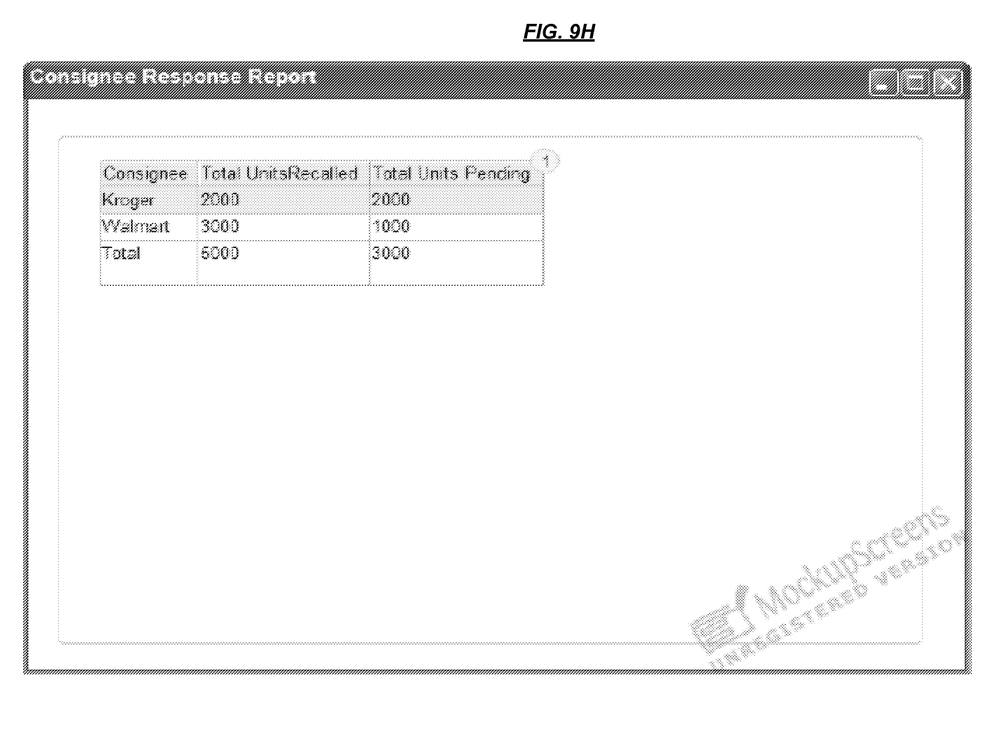

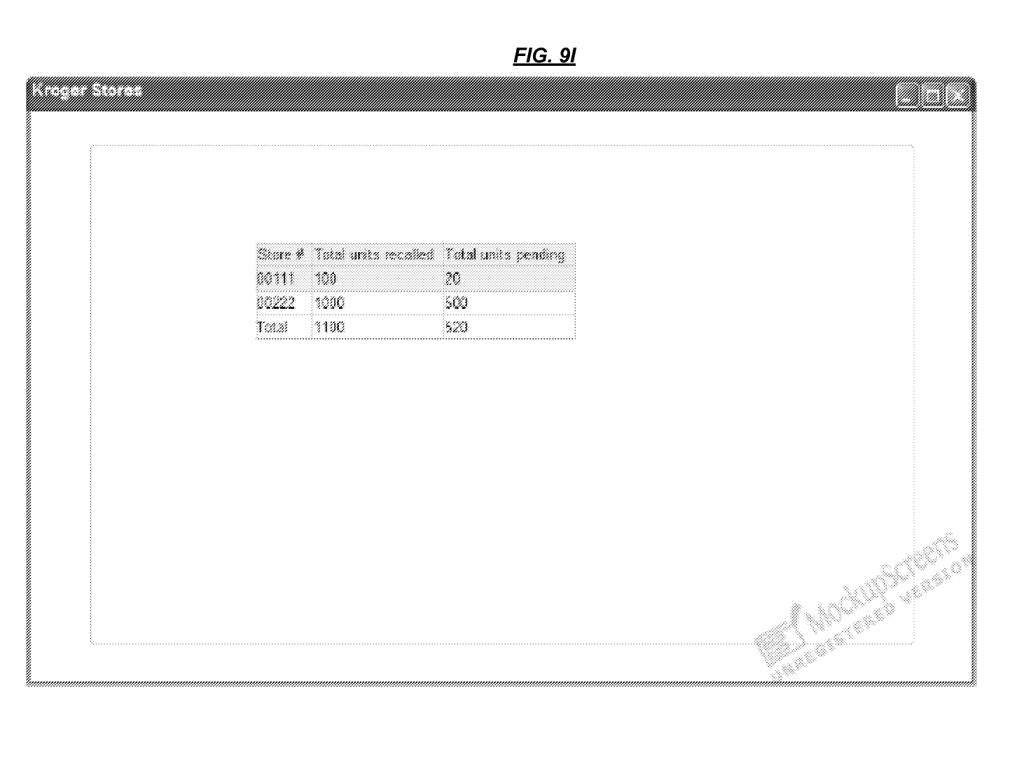

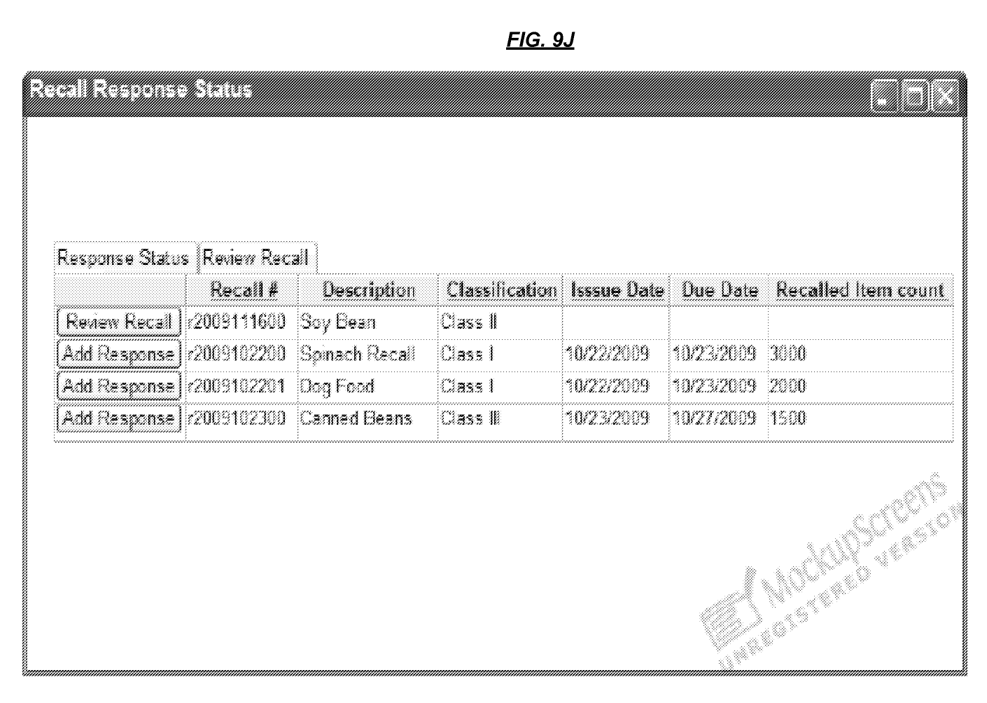

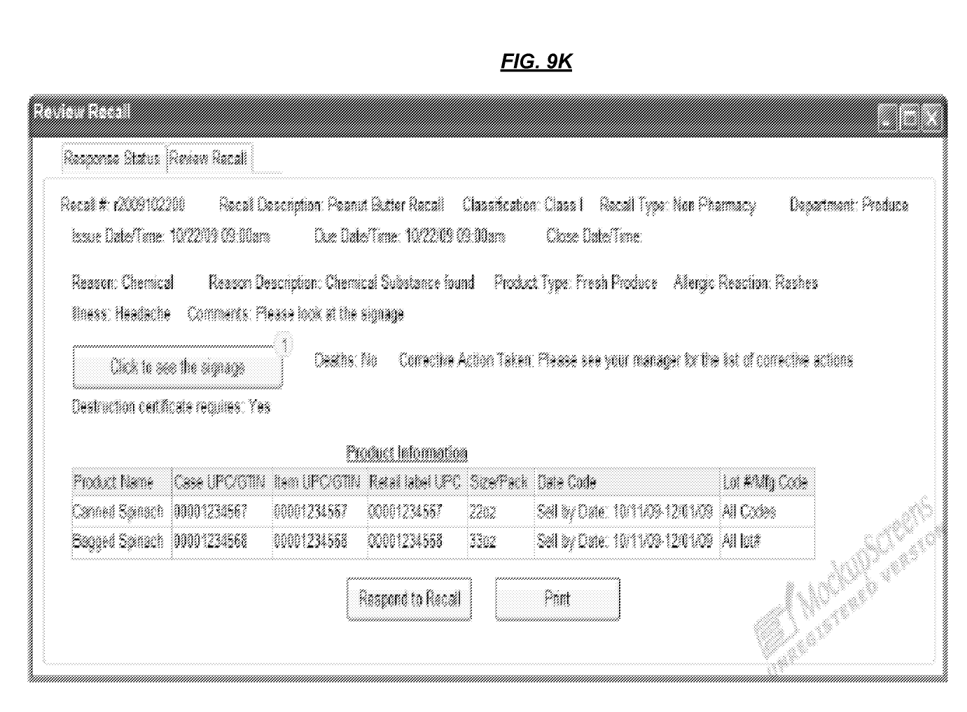

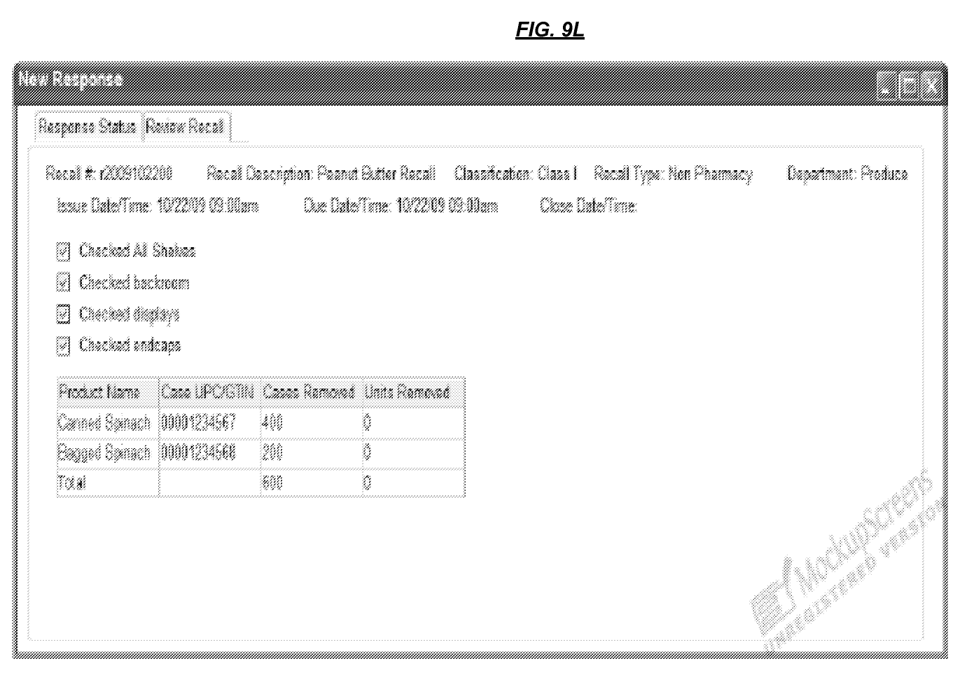

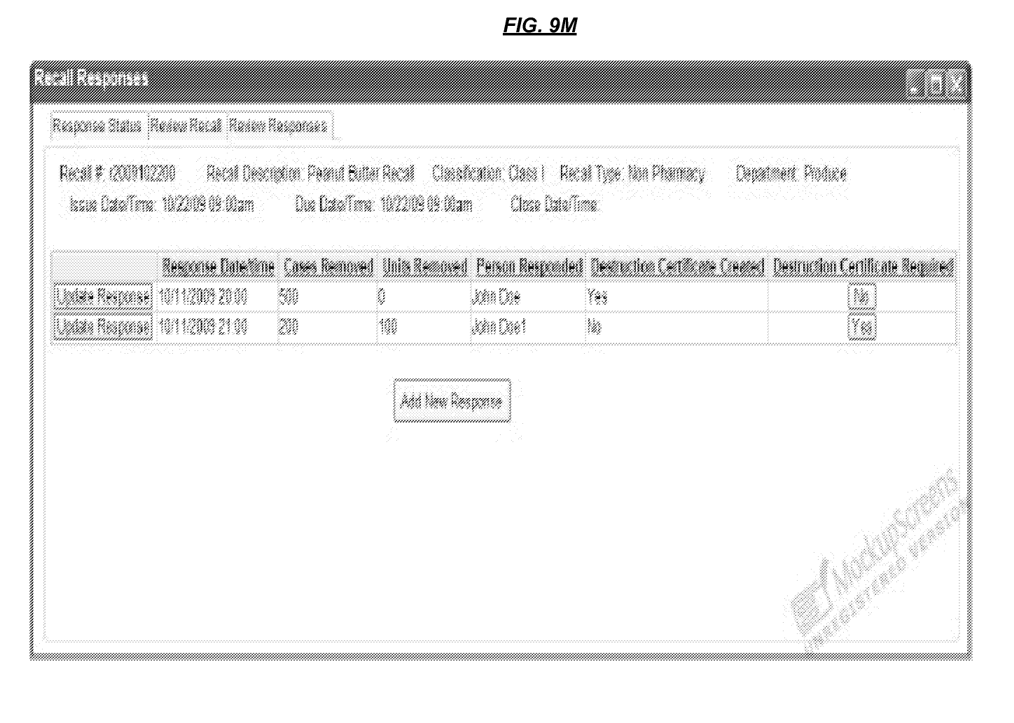

An illustrative and exemplary screen shot is shown in FIG. 9A in connection with adding one or more internal employees to an Exchange.

An illustrative and exemplary screen shot is shown in FIG. 9B in connection with deleting one or more internal employees from an Exchange.

An illustrative and exemplary screen shot is shown in FIG. 9C in connection with adding one or more consignees to an Exchange.

An illustrative and exemplary screen shot is shown in FIG. 9D in connection with adding one or more mailboxes to an Exchange.

An illustrative and exemplary screen shot is shown in FIG. 9E in connection with adding one or more recalls to an Exchange.

In certain illustrative and exemplary embodiments, depression of the “add attachment” button in FIG. 9E may generate and open a Windows ‘upload’ box from which one or more files can be uploaded. In certain illustrative and exemplary embodiments, the Exchange (or one or more other applications) may send an electronic notification to one or more selected consignees from the drop down menu “affected consignees” as shown in FIG. 9E. In certain illustrative and exemplary embodiments, depression of the “add products” button of FIG. 9E may generate and open an ‘add items screen’ to facilitate the addition or identification of one or more products.

An illustrative and exemplary screen shot is shown in FIG. 9F in connection with providing a recall status.

In certain illustrative and exemplary embodiments, depression of the “add new recall” button in FIG. 9F may allow a user or other party to an Exchange to an add recall screen (e.g., FIG. 9E).

In certain illustrative and exemplary embodiments, depression of the “upload recall information” button in FIG. 9F may generate and open a popup Window from where one can upload recall information, optionally from a custom interface like a spread sheet, xml, access database, etc.

In certain illustrative and exemplary embodiments, after the upload the Exchange may navigate to an add recall screen (e.g., FIG. 9E) in order to allow a user or other party to the Exchange to view the information that was uploaded and to make any changes as needed.

In certain illustrative and exemplary embodiments, depression of the “% Acknowledged,” “% Responded,” and “% Completed” buttons or columns in FIG. 9F may be used to provide status as to acknowledgment of a recall, responses to a recall, and whether a particular party or entity has completed his/her/their portion of the recall activities.

In certain illustrative and exemplary embodiments, depression of the “issue date” and “due date” buttons or columns in FIG. 9F may sort recalls by the issue date and due date, respectively.

In certain illustrative and exemplary embodiments, depression of the “attachments” and “press releases” buttons or columns in FIG. 9F may open up one or more attachments or press releases for a recall.

In certain illustrative and exemplary embodiments, if a recall has not been issued it may be edited. For example, referring to FIG. 9F, if the “Soy Bean” recall has not been sent to one or more consignees, it may be edited. The issue date and due date for the “Soy Bean” recall may be populated once the recall is sent or issued.

In certain illustrative and exemplary embodiments, one or more of the buttons or titles in FIG. 9F may be associated with a link or hyperlink. For example, the “total units recalled” link of FIG. 9F may be selected to navigate to or display one or more reports.

An illustrative and exemplary screen shot is shown in FIG. 9G in connection with adding one or more products to a recall.

An illustrative and exemplary screen shot is shown in FIG. 9H in connection with providing one or more consignee response reports.

An illustrative and exemplary screen shot is shown in FIG. 9I in connection with providing one or more consignee response reports at a store level. For example, relative to FIG. 9H, particular Kroger Stores (identified by store number) are shown in FIG. 9I.

An illustrative and exemplary screen shot is shown in FIG. 9J in connection with providing recall response status.

An illustrative and exemplary screen shot is shown in FIG. 9K in connection with providing a review of one or more recalls.

In certain illustrative and exemplary embodiments, depression of the “click to see signage” button in FIG. 9K may generate and open an ‘upload’ box from which one or more files can be uploaded.

An illustrative and exemplary screen shot is shown in FIG. 9L in connection with providing or displaying one or more new responses to a recall.

An illustrative and exemplary screen shot is shown in FIG. 9M in connection with providing or displaying one or more responses to a recall.

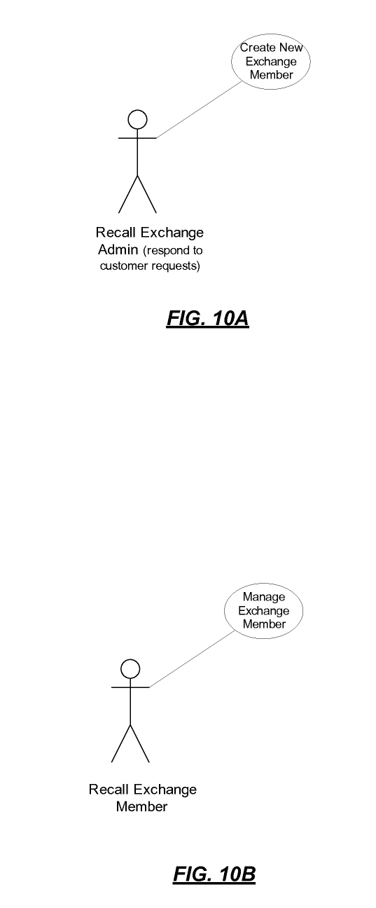

In certain illustrative and exemplary embodiments, new parties or members to an Exchange may be created. FIG. 10A illustrates one such example use case. In certain illustrative and exemplary embodiments, the following use case model or specification may be used to create the new parties or members to the Exchange:

Use Case GEN-01:

| User Requirement | Create a new Exchange Member in Recall | | | | |
|---|---|---|---|---|---|
| | Exchange System | | | | |
| Subject Area | | | | | |
| Actor(s) | Recall Exchange Admin | | | | |
| Use Case Overview | | | | | |
| Trigger | The actor selects the option to create a new | | | | |
| | Exchange Member | | | | |
| Preconditions | 1. | The Exchange Member do not exist in the | | | |
| | | Recall Exchange System. | | | |
| | 2. | The actor has successfully logged into the | | | |
| | | system using their login id. | | | |
| Post conditions | A new Exchange Member is created. | | | | |
| Basic Flow | Create a new Exchange Member | | | | |
| | | 1. | The actor gets an electronic notification from a | | |
| | | | potential member to be added on to Recall | | |
| | | | Exchange. | | |
| | | 2. | The actor enters the exchange member information | | |
| | | | from the electronic notification. | | |
| | | 3. | The actor enters the following information of the | | |
| | | | member: | | |
| | | | | 3.1 | Contact Name |
| | | | | 3.2 | Contact Address |
| | | | | 3.3 | Address for electronic communication |
| | | 4. | The system validates the information entered. | | |
| | | 5. | The system saves the member information and | | |
| | | | creates a unique member ID. | | |
| | | 6. | The system electronically sends the member login | | |
| | | | information to the address specified in step 3.3 | | |
| Alternative Flow(s) | Update an Exchange Member | | | | |
| | | 1. | The actor enters the member's unique address for | | |
| | | | electronic communication and searches the | | |
| | | | member. | | |
| | | 2. | The actor updates the following information of the | | |
| | | | member: | | |
| | | | | a. | Address for electronic communication |
| | | 3. | The system validates the information entered. | | |
| | | 4. | The system saves the updated member information. | | |
| Exceptional Flows | | 1. | The system displays a message saying the | | |
| | | | member is already registered. | | |
| | | 2. | The system displays an error message to | | |
| | | | notify the database is down. Actor is | | |
| | | | directed to come back later. | | |
| Use Case Notes | | | | | |
| Business Rules | | BR #1. The electronic notification received | | | |
| | | from the potential user should contain address | | | |
| | | for electronic communication with the member. | | | |
| | | BR #2. The address for electronic | | | |
| | | communication should be unique for each | | | |
| | | member. | | | |
| Functional | | FR#1. The address for electronic | | | |
| Requirements | | communication (Recall Exchange mailbox for | | | |
| | | the member) is used in UC_Add_Consignees | | | |
| | | to identify a consignee as an exchange | | | |
| | | member. | | | |
| | | FR#2. | | | |
| Non-functional | | | | | |
| requirements | | | | | |

In certain illustrative and exemplary embodiments, parties or members to an Exchange may be managed. FIG. 10B illustrates one such example use case. In certain illustrative and exemplary embodiments, the following use case model or specification may be used to manage one or more parties or members to the Exchange:

Use Case GEN-01:

| User Requirement | Manage Exchange Member in Recall Exchange | |
|---|---|---|
| | System | |
| Subject Area | | |
| Actor(s) | Recall Exchange Member | |
| Use Case Overview | | |
| Trigger | The actor selects the option to manage Exchange | |
| | Member | |
| Preconditions | 1. | The Exchange Member exists in the Recall |
| | | Exchange System. |
| | 2. | The actor has successfully logged into the system |
| | | using their unique Member ID (login id). |

| | |
|---|---|
| Post conditions | The Exchange Member is updated. |
| Basic Flow | Add internal employee |

| | |
|---|---|
| 1. | The actor is taken to their home page in Recall |
| | Exchange. |
| 2. | The actor selects the option to add employees |
| 3. | The actor adds the information of their internal |
| | employees who should receive the recall notification. |
| 4. | The actor enters the following information: |

| | |
|---|---|
| 4.1 | Employee First Name |
| 4.2 | Employee Last Name |
| 4.3 | Designation |
| 4.4 | Address for electronic communication |

| | | 5. | The system validates the information entered. |
|---|---|---|---|
| | | 6. | The system saves the member information under the |
| | | | unique member ID |
| | | 7. | The system displays the employee list on the screen. |
| Alternative | Delete an internal employee | | |
| Flow(s) | | 1. | Steps 1 under Basic Flow. |
| | | 2. | The actor selects the option to delete internal |
| | | | employees. |
| | | 3. | The actor deletes the employee. |
| | | 4. | The system saves the updated member information |
| | | | under the unique member ID |
| | | 5. | The system displays the employee list on the screen |
| Exceptional | | 1. | The system displays a message saying the |
| Flows | | | member cannot be found. |
| | | 2. | The system displays an error message to notify |
| | | | the database is down. Actor is directed to come |
| | | | back later. |
| Use Case Notes | | | |

| | |
|---|---|
| Business Rules | BR #1. The information should be stored under the |
| | unique member ID. |
| | BR #2. |
| Functional | FR#1. |
| Requirements | FR#2. |
| Non-functional | |
| requirements | |

In certain illustrative and exemplary embodiments, consignees to an Exchange may be added. In certain illustrative and exemplary embodiments, the following use case model or specification may be used to add one or more consignees to the Exchange:

Use Case GEN-01:

| User Requirement | Add consignees to Recall Exchange System | |
|---|---|---|
| Subject Area | | |
| Actor(s) | Recall Exchange Member | |
| Use Case Overview | | |
| Trigger | The actor selects the option to add consignees | |
| Preconditions | 1. | The actor has successfully logged into the system |
| | | using their login id. |

| | |
|---|---|
| Post conditions | Consignee is added. |
| Basic Flow | Add individual consignees |

| | |
|---|---|
| 1. | The system displays the screen to add individual |
| | consignee information. |
| 2. | The actor enters the following information of the |
| | consignee and clicks the Add Consignee button: |

| | |
|---|---|
| a. | Company |
| b. | Contact Name |
| c. | Address for electronic communication |
| d. | Contact Address: |

| | |
|---|---|
| i. | Street |
| ii. | City |
| iii. | State |
| iv. | Zip code |

| | |
|---|---|
| 3. | The system validates the information entered. |
| 4. | The system saves the information under the unique |
| | member ID. |
| 5. | The system displays the below information on the |
| | screen |

| | |
|---|---|
| a. | Company Name |
| b. | Contact |
| c. | Registered with my Company - Yes/No |
| d. | Registration Expiry date |

| Alternative | Update Consignee from External source | | |
|---|---|---|---|
| Flow(s) | | 1. | The actor clicks on ‘Update Consignee from External |
| | | | source’ button. |
| | | 2. | The system pops up the upload from box. |
| | | 3. | The actor selects the file to upload from. |
| | | 4. | The system saves the information under the unique |
| | | | member ID. |
| | | 5. | The system displays the below information on the |
| | | | screen |

| | |
|---|---|
| a. | Company Name |
| b. | Contact |
| c. | Registered with my Company - Yes/No |
| d. | Registration Expiry date |

| | | |
|---|---|---|
| Exceptional | 1. | The system displays an error message to notify |
| Flows | | the database is down. Actor is directed to come |
| | | back later. |
| Use Case Notes | | |

| | |
|---|---|
| Business Rules | BR #1. If the consignee is already a member of the |
| | Recall Exchange, then the Registered with |
| | Company will be flagged ‘Yes’. |
| | BR #2. The Registration expiry date will be 1 year |
| | from the date of registration. |
| | BR #3. The Exchange will send re-registration |
| | notification to consignees one month before their |
| | registration expiry date |
| | BR #4. The Exchange will send ‘registration |
| | required’ notification to those consignees who have |
| | not registered with the Exchange. |
| Functional | FR#1. The Exchange will identify a consignee as |
| Requirements | an Exchange Member from the unique Recall |
| | Exchange mailbox for the consignee. |
| | FR#2. |
| Non-functional | |
| requirements | |

In certain illustrative and exemplary embodiments, internal employees may be added. In certain illustrative and exemplary embodiments, the following use case model or specification may be used to add one or more internal employees to the Exchange:

Use Case GEN-01:

| User Requirement | Add internal employee in Recall Exchange System | |
|---|---|---|
| Subject Area | | |
| Actor(s) | Recall Exchange Member | |
| Use Case Overview | | |
| Trigger | The actor selects the option to add employees | |
| Preconditions | 1. | The actor has successfully logged into the system |
| | | using their login id. |

| | |
|---|---|
| Post conditions | Internal Employee is added. |
| Basic Flow | Add individual employees |

| | |
|---|---|
| 1. | The actor clicks on ‘Individual Employee’ button. |
| 2. | The system displays the screen to add individual |
| | employee information. |
| 3. | The actor enters the following information of the |
| | employee: |

| | |
|---|---|
| a. | First Name |
| b. | Last Name |
| c. | Address for electronic communication |
| d. | Designation |

| | | 4. | The system validates the information entered. |
|---|---|---|---|
| | | 5. | The system saves the information under the unique |
| | | | member ID. |
| | | 6. | The system displays the information on the screen |
| Alternative | Add Company Exchange Mailbox | | |
| Flow(s) | | 1. | The actor clicks on ‘Company’ button. |
| | | 2. | The system displays the screen to add Recall Exchange |
| | | | Mailbox. |
| | | 3. | The actor enters the Recall Exchange Mailbox address - |
| | | | ExchangeRecall@Yourdomain.com: |
| | | 4. | The system validates the information entered. |
| | | 5. | The system saves the information under the unique |
| | | | member ID. |
| | | 6. | The system displays the information on the screen. |
| Exceptional | | 1. | The system displays an error message to notify |
| Flows | | | the database is down. Actor is directed to come |
| | | | back later. |
| Use Case Notes | | | |

| | |
|---|---|
| Business Rules | BR #1. The consignee should map the internal |
| | employees who should receive the recall |
| | notification to their Recall Exchange Mailbox |
| | address. |
| Functional | FR#1. |
| Requirements | FR#2. |
| Non-functional | |
| requirements | |

In certain illustrative and exemplary embodiments, products to an Exchange may be added. In certain illustrative and exemplary embodiments, the following use case model or specification may be used to add one or more products to a recall in an Exchange:

Use Case GEN-01:

| User Requirement | Add Products to recall in Recall Exchange System | |
|---|---|---|
| Subject Area | | |
| Actor(s) | Recall Exchange Member | |
| Use Case Overview | | |
| Trigger | The actor clicks the button to Add Products | |
| Preconditions | 1. | The actor has successfully logged into the system |
| | | using their login id. |

| | |
|---|---|
| Post conditions | Products are added to a recall. |
| Basic Flow | Add a Product |

| | |
|---|---|
| 1. | The system displays the screen to add product |
| | information. |
| 2. | The actor enters the following information about a |
| | product and clicks the ‘Add Product’ button: |

| | |
|---|---|
| a. | Product Name/Description |
| b. | Case UPC/GTIN |
| c. | Item UPC/GTIN |
| d. | Retail Label UPC |
| e. | Size/Pack |
| f. | Date Codes |
| g. | Lot Number/Mfg Codes |
| h. | Quantity |

| | | 3. | The system validates the information entered. | |
|---|---|---|---|---|
| | | 4. | The system saves the information under the unique | |
| | | | Recall Number. | |
| | | 5. | The actor clicks on the ‘Return to previous page’ button. | |
| | | 6. | The system displays the ‘Add Recall’ screen. | |
| Alternative | Delete a product | | | |
| Flow(s) | | 1. | The actor clicks on ‘Delete’ button against the product. | |
| | | 2. | The system shows a confirmation for deletion. | |
| | | 3. | The actor accepts the confirmation. | |
| | | 4. | The system removes the product from under the unique | |
| | | | Recall Number. | |
| Alternative | Delete a product | | | |
| Flow(s) | | | 1. | The actor clicks on ‘Delete’ button against the |
| | | | | product. |
| | | | 2. | The system shows a confirmation for deletion. |
| | | | 3. | The actor does not accept the confirmation. |
| | | | 4. | The system does not remove the product. |

| | | |
|---|---|---|
| Exceptional | 1. | The system displays an error message to notify |
| Flows | | the database is down. Actor is directed to come |
| | | back later. |
| Use Case Notes | | |

| | |
|---|---|
| Business Rules | BR #1. Recall Number is a unique alpha-numeric |
| | entry that identifies a recall. |
| | BR #2. Issue date is the date/time when the recall |
| | is sent out to the consignees. |
| | BR #3. Due date is date/time the recall is due. It is |
| | calculated based on the classification of recall. |
| | Class I recalls are due 24 hours from issue |
| | date/time |
| | BR #4. Close date is date/time of when recall is |
| | closed. |
| Functional | FR#1. Recall Number is a combination of letter ‘r’, |
| Requirements | year, month, date, and a whole number. Example - |
| | the first recall created on Jan. 1, 2010 will have a |
| | recall number of ‘r2010010101’. The second recall |
| | created on Jan. 1, 2010 will have a recall number of |
| | ‘r2010010102’ and so on . . . |
| | FR#2. Classification Types - Class I, Class II, |
| | Class III, Product Withdrawal |
| | FR#3. Recall Types - Pharmacy, Non-Pharmacy |
| | FR#4. Reason - Chemical, Allergen, . . . |
| | FR#5. Product Type - Fresh Produce, Seafood . . . |
| | FR#6. Department -Produce, Seafood, Grocery . . . |
| | FR#7. Affected Consignees - This drop down is |
| | populated with all the consignees added under the |
| | Exchange member. |
| Non-functional | |
| requirements | |

In certain illustrative and exemplary embodiments, a recall may be created in an Exchange. In certain illustrative and exemplary embodiments, the following use case model or specification may be used to create a recall in an Exchange:

Use Case GEN-01:

| User Requirement | Create recall in Recall Exchange System | |
|---|---|---|
| Subject Area | | |
| Actor(s) | Recall Exchange Member | |
| Use Case Overview | | |
| Trigger | The actor selects the option to create recall | |
| Preconditions | 1. | The actor has successfully logged into the system |
| | | using their login id. |

| | |
|---|---|
| Post conditions | Recall is created. |
| Basic Flow | Create Recall |

| | |
|---|---|
| 1. | The system displays the screen to add recall information. |
| 2. | The actor enters/selects the following information about |
| | the recall: |

| | |
|---|---|
| 2.1 | Recall Description |
| 2.2 | Classification |
| 2.3 | Recall Type |
| 2.4 | Reason |
| 2.5 | Reason Description |
| 2.6 | Product Type |
| 2.7 | Department |
| 2.8 | Illness |
| 2.9 | Allergic Reactions |
| 2.10 | Deaths - Yes/No button |
| 2.11 | Destruction Certificate Required - Yes/No button |
| 2.12 | Affected consignees |
| 2.13 | Corrective Action |
| 2.14 | Blanket Notification - Yes/No button |
| 2.15 | Display Public Press release - Yes/No button |

| | |
|---|---|
| 3. | The system validates the information entered. |
| 4. | The system calculates the below fields: |

| | |
|---|---|
| 4.1 | Recall Number |
| 4.2 | Issue Date |
| 4.3 | Due Date |
| 4.4 | Close Date |

| | | 5. | The system saves the information under the unique |
|---|---|---|---|
| | | | member ID. |
| | | 6. | The actor clicks on ‘Add Products’ button (See Use case |
| | | | Add Products). |
| | | 7. | The actor clicks the ‘Send to Consignees’ button |
| | | 8. | The system sends electronic notification to all selected |
| | | | consignees. |
| Alternative | Add Attachment | | |
| Flow(s) | | 1. | The actor clicks on ‘Add Attachment’ button. |
| | | 2. | The system pops up a Windows ‘upload’ box. |
| | | 3. | The actor selects the file to upload from. |
| Exceptional | | 1. | The system displays an error message to notify |
| Flows | | | the database is down. Actor is directed to come |
| | | | back later. |
| Use Case Notes | | | |

| | |
|---|---|
| Business Rules | BR #1. Recall Number is a unique alpha-numeric |
| | entry that identifies a recall. |
| | BR #2. Issue date is the date/time when the recall |
| | is sent out to the consignees. |
| | BR #3. Due date is date/time the recall is due. It is |
| | calculated based on the classification of recall. For |
| | example: Class I recalls are due 24 hours from |
| | issue date/time |
| | BR #4. Close date is date/time of when recall is |
| | closed. |
| Functional | FR#1. Recall Number is a combination of letter ‘r’, |
| Requirements | year, month, date, and a whole number. Example - |
| | the first recall created on Jan. 1, 2010 will have a |
| | recall number of ‘r2010010101’. The second recall |
| | created on Jan. 1, 2010 will have a recall number of |
| | ‘r2010010102’ and so on . . . |
| | FR#2. Classification Types - Class I, Class II, |
| | Class III, Product Withdrawal |
| | FR#3. Recall Types - Pharmacy, Non-Pharmacy |
| | FR#4. Reason - Chemical, Allergen, . . . |
| | FR#5. Product Type - Fresh Produce, Seafood . . . |
| | FR#6. Department -Produce, Seafood, Grocery . . . |
| | FR#7. Affected Consignees - This drop down is |
| | populated with all the consignees added under the |
| | Exchange member. |
| | FR#8. On clicking the ‘Send to Consignees’ button, |
| | the system should send electronic notification to all |
| | affected consignees. The notification should be |
| | send to Recall Exchange Mailbox of the consignee. |
| | FR#9. If Blanket Notification ‘Yes’ is selected, an |
| | electronic notification should be send to all |
| | consignees of the exchange member. |
| Non-functional | |
| requirements | |

In certain illustrative and exemplary embodiments, the following use case model or specification may be used to create a recall in an Exchange:

Use Case GEN-01:

| User Requirement | Create recall in Recall Exchange System | |
|---|---|---|
| Subject Area | | |
| Actor(s) | Recall Exchange Member | |
| Use Case Overview | | |
| Trigger | The actor selects the option to create recall | |
| Preconditions | 1. | The actor has successfully logged into the system using their |
| | | login id. |

| | |
|---|---|
| Post conditions | Recall is created. |
| Basic Flow | Create Recall |

| | |
|---|---|
| 1. | The system displays the screen to add recall |
| | information. |
| 2. | The actor enters/selects the following information |
| | about the recall: |

| | |
|---|---|
| 2.1 | Recall Description |
| 2.2 | Classification |
| 2.3 | Recall Type |
| 2.4 | Reason |
| 2.5 | Reason Description |
| 2.6 | Product Type |
| 2.7 | Department |
| 2.8 | Illness |
| 2.9 | Allergic Reactions |
| 2.10 | Deaths - Yes/No button |
| 2.11 | Destruction Certificate Required - Yes/No |
| 2.12 | button |
| 2.13 | Affected consignees |
| 2.14 | Corrective Action |
| 2.15 | Blanket Notification - Yes/No button |
| 2.16 | Display Public Press release - Yes/No button |

| | |
|---|---|
| 3. | The system validates the information entered. |
| 4. | The system calculates the below fields: |

| | |
|---|---|
| 4.1 | Recall Number |
| 4.2 | Issue Date |
| 4.3 | Due Date |
| 4.4 | Close Date |

| | | 5. | The system saves the information under the unique |
|---|---|---|---|
| | | | member ID. |
| | | 6. | The actor clicks on ‘Add Products’ button (See Use |
| | | | case Add Products). |
| | | 7. | The actor clicks the ‘Send to Consignees’ button |
| | | 8. | The system sends electronic notification to all selected |
| | | | consignees. |
| Alternative | Add Attachment | | |
| Flow(s) | | 1. | The actor clicks on ‘Add Attachment’ button. |
| | | 2. | The system pops up a Windows ‘upload’ box. |
| | | 3. | The actor selects the file to upload from. |
| Exceptional | | 1. | The system displays an error message to notify the |
| Flows | | | database is down. Actor is directed to come back later. |
| Use Case Notes | | | |

| | |
|---|---|
| Business Rules | BR #1. Recall Number is a unique alpha-numeric entry that |
| | identifies a recall. |
| | BR #2. Issue date is the date/time when the recall is sent out |
| | to the consignees. The issue date/time will be the time recall |
| | is send by each consignee. |
| | BR #3. Due date is date/time the recall is due. It is calculated |
| | based on the classification of recall. For example: Class I |
| | recalls are due 24 hours from issue date/time |
| | BR #4. Close date is date/time of when recall is closed by |
| | the recalling firm |
| | BR#5. Need a regulatory recall # in addition to the system |
| | generated recall #. Ability to update the regulatory Recall # |
| Functional | FR#1. Recall Number is a combination of letter ‘r’, year, |
| Requirements | month, date, and a whole number. The number should go to |
| | 999 Example - the first recall created on Jan. 1, 2010 will have |
| | a recall number of ‘r2010010101’. The second recall created |
| | on Jan. 1, 2010 will have a recall number of ‘r2010010102’ and |
| | so on . . . |
| | FR#2. Classification Types - Class I, Class II, Class III, |
| | Product Withdrawal |
| | FR#3. Recall Types - Pharmacy, Non-Pharmacy |
| | FR#4. Reason - Chemical, Allergen, . . . |
| | FR#5. Product Type - Fresh Produce, Seafood . . . |
| | FR#6. Department -Produce, Seafood, Grocery . . . |
| | FR#7. Affected Consignees - This drop down is populated |
| | with all the consignees added under the Exchange member. |
| | FR#8. On clicking the ‘Send to Consignees’ button, the |
| | system should send electronic notification to all affected |
| | consignees. The notification should be send to Recall |
| | Exchange Mailbox of the consignee. |
| | FR#9. If Blanket Notification ‘Yes’ is selected, an electronic |
| | notification should be send to all consignees of the |
| | exchange member. |
| Non-functional | |
| requirements | |

In certain illustrative and exemplary embodiments, one or more consignees may be deleted from an Exchange. In certain illustrative and exemplary embodiments, the following use case model or specification may be used to delete one or more consignees from an Exchange:

Use Case GEN-01:

| User | Delete consignees from Recall Exchange | | |
|---|---|---|---|
| Requirement | System | | |
| Subject Area | | | |
| Actor(s) | Recall Exchange Member | | |
| Use Case | | | |
| Overview | | | |
| Trigger | The actor selects the option to delete consignees | | |
| Preconditions | 1. | The actor has successfully logged | |
| | | into the system using their login id. | |
| Post conditions | Consignee is deleted. | | |
| Basic Flow | Delete individual consignee | | |
| | | 1. | The actor clicks on ‘Delete’ button |
| | | | against the consignee’s name. |
| | | 2. | The system shows a confirmation for |
| | | | deletion. |
| | | 3. | The actor accepts the confirmation. |
| | | 4. | The system removes the consignee from |
| | | | under the unique member ID. |
| Alternative | Delete individual consignee | | |
| Flow(s) | | 1. | The actor clicks on ‘Delete’ button |
| | | | against the consignee’s name. |
| | | 2. | The system shows a confirmation for |
| | | | deletion. |
| | | 3. | The actor does not accept the confirmation. |
| | | 4. | The system does not remove the consignee. |
| Exceptional | | 1. | The system displays an error message to |
| Flows | | | notify the database is down. Actor is |
| | | | directed to come back later. |
| Use Case Notes | | | |

| | |
|---|---|
| Business Rules | BR #1. |
| | BR #2. |
| Functional | FR#1. |
| Requirements | FR#2. |
| Non-functional | |
| requirements | |

In certain illustrative and exemplary embodiments, one or more internal employees may be deleted from an Exchange. In certain illustrative and exemplary embodiments, the following use case model or specification may be used to delete one or more internal employees from an Exchange:

Use Case GEN-01:

| User | Delete internal employee from Recall Exchange | | | |
|---|---|---|---|---|
| Requirement | System | | | |
| Subject Area | | | | |
| Actor(s) | Recall Exchange Member | | | |
| Use Case | | | | |
| Overview | | | | |
| Trigger | The actor selects the option to delete employees | | | |
| Preconditions | 1. | The actor has successfully logged | | |
| | | into the system using their login id. | | |
| Post conditions | Internal Employee is deleted. | | | |
| Basic Flow | Delete individual employees | | | |
| | | 1. | The actor clicks on ‘Delete’ button | |
| | | | against the employee’s name. | |
| | | 2. | The system shows a confirmation for | |
| | | | deletion. | |
| | | 3. | The actor accepts the confirmation. | |
| | | 4. | The system removes the employee from | |
| | | | under the unique member ID. | |
| Alternative | Delete individual employees | | | |
| Flow(s) | | | 1. | The actor clicks on ‘Delete’ |
| | | | | button against the employee’s name. |
| | | | 2. | The system shows a confirmation for |
| | | | | deletion. |
| | | | 3. | The actor does not accept the confirma- |
| | | | | tion. |
| | | | 4. | The system does not remove the em- |
| | | | | ployee. |

| | | |
|---|---|---|
| Exceptional | 1. | The system displays an error message to |
| Flows | | notify the database is down. Actor is directed |
| | | to come back later. |

| | |
|---|---|
| Use Case Notes | |
| Business Rules | BR #1. |
| Functional | FR#1. |
| Requirements | FR#2. |

Non-functional
requirements

In certain illustrative and exemplary embodiments, one or more display screens may be generated to enable or allow for reviewing or responding to a recall in an Exchange. In certain illustrative and exemplary embodiments, the following use case model or specification may be used to generate such display screen(s) in an Exchange:

Use Case GEN-01:

| User Requirement | Review recall in Recall Exchange System | |
|---|---|---|
| Subject Area | | |
| Actor(s) | Recall Exchange Member - Secondary Consignee | |
| Use Case Overview | | |
| Trigger | The actor selects the option to respond to recall | |
| Preconditions | 1. | The actor has successfully logged into the system |
| | | using their login id. |

| | |
|---|---|
| Post conditions | Recall is responded. |
| Basic Flow | Add Response |

| | |
|---|---|
| 1. | The system displays the recall send to the secondary |
| | consignee |
| 2. | The system lists the below information about the recall: |

| | |
|---|---|
| 2.1 | Recall Number |
| 2.2 | Recall Description |
| 2.3 | Issue Date |
| 2.4 | Due Date |
| 2.5 | Classification |
| 2.6 | Recall Type |
| 2.7 | Reason |
| 2.8 | Reason Description |
| 2.9 | Product Type |
| 2.10 | Department |
| 2.11 | Illness |
| 2.12 | Allergic Reactions |
| 2.13 | Deaths - Yes or No |
| 2.14 | Destruction Certificate Required - Yes or No |
| 2.15 | Corrective Action |

| | | 3. | The system displays the UPC numbers | |
|---|---|---|---|---|
| | | 4. | The actor enters the count of each UPC removed from their | |
| | | | facility | |
| | | 5. | The actor enters the number of hours spend removing the | |
| | | | items | |
| | | 6. | The actor saves the information | |
| | | 7. | The system validates the information and save the count of | |
| | | | items and hours spend for the recall under the unique | |
| | | | consignee id. | |
| | | 8. | The system prompts the user to print the response | |
| | | 9. | The actor prints the response. | |
| | | 10. | The system takes the actor back to the recall response | |
| | | | status screen (See Use Case Recall Response Status) | |
| Alternative | Update Response | | | |
| Flow(s) | | 1. | The system displays the recall send to the secondary | |
| | | | consignee | |
| | | 2. | The system lists the below information about the recall | |
| | | | along with the “updated” verbiage: | |
| | | | 2.1. | Recall Number |
| | | | 2.2. | Recall Description |
| | | | 2.3. | Issue Date |
| | | | 2.4. | Due Date |
| | | | 2.5. | Classification |
| | | | 2.6. | Recall Type |
| | | | 2.7. | Reason |
| | | | 2.8. | Reason Description |
| | | | 2.9. | Product Type |
| | | | 2.10. | Department |
| | | | 2.11. | Illness |
| | | | 2.12. | Allergic Reactions |
| | | | 2.13. | Deaths - Yes or No |
| | | | 2.14. | Destruction Certificate Required - Yes or No |
| | | | 2.15. | Corrective Action |
| | | 3. | The system displays the UPC numbers | |
| | | 4. | The actor enters the count of each UPC removed from their | |
| | | | facility | |
| | | 5. | The actor enters the number of hours spend removing the | |
| | | | items | |
| | | 6. | The actor saves the information | |
| | | 7. | The system validates the information and save the count of | |
| | | | items and hours spend for the recall under the unique | |
| | | | consignee id. | |
| | | 8. | The system prompts the user to print the response | |
| | | 9. | The actor prints the response. | |
| | | 10. | The system takes the actor back to the recall response | |
| | | | status screen (See Use Case Recall Response Status) | |
| Exceptional | | | 1. | The system displays an error message to |
| Flows | | | | notify the database is down. Actor is directed |
| | | | | to come back later. |
| Use Case Notes | | | | |

| | |
|---|---|
| Business Rules | BR #1. If the response is being updated, the |
| | response screen should show the word “Updated”. |
| | BR #2. Before adding the first response the |
| | system should always force the user to review the |
| | recall. |
| Functional | FR#1. If there are multiple responses, the system |
| Requirements | should show individual responses on the recall |
| | response status screen with a running total at the |
| | bottom |
| | FR#2. As soon as the secondary consignee |
| | responds to a recall, a real time update should be |
| | made so that the response percentage and |
| | response counts for the recall will be captured on |
| | the exchange dashboard. |
| Non-functional | |
| requirements | |

In certain illustrative and exemplary embodiments, the following use case model or specification may be used to generate one or more display screen(s) in an Exchange for reviewing or responding to a recall:

Use Case GEN-01:

| User Requirement | Review recall in Recall Exchange System | |
|---|---|---|
| Subject Area | | |
| Actor(s) | Recall Exchange Member - Secondary Consignee | |
| Use Case Overview | | |
| Trigger | The actor selects the option to review recall | |
| Preconditions | 1. | The actor has successfully logged into the system |
| | | using their login id. |

| | |
|---|---|
| Post conditions | Recall is reviewed. |
| Basic Flow | Review Recall |

| | |
|---|---|
| 1. | The system displays the recall send to the secondary |
| | consignee |
| 2. | The system lists the below information about the recall: |

| | |
|---|---|
| 2.1 | Recall Number |
| 2.2 | Recall Description |
| 2.3 | Issue Date |
| 2.4 | Due Date |
| 2.5 | Classification |
| 2.6 | Recall Type |
| 2.7 | Reason |
| 2.8 | Reason Description |
| 2.9 | Product Type |
| 2.10 | Department |
| 2.11 | Illness |
| 2.12 | Allergic Reactions |
| 2.13 | Deaths - Yes or No |
| 2.14 | Destruction Certificate Required - Yes or No |
| 2.15 | Corrective Action |
| 2.16 | Public Press release button |
| 2.17 | Attachments button |

| Alternative | View Attachment | | |
|---|---|---|---|
| Flow(s) | | 1. | The actor clicks on ‘Attachment’ button. |
| | | 2. | The system opens the attachment in a separate |
| | | | window. |
| Alternative | View Press Release | | |
| Flow(s) | | 1. | The actor clicks on ‘Press Release’ button. |
| | | 2. | The system opens the press release in a separate |
| | | | window. |
| Exceptional | | 1. | The system displays an error message to |
| Flows | | | notify the database is down. Actor is |
| | | | directed to come back later. |
| Use Case Notes | | | |

| | |
|---|---|
| Business Rules | BR #1. If there is an attachment for the recall, an |
| | attachment icon should be visible. If there is no |
| | attachment, attachment icon should not be visible. |
| | BR #2. If there is a press release for the recall, a |
| | press release icon should be visible . . . If there is |
| | no press release, press release icon should not be |
| | visible |
| Functional | FR#1. If there are multiple attachments, the |
| Requirements | system should open up all attachments when the |
| | icon is clicked. |
| | FR#2. If there are multiple press releases, the |
| | system should open up all press releases when |
| | the icon is clicked. |
| | FR#3. As soon as the secondary consignee |
| | acknowledges a recall, a real time update should |
| | be made so that the acknowledgement |
| | percentage for the recall will be captured on the |
| | exchange dashboard. |
| Non-functional | |
| requirements | |

In certain illustrative and exemplary embodiments, one or more recalls may be uploaded to an Exchange. In certain illustrative and exemplary embodiments, the following use case model or specification may be used to upload a recall to an Exchange:

Use Case GEN-01:

| User Requirement | Upload recall to Recall Exchange System | | |
|---|---|---|---|
| Subject Area | | | |
| Actor(s) | Recall Exchange Member | | |
| Use Case Overview | | | |
| Trigger | The actor selects the option to upload recall | | |
| Preconditions | 1. | The actor has successfully logged into the system | |
| | | using their login id. | |
| Post conditions | Recall is created. | | |
| Basic Flow | Upload Recall | | |
| | 1. | The system displays the screen where all open recalls | |
| | | initiated by the exchange member are listed. | |
| | 2. | The actor clicks the ‘upload recall information’ button | |
| | 3. | The system pops up a Windows ‘upload’ box. | |
| | 4. | The actor selects the file to upload from. | |
| | 5. | The system uploads the recall information and takes the | |
| | | user to the Add Recall screen (See Use Case Create | |
| | | Recall). | |
| Alternative | Edit Recall | | |
| Flow(s) | | 1. | The actor clicks on ‘Edit’ button against a recall. |
| | | 2. | The system takes the user to the Add Recall screen |
| | | | (See Use Case Create Recall). |
| Alternative | Sort Recall | | |
| Flow(s) | | 1. | The actor clicks on Issue Date or Due Date columns. |
| | | 2. | The system sorts the recalls by issue date or due date |
| | | | columns respectively |
| Alternative | Recall Status | | |
| Flow(s) | | 1. | The actor clicks on ‘% Acknowledged’ cell of a recall. |
| | | 2. | The system takes the user to Consignee Acknowledged |
| | | | pop up (See Use Case Consignee Acknowledgement) |
| | | 3. | The actor clicks on ‘% Responded’ cell of a recall. |
| | | 4. | The system takes the user to Consignee Response pop |
| | | | up (See Use Case Consignee Response) |
| Alternative | Consignee Acknowledgement | | |
| Flow(s) | | 1. | The actor clicks on ‘Consignee Notified’ link. |
| | | 2. | The system takes the user to Consignee Acknowledged |
| | | | report (See Use Case Consignee Acknowledgement |
| | | | Report) |
| Alternative | Consignee Response | | |
| Flow(s) | | 1. | The actor clicks on ‘Consignee Responded’ link. |
| | | 2. | The system takes the user to Consignee Responded |
| | | | report (See Use Case Consignee Response Report) |
| Alternative | Attachment | | |
| Flow(s) | | 1. | The actor clicks on ‘Yes’ under the attachment column. |
| | | 2. | The system opens up the attachment added for the |
| | | | recall in a separate window. |
| Alternative | Press Release | | |
| Flow(s) | | 1. | The actor clicks on ‘Yes’ under the press release |
| | | | column. |
| | | 2. | The system opens up the press release added for the |
| | | | recall in a separate window. |
| Exceptional | | 1. | The system displays an error message to |
| Flows | | | notify the database is down. Actor is directed |
| | | | to come back later. |
| Use Case Notes | | | |

| | |
|---|---|
| Business Rules | BR#1. A recall can be edited only if it is in ‘draft’ |
| | status. |
| | BR #2. If there is an attachment or press release |
| | for a recall, clicking the cell will open the |
| | attachment or press release respectively. |
| | BR #3. Due date and issue date will be populated |
| | only when the recall is sent. |
| | BR #4. The consignee acknowledgement should |
| | show real time data for consignees notified, |
| | consignees acknowledged and consignees |
| | pending |
| | BR #5. The consignee response should show real |
| | time data for total units recalled, total units |
| | accounted and units pending. |
| Functional | FR#1. If there is an attachment or press release |
| Requirements | for a recall, the cell will be a hyperlink. |
| | FR#2. If there are multiple attachments, the |
| | system should open up all attachments when the |
| | hyperlink is clicked. |
| | FR#3. If there are multiple press releases, the |
| | system should open up all press releases when |
| | the hyperlink is clicked. |
| | FR #4. The consignee pending should be |
| | calculated from consignees notified, consignees |
| | acknowledged (consignee pending = consignee |
| | notified − consignee acknowledged) |
| | FR #5. The units pending should be calculated |
| | from total units recalled and total units accounted |
| | (units pending = total units recalled − total units |
| | accounted). |
| Non-functional | |
| requirements | |

Given the benefit of the above disclosure and description of exemplary embodiments, it will be apparent to those skilled in the art that numerous alternative and different embodiments are possible in keeping with the general principles of the invention disclosed here. Those skilled in the art will recognize that all such various modifications and alternative embodiments are within the true scope and spirit of the invention. The appended claims are intended to cover all such modifications and alternative embodiments. It should be understood that the use of a singular indefinite or definite article (e.g., “a,” “an,” “the,” etc.) in this disclosure and in the following claims follows the traditional approach in patents of meaning “at least one” unless in a particular instance it is clear from context that the term is intended in that particular instance to mean specifically one and only one. Likewise, the term “comprising” is open ended and, so, does not exclude additional items, features, components, etc. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the inventive systems, methods and devices defined by the following claims.

What is claimed is:

1. A recall information exchange platform comprising an exchange processor, associated storage readable and writable by the exchange processor, and an electronic communication pathway for electronic data interchange by the exchange processor,
the exchange processor being configured to register multiple members of a multi-tiered distribution system as exchange system members, comprising receiving and retrievably storing registration information from each of the multiple exchange system members;
the exchange processor being configured to receive a recall notification from a recalling firm that is an exchange system member to implement a recall information exchange, the recall notification including at least—
RF identification information identifying the recalling firm,
product information identifying at least certain product units for which a recall is to be executed, and
the identity of one or more consignees of product units for which the recall is to be executed;
the exchange processor being configured to automatically implement a recall information exchange in response to receipt of the recall notification, including being configured to perform, in any possible order, at least:
opening a product recall file;
generating and transmitting a recall notification receipt to the recalling firm,
establishing a tabulated recalled units status for the product units for which the recall is being implemented;
establishing a tabulated consignee status for the one or more identified consignees of product units for which the recall is being implemented;
generating and transmitting a primary recall notification to one or more identified consignees identifying at least product units for which the recall is being implemented;
receiving a consignee acknowledgment from any of the identified consignees indicating receipt of the primary notification;
updating the tabulated consignee status in response to receipt of each consignee acknowledgment;
receiving a progress report from any of the identified consignees indicating a status of product units for which the recall is being implemented;
updating the tabulated recalled units status in response to receipt of each progress report; and
generating and transmitting a consignee status notification to the recalling firm providing information corresponding to at least one of the tabulated recalled units status and the tabulated consignee status.

2. The recall information exchange system of claim 1 wherein the exchange processor is configured to generate and disseminate a pre-recall incident alert based on an identification of a geographic product origin and a product category selected from at least one of: food products and ingredients for human consumption, food products and ingredients for animal consumption, pharmaceutical products, tobacco products, alcoholic products, general merchandise, and health and beauty care.

3. The recall information exchange system of claim 2 wherein the incident alert is based on at least one of: a tampering incident, a foodborne illness outbreak alert, a food defense threat or event, an identification of a counterfeit product, product extortion, and product contamination.

4. The recall information exchange system of claim 1 further comprising positioning purchasing personnel to arrange alternate sources of products before competitors or speculators lock up excess supply.

5. The recall information exchange system of claim 1 wherein the recall exchange processor is configured to provide to one or more exchange members at least one of the following services: product recall insurance, product liability insurance, physical retrieval of a recalled product service, 1-800 and call center service, crisis management service, public relations (PR) service, and tracking and traceability service.

6. The recall information exchange system of claim 5 wherein a service provider of the at least one service is subject to at least one of a vetting process and an exchange member nomination process.

7. The recall information exchange system of claim 1 wherein the identified product units for which the recall is to be executed include at least one of: food products and ingredients for human consumption, food products and ingredients for animal consumption, pharmaceutical products, tobacco products, alcoholic products, general merchandise, and health and beauty care products.

8. A method comprising:
receiving registration information from a user;
identifying at least one information exchange party member in addition to the user;
receiving a recall notification request from at least one of the user and the at least one information exchange party member, the notification request identifying one or more product units;
opening a folder in response to the notification request;
assigning a tabulated status to the one or more product units;
transmitting a primary notification to the user and the at least one information exchange party member, the primary notification referencing the one or more product units;
receiving a progress report from at least one of the user and the at least one information exchange party member, the progress report indicating a status of product included in the one or more product units and attributable to the corresponding at least one of the user and the at least one information exchange party member; and
updating the tabulated status of the one or more product units based on the status included in the received progress report.

9. The method of claim 8, wherein the folder is a watch folder.

10. The method of claim 8, wherein the folder is a recall folder.

11. The method of claim 8, further comprising:
receiving approval of the recall notification request from a designated authority,
wherein the opening of the folder is further responsive to the received approval.

12. The method of claim 8, wherein the at least one information exchange party member includes at least one of: a designated authority, a consignor of the user, a consignee of the user, and a sub consignee of the user.

13. The method of claim 8, further comprising:
closing the folder.

14. The method of claim 13, wherein the closing of the folder is responsive to the updated tabulated status of the one or more product units indicating that the one or more product units have been accounted for.

15. The method of claim 14, wherein the closing of the folder is further responsive to receiving an indication that corrective action has been taken with respect to the one or more product units.

16. The method of claim 13, wherein the closing of the folder is responsive to a risk associated with the opening of the folder being mitigated to below a threshold value.

17. The method of claim 8, wherein the receiving of a notification request from at least one of the user and the at least one information exchange party member is responsive to detecting a change to a website associated with the corresponding at least one of the user and the at least one information exchange party member.

18. The method of claim 17, wherein the at least one information exchange party member includes a designated authority, and wherein the detected change is a change to a website associated with the designated authority.
